(19) United States
(12) Patent Application Publication
(10) Pub. No.: US 2016/0334695 A1
(43) Pub. Date: Nov. 17, 2016

(54) LIGHT SOURCE DEVICE

(71) Applicant: MITSUBISHI ELECTRIC CORPORATION, Tokyo (JP)

(72) Inventors: Akihiro YAMADA, Tokyo (JP); Nobutaka KOBAYASHI, Tokyo (JP); Shinji YAGYU, Tokyo (JP)

(73) Assignee: MITSUBISHI ELECTRIC CORPORATION, Tokyo (JP)

(21) Appl. No.: 15/109,578

(22) PCT Filed: Feb. 24, 2015
(86) PCT No.: PCT/JP2015/055124

§ 371 Date: Jul. 1, 2016

(30) Foreign Application Priority Data
Feb. 27, 2014 (JP) 2014-036476

(51) Int. Cl. G03B 21/20; F21V 9/08; F21V 9/16; G02B 27/14; F21V 7/00; F21V 3/00; F21V 23/00; F21V 13/14; F21V 17/02; F21V 5/04

(52) U.S. Cl. CPC G03B 21/208; F21V 17/02; F21V 9/08; F21V 9/16; F21V 5/04; F21V 7/00; F21V 3/00; F21V 23/003; F21V 13/14; G03B 21/204; G03B 21/2066; G03B 21/2013; G02B 27/141; F21Y 2115/30

(57) ABSTRACT

A light source device includes: a light combining element for transmitting first excitation light and reflecting second excitation light; and a phosphor element for receiving the first excitation light and the second excitation light and emitting first fluorescence. An emission angle of the first excitation light emitted from the light combining element and a reflection angle of the second excitation light reflected by the light combining element are different from each other, so that a position at which the first excitation light passing through the light combining element reaches the phosphor element and a position at which the second excitation light reflected by the light combining element reaches the phosphor element are different from each other.

### TECHNICAL FIELD

The present invention relates to a light source device including multiple light sources that generate excitation light, and a phosphor that absorbs the energy of the excitation light and emits fluorescence.

### BACKGROUND ART

For example, as a device using a light source device, there is a projection display device. A projection display device includes a light source system, an illumination optical system, and a projection optical system. “Light source system” refers to, for example, a light source system. “System” refers to a group or mechanism in which individual elements function as a whole while interacting with each other. The light source system is a system including a light emitting element that emits light, an optical element, and the like. The light source system emits projection light. The illumination optical system guides the light emitted from the light source system to a light valve. The light valve receives an image signal and outputs image light. The projection optical system magnifies and projects the image light output by the light valve onto a screen.

Here, “image light” refers to light having image information. “Light valve” refers to an optical shutter that controls transmission or reflection of light. The light valve is, for example, a liquid crystal panel, a digital micro-mirror device (DMD; registered trademark), or the like. Excitation light is a general term for light that causes excitation of substance, such as a phosphor. Projection light is used in the same sense as projected light. “Projection” and “projecting” refer to projecting light.

Conventional mainstream light source systems use pressure mercury lamps or xenon lamps as light sources. Recently, projection display devices using light emitting diodes (referred to below as LEDs), laser diodes (LDs) (referred to below as lasers), or other light sources are being developed.

In light source systems using LEDs or lasers, a single light element is poor in brightness compared to a lamp, so means for enhancing brightness is necessary. For example, Patent Reference 1 discloses a projection display device that concentrates light emitted by multiple excitation light sources on a phosphor element to generate green fluorescence, thereby enhancing brightness.

However, as described in Patent Reference 1, a phosphor element has a problem of light saturation. “Light saturation” refers to the fact that reduction in light output converted from concentrated light output occurs. For example, the projection display device disclosed in Patent Reference 1 enhances uniformity of the light beam concentrated on the phosphor element and reduces local light saturation by arranging a lens array between the light source and the condensing optical system.

### PRIOR ART REFERENCES

### Patent References

Patent Reference 1: Japanese Patent Application Publication No. 2013-114980 (pages 99-105, FIGS. 1 and 6)

### SUMMARY OF THE INVENTION

### Problems to be Solved by the Invention

However, since the lens array is added to uniformly concentrate a light beam on the phosphor, there is a problem of the increase in the number of optical components. Further, the increase in the number of optical components causes problems, such as deterioration in assemblability and increase in cost.

### Means for Solving the Problems

The present invention has been made to solve the problems as described above, and includes: a light combining element for transmitting first excitation light and reflecting second excitation light; and a phosphor element for receiving the first excitation light and the second excitation light and emitting first fluorescence, wherein an emission angle of the first excitation light emitted from the light combining element and a reflection angle of the second excitation light reflected by the light combining element are different from each other, so that a position at which the first excitation light passing through the light combining element reaches the phosphor element and a position at which the second excitation light reflected by the light combining element reaches the phosphor element are different from each other.

### Effect of the Invention

It is possible to provide a light source device having reduced local light saturation of a phosphor while reducing the increase in the number of optical components.

### BRIEF DESCRIPTION OF THE DRAWINGS

FIG. 1 is a configuration diagram illustrating a configuration of a projection display device 1 of a first embodiment.

FIG. 2 is a schematic diagram for explaining an arrangement configuration of excitation light sources and collimator lenses of the projection display device 1 of the first embodiment.

FIG. 3 is a schematic diagram for explaining an arrangement configuration of excitation light sources and collimator lenses of the projection display device 1 of the first embodiment.

FIG. 4 is a graph illustrating a wavelength-transmittance characteristic of a light combining element 70 of the first embodiment.

FIG. 5 is a schematic diagram illustrating other configurations of the light combining element 70 of the first embodiment.

FIG. 6 is a perspective view illustrating a shape of a light intensity equalizing element 113 of the first embodiment.

FIG. 7 is a diagram for explaining characteristics of the light combining element 70.

FIG. 8 is a simulation diagram illustrating an effect of the projection display device 1 of the first embodiment.

FIG. 9 is a schematic diagram illustrating an illuminance distribution on a phosphor element 40G of the first embodiment.

FIG. 10 is a diagram illustrating a simulation result of a spot image of excitation light on the phosphor element 40G of the first embodiment.

FIG. 11 is a diagram illustrating a simulation result of a spot image of excitation light on the phosphor element 40G of the first embodiment.

FIG. 12 is a diagram illustrating a simulation result of a spot image of excitation light on the phosphor element 40G of the first embodiment. FIG. 13 is a diagram illustrating a simulation result of a spot image of excitation light on the phosphor element 40G of the first embodiment.

FIG. 14 is a configuration diagram illustrating an arrangement configuration of a red light source unit 30R of the first embodiment.

FIG. 15 is a configuration diagram illustrating an arrangement configuration of a blue light source unit 20B of the first embodiment.

FIG. 16 is a diagram for explaining a projection optical system 124 of the first embodiment.

FIG. 17 is a schematic diagram for explaining a relationship between the projection optical system 124 and a projection surface 150 of the first embodiment.

FIG. 18 is a schematic diagram illustrating an illuminance distribution on the light intensity equalizing element 113 of the first embodiment.

FIG. 19 is a configuration diagram illustrating a configuration of a projection display device of a second embodiment.

FIG. 20 is a schematic diagram for explaining a feature of a rotary phosphor of the second embodiment.

FIG. 21 is a schematic diagram for explaining a feature of a rotary phosphor of the second embodiment.

FIG. 22 is a schematic diagram for explaining a feature of a rotary phosphor of the second embodiment.

FIG. 23 is a configuration diagram illustrating a configuration of a projection display device of a third embodiment.

FIG. 24 is a configuration diagram illustrating a configuration of a projection display device of a fourth embodiment.

FIG. 25 is a schematic diagram illustrating a shape of a light combining element 2300 of the fourth embodiment.

FIG. 26 is a simulation diagram illustrating an effect of the projection display device of the fourth embodiment.

FIG. 27 is a configuration diagram illustrating an example in which a light source device 1004 of the fourth embodiment is applied to a headlight of a vehicle.

FIG. 28 is a configuration diagram illustrating an example in which a light source device 1005 of the fourth embodiment is applied to a headlight of a vehicle.

FIG. 29 is a light ray trajectory diagram for explaining the behavior of light beams in an example in which the light source device 1004 or 1005 of the fourth embodiment is applied to a headlight of a vehicle.

### MODES FOR CARRYING OUT THE INVENTION

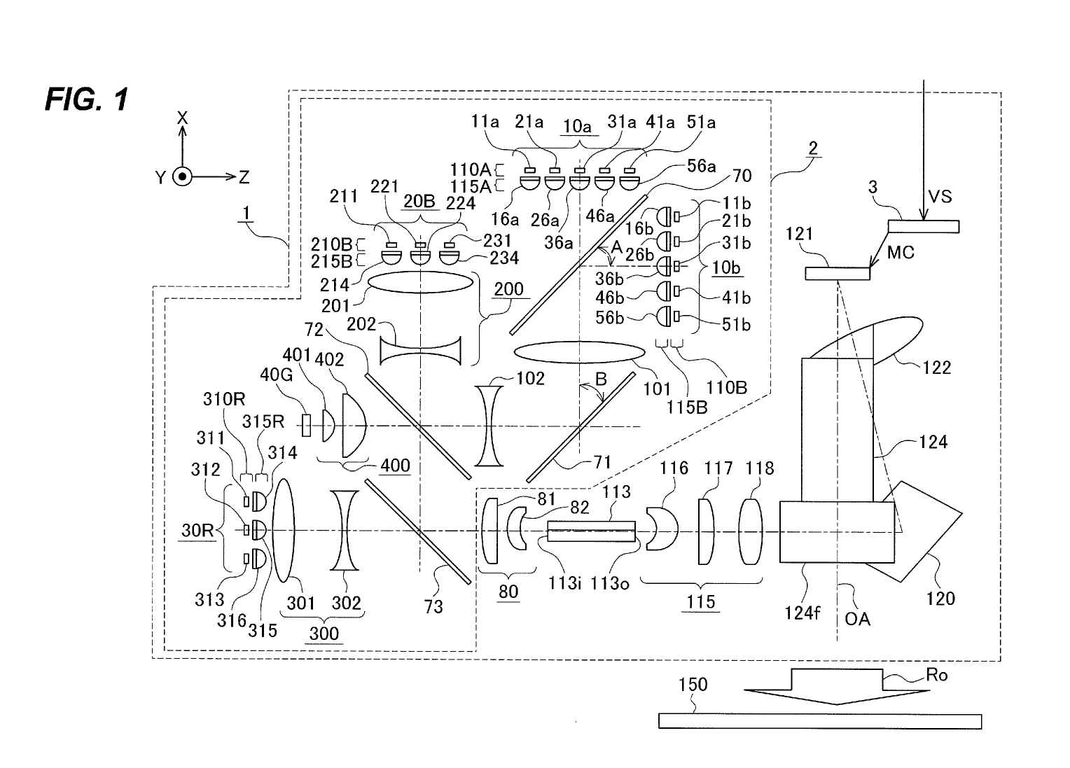

XYZ coordinates are used to facilitate explanation of drawings. FIG. 1 illustrates X, Y, and Z axes perpendicular to each other. The X axis is parallel to an optical axis OA of a projection optical system 124. The −X axis direction is a traveling direction of light in the projection optical system 124; the opposite direction is the +X axis direction. The Y axis is parallel to a height direction of a projection display device 1. The upward direction of the projection display device 1 is the +Y axis direction; the downward direction is the −Y axis direction. The Z axis is parallel to a lateral direction of the projection display device 1. That is, the Z axis is parallel to a width direction of the projection display device 1. As viewed from a direction (the −X axis direction) in which projection light Ro is emitted from the projection display device 1, the right direction is the +Z axis direction; the left direction is the −Z axis direction. A side of the projection display device 1 from which the projection light Ro is emitted will be referred to as “the front side”.

In the following description, a projection display device will be described as an example. In a modification of a fourth embodiment, a headlight for a vehicle will be described as an example.

### First Embodiment

### <Configuration of Projection Display Device 1>

FIG. 1 is a configuration diagram schematically illustrating the main components of the projection display device 1 of a first embodiment of the present invention. As illustrated in FIG. 1, the projection display device 1 includes a light source device 2, a light intensity equalizing element 113, an illumination optical system, a light valve 121, and the projection optical system 124. The projection display device 1 may also include a condensing optical system 80.

The illumination optical system may include a relay lens group 115, a deflecting mirror 120, or a condensing lens 122. The relay lens group 115 may include, for example, a concave-convex lens (meniscus lens) 116, a convex lens 117, or a biconvex lens 118. The condensing optical system 80 may include, for example, a convex lens 81 or a concave-convex lens (meniscus lens) 82.

The light source device 2 may include a first excitation light source unit 10a, a second excitation light source unit 10b, or a light combining element 70. The first excitation light source unit 10a includes, for example, a first excitation light source group 110A and a first collimator lens group 115A. The second excitation light source unit 10b includes, for example, a second excitation light source group 110B and a second collimator lens group 115B.

The light source device 2 may also include an afocal optical system. The afocal optical system is an optical system having an infinite focal length. In FIG. 1, for example, the afocal optical system includes a biconvex lens 101 and a biconcave lens 102.

The light source device 2 may also include lens groups 200 and 300. The lens group 200 includes, for example, a convex lens 201 and a concave lens 202. The lens group 300 includes, for example, a convex lens 301 and a concave lens 302.

The light source device 2 may also include a condensing lens group 400. In FIG. 1, for example, the condensing lens group 400 includes a convex lens 401 and an aspheric convex lens 402.

The light source device 2 may also include a deflecting mirror 71, a color separation filter 72, or a color separation filter 73.

The light source device 2 may also include a phosphor element 40G. The phosphor element 40G emits green fluorescence, for example.

The light source device 2 may also include a blue light source unit 20B. The blue light source unit 20B includes, for example, a blue light source group 210B and a collimator lens group 215B.

The light source device 2 may also include a red light source unit 30R. The red light source unit 30R includes, for example, a red light source group 310R and a collimator lens group 315R.

The light source device 2 may also include a controller 3.

The light valve 121 is a spatial light modulator that spatially modulates an incident light beam. The light valve 121 performs a control of two-dimensionally changing a characteristic of the incident light beam. Here, “characteristic” refers to, for example, a phase, a polarization state, an intensity, or a traveling direction of light. The light valve 121 controls light; or the light valve 121 adjusts light. The light valve is an optical element that controls light from a light source and outputs image light. Here, “image light” refers to light having image information.

The light valve 121 is, for example, a reflection type spatial light modulator. In the first embodiment, a digital micro-mirror device (referred to below as a DMD; registered trademark) is used as the light valve 121.

However, this is not mandatory. For example, a reflective liquid crystal element or a transmissive liquid crystal element may be used instead of the DMD. However, an optical system after the color separation filter 73 needs to be considered depending on the employed spatial light modulator.

The light valve 121 receives a light beam emitted from the condensing lens 122, for example.

The controller 3 generates a modulation control signal MC in accordance with an image signal VS supplied from an external signal source (not illustrated). The controller 3 supplies the modulation control signal MC to the light valve 121. The light valve 121 spatially modulates an incident light beam in accordance with the modulation control signal MC.

By the spatial modulation of the incident light beam, the light valve 121 generates and outputs modulated light. This modulated light is projected onto a projection surface 150, so that an optical image is displayed. “Modulated light” refers to light obtained by converting an image signal into an optical image to be projected onto a projection surface. “Image light” and “modulated light” are used interchangeably. “Projection surface” refers to, for example, a screen that reflects an image.

The projection optical system 124 refracts the modulated light (image light) emitted from the light valve 121 and emits projection light Ro. The projection light Ro is emitted from a front face 124f of the projection optical system 124 toward the projection surface 150. The projection optical system 124 can magnify and project an optical image represented by the modulated light onto the projection surface 150, which is an external screen or the like. The projection optical system 124 magnifies and projects the modulated light.

Here, the projection optical system 124 is, for example, a projection lens.

The projection surface 150 is, for example, a screen disposed on the outside.

### <Excitation Light Source Groups 110A and 110B, Phosphor Element 40G, and Green Light Beam>

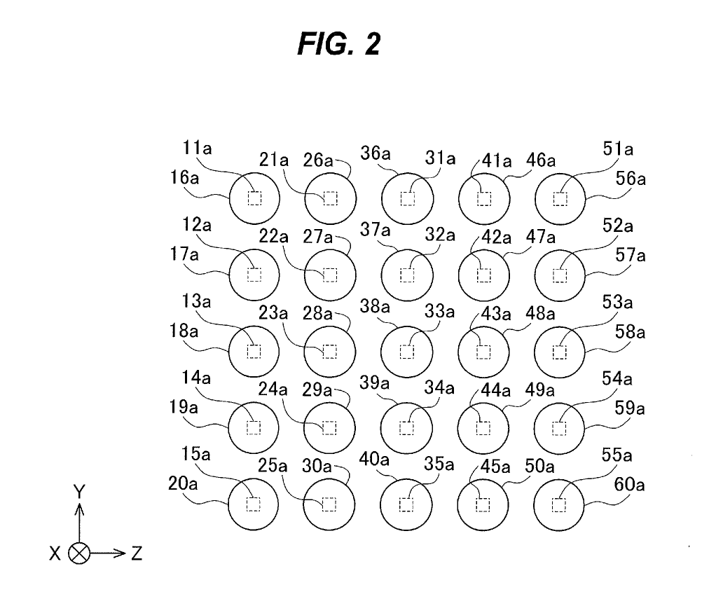

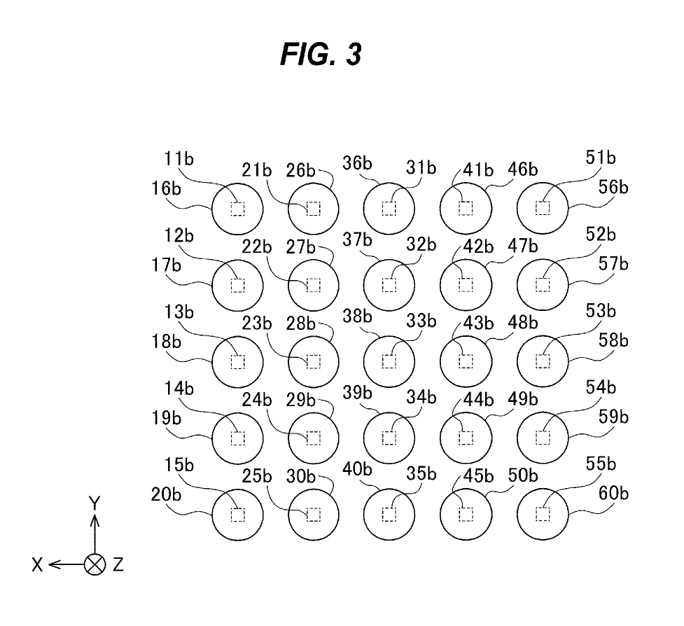

FIG. 2 is a schematic diagram for explaining an arrangement configuration of first excitation light sources (the first excitation light source group 110A) and first collimator lenses (the first collimator lens group 115A) of the projection display device 1. FIG. 3 is a schematic diagram for explaining an arrangement configuration of second excitation light sources (the second excitation light source group 110B) and second collimator lenses (the second collimator lens group 115B) of the projection display device 1.

The first excitation light source unit 10a includes multiple first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a (referred to below as the first excitation light source group 110A) arranged in a planar manner.

The first excitation light source unit 10a also includes multiple first collimator lenses 16a, 17a, 18a, 19a, 20a, 26a, 27a, 28a, 29a, 30a, 36a, 37a, 38a, 39a, 40a, 46a, 47a, 48a, 49a, 50a, 56a, 57a, 58a, 59a, and 60a (referred to below as the first collimator lens group 115A) arranged in a planar manner.

The first collimator lens group 115A is arranged on the −X axis direction side of the corresponding first excitation light source group 110A. For example, the first collimator lens 16a is disposed on the −X axis direction side of the corresponding first excitation light source 11a. Thus, in FIG. 2, the first excitation light source group 110A is indicated by dashed lines. For example, the first excitation light source 11a is indicated by a dashed line.

Each of the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a emits a light beam in the −X axis direction. That is, the first excitation light source group 110A emits multiple light beams in the −X axis direction.

Each of the first collimator lenses 16a, 17a, 18a, 19a, 20a, 26a, 27a, 28a, 29a, 30a, 36a, 37a, 38a, 39a, 40a, 46a, 47a, 48a, 49a, 50a, 56a, 57a, 58a, 59a, and 60a collimates the light beam emitted from the corresponding first excitation light source 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, or 55a. That is, the first collimator lens group 115A collimates the multiple light beams emitted from the first excitation light source group 110A in the −X axis direction. For example, the first collimator lens 16a collimates the light beam emitted from the corresponding first excitation light source 11a.

In the first embodiment, the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a are arranged on a Y-Z plane.

In the first embodiment, the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a are regularly arranged. The regular arrangement is, for example, a matrix arrangement described later.

For example, blue laser diodes (blue LDs) each emitting laser light in a blue wavelength range may be used as the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a.

The blue wavelength range has a center wavelength of 450 nm, for example. Excitation light sources having a center wavelength of 405 nm may be used.

As illustrated in FIG. 2, the first excitation light source group 110A is arranged on a Y-Z plane in a matrix having five rows and five columns. “Matrix” has “rows” and “columns”, which are two directions perpendicular to each other on a plane. For example, the light sources or the like are arranged at positions at which the “rows” and the “columns” intersect. “Arranged in a matrix” is an example of being regularly arranged on a plane.

The first excitation light source group 110A and first collimator lens group 115A are disposed on the +X axis direction side of the light intensity equalizing element 113 and relay lens group 115.

The first excitation light source group 110A emits light beams in the −X axis direction.

The first collimator lens group 115A is disposed on the −X axis direction side of the first excitation light source group 110A.

The first collimator lens group 115A converts the light emitted from the first excitation light source group 110A into parallel light beams and emits them.

The first collimator lens group 115A emits the light emitted from the first excitation light source group 110A in the −X axis direction.

The light combining element 70 is disposed on the −X axis direction side of the first collimator lens group 115A.

The parallel light beams emitted from the first collimator lens group 115A are incident on the light combining element 70. The parallel light beams incident on the light combining element 70 then pass through the light combining element 70. That is, the light combining element 70 has a characteristic of transmitting parallel light beams emitted from the first collimator lens group 115A. The characteristic of the light combining element 70 will be described later.

The parallel light beams passing through the light combining element 70 then travel in the −X axis direction.

The biconvex lens 101 is disposed on the −X axis direction side of the light combining element 70. The parallel light beams passing through the light combining element 70 travel toward the biconvex lens 101.

The second excitation light source unit 10b includes multiple second excitation light sources lib, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b (referred to below as the second excitation light source group 110B) arranged in a planar manner.

The second excitation light source unit 10b also includes multiple second collimator lenses 16b, 17b, 18b, 19b, 20b, 26b, 27b, 28b, 29b, 30b, 36b, 37b, 38b, 39b, 40b, 46b, 47b, 48b, 49b, 50b, 56b, 57b, 58b, 59b, and 60b (referred to below as the second collimator lens group 115B) arranged in a planar manner.

The second collimator lens group 115B is arranged on the −Z axis direction side of the corresponding second excitation light source group 110B. For example, the second collimator lens 16b is arranged on the −Z axis direction side of the corresponding second excitation light source 11b. Thus, in FIG. 3, the second excitation light source group 110B is indicated by dashed lines. For example, the second excitation light source 11b is indicated by a dashed line.

Each of the second excitation light sources lib, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b emits a light beam in the −Z axis direction. The second excitation light source group 110B emits multiple light beams in the −Z axis direction.

Each of the second collimator lenses 16b, 17b, 18b, 19b, 20b, 26b, 27b, 28b, 29b, 30b, 36b, 37b, 38b, 39b, 40b, 46b, 47b, 48b, 49b, 50b, 56b, 57b, 58b, 59b, and 60b collimates the light beam emitted from the corresponding second excitation light source 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, or 55b. The second collimator lens group 115B collimates the multiple light beams emitted from the second excitation light source group 110B in the −Z axis direction. For example, the second collimator lens 16b collimates the light beam emitted from the corresponding second excitation light source 11b.

In the first embodiment, the second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b are arranged on an X-Y plane.

In the first embodiment, the second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b are regularly arranged. The regular arrangement is, for example, a matrix arrangement described later.

For example, blue laser diodes (blue LDs) each emitting laser light in a blue wavelength range may be used as the second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b.

The blue wavelength range has a center wavelength of 450 nm, for example. Excitation light sources having a center wavelength of 405 nm may be used.

In the first embodiment, the polarization direction of the second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b is different by 90 degrees from the polarization direction of the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a.

For example, the first excitation light sources 11a, 12a, 13a, 14a, 15a, 21a, 22a, 23a, 24a, 25a, 31a, 32a, 33a, 34a, 35a, 41a, 42a, 43a, 44a, .45a, 51a, 52a, 53a, 54a, and 55a are P-polarized light. The second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b are S-polarized light.

As illustrated in FIG. 3, the second excitation light source group 110B is arranged on an X-Y plane in a matrix having five rows and five columns.

The second excitation light source group 110B and second collimator lens group 115B are disposed on the +X axis direction side of the light intensity equalizing element 113 and relay lens group 115.

The second excitation light source group 110B emits light beams in the −Z axis direction.

The second collimator lens group 115B is disposed on the −Z axis direction side of the second excitation light source group 110B.

The second collimator lens group 115B converts the light emitted from the second excitation light source group 110B into parallel light beams and emits them.

The second collimator lens group 115B emits the light emitted from the second excitation light source group 110B in the −Z axis direction.

The light combining element 70 is disposed on the −Z axis direction side of the second collimator lens group 115B.

The parallel light beams emitted from the second collimator lens group 115B are incident on the light combining element 70 at an angle A. The parallel light beams incident on the light combining element 70 are then reflected by the light combining element 70. The light combining element 70 has a characteristic of reflecting parallel light beams emitted from the second collimator lens group 115B.

The parallel light beams reflected by the light combining element 70 then travel in the −X axis direction.

Here, the angle A is an angle having a value obtained by subtracting an incident angle P1 from 90 degrees. The incident angle P1 is defined as the angle between the traveling direction of the light and the normal to the boundary surface. In FIG. 1, the angle formed by the light emitted from the second excitation light source group 110B and the reflection surface of the light combining element 70 is the angle A.

The biconvex lens 101 is disposed on the −X axis direction side of the light combining element 70. The parallel light beams reflected by the light combining element 70 travel toward the biconvex lens 101.

Thereby, the parallel light beams emitted from the first collimator lens group 115A and the parallel light beams emitted from the second collimator lens 115B are combined on the same optical path.

The light beams emitted from the first excitation light source group 110A and the light beams emitted from the second excitation light source group 110B are combined on the same optical path.

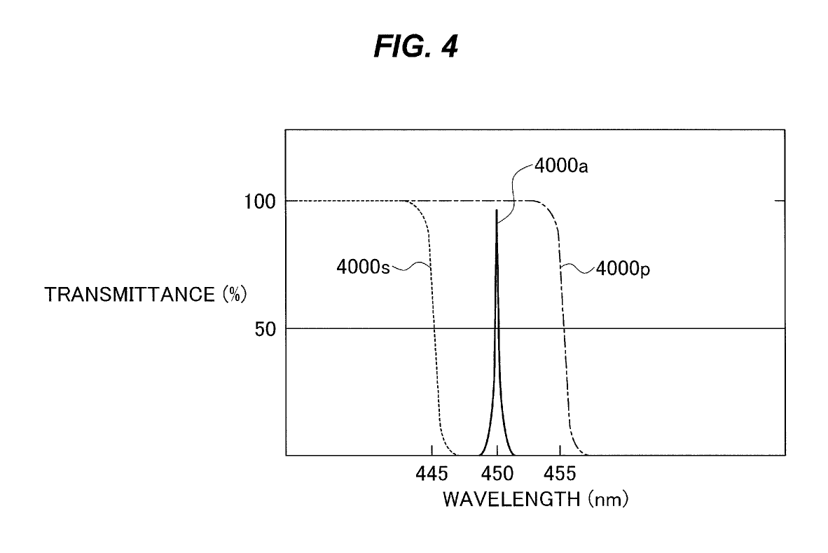

The light combining element 70 has, for example, a wavelength-transmission characteristic illustrated in FIG. 4. FIG. 4 is a graph illustrating a wavelength-transmittance characteristic of the light combining element 70. The vertical axis of FIG. 4 is optical transmittance [%]. The horizontal axis of FIG. 4 is wavelength of light [nm].

In FIG. 4, the spectrum of an excitation light source having a center wavelength of 450 nm is indicated by a solid line 4000a. The transmittance characteristic of S-polarized light is indicated by a dashed line 4000s. The transmittance characteristic of P-polarized light is indicated by a dot-and-dash line 4000p.

In FIG. 4, it can be seen that the light combining element 70 has a characteristic of transmitting P-polarized light having a center wavelength of 450 nm. It can also be seen that the light combining element 70 has a characteristic of reflecting S-polarized light having a center wavelength of 450 nm.

The first excitation light source group 110A is P-polarized light, and the second excitation light source group 110B is S-polarized light. Light emitted from the first excitation light source group 110A passes through the light combining element 70. Light emitted from the second excitation light source group 110B is reflected by the light combining element 70.

Both the light emitted from the first excitation light source group 110A and the light emitted from the second excitation light source group 110B travel in the −X axis direction.

The light combining element 70 may employ other configurations as long as the first excitation light source group 110A and second excitation light source group 110B are combined.

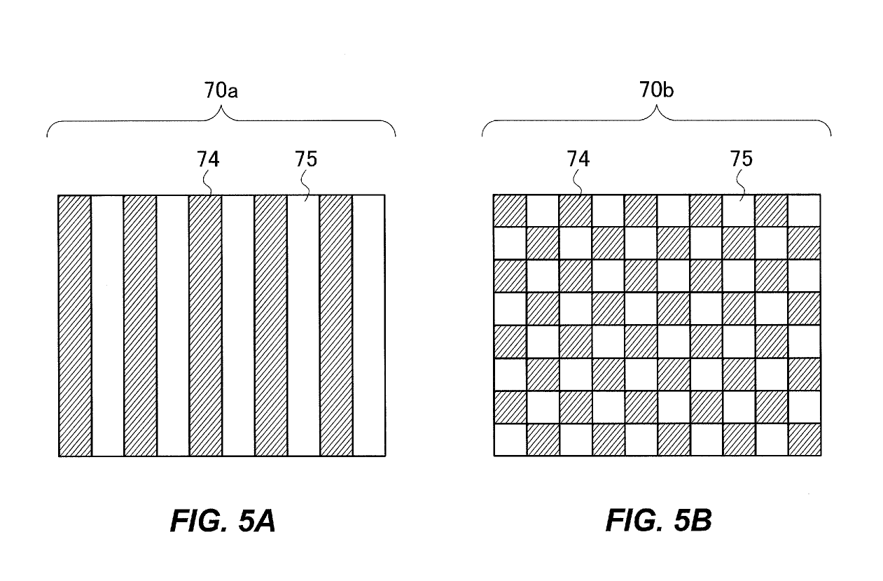

FIGS. 5A and 5B are schematic diagrams illustrating other configurations of the light combining element 70. FIG. 5A is an example of a light combining element 70a in which reflection regions 74 and transmission regions 75 are alternately formed in stripes. FIG. 5B is an example of a light combining element 70b in which reflection regions 74 and transmission regions 75 are formed in a checkered pattern.

For example, as disclosed in W02013-105546, the reflection regions 74 and transmission regions 75 may be alternately formed in stripes. One example is illustrated in FIG. 5A. This makes it possible to combine light regardless of the polarization directions.

As the light combining element 70, multiple mirrors having reflection surfaces at the positions of the reflection regions 74 may be arranged.

The light combining element 70 may have a structure in which openings are formed in the transmission regions 75. That is, the transmission regions 75 may be regions of space that does not pass through the inside of the optical element (light combining element 70).

The reflection regions 74 and transmission regions 75 may be formed in a checkered pattern. This makes it possible to form a denser light beam. “Checkered pattern” refers to alternately arranging two rows of items. That is, it refers to sequentially arranging two different items in two rows while reversing the rows. For example, it refers to sequentially arranging the reflection regions 74 and transmission regions 75 in two rows while reversing the rows.

FIG. 5B illustrates an example of the checkered light combining element 70b in which the reflection regions 74 and transmission regions 75 are arranged in eight rows and eight columns. The gray parts are the reflection regions 74.

The reflection surfaces of the reflection regions 74 are formed by, for example, evaporating a reflecting metal film on a glass surface.

On the other hand, the transmission regions 75 are, for example, regions in which reflection surfaces are not formed on glass surfaces as in the reflection regions 74.

For example, if the reflection surfaces are formed on one side of a transparent plate, such as a glass plate, the reflection surfaces of the reflection regions 74 and transmission surfaces of the transmission regions 75 are formed on the same plane.

The light combining element 70 having the characteristic of FIG. 4 can combine a light beam emitted from the first excitation light source group 110A and a light beam emitted from the second excitation light source group 110B at the same position on a surface of the light combining element 70.

Thus, it has an advantage that the diameter of the light beam emitted from the light combining element 70 can be made small as compared to other ways. The light beam emitted from the light combining element 70 is formed of a bundle of multiple light beams emitted from the excitation light source groups 110A and 110B. Here, the bundle of the multiple light beams will be referred to as the total light beam. Light concentration efficiency onto the phosphor element 40G improves as the diameter of the total light beam decreases.

The biconvex lens 101 receives the light beams passing through the light combining element 70 and the light beams reflected by the light combining element 70. The biconvex lens 101 and biconcave lens 102 reduce the diameter of the total light beam, which is formed of a bundle of the multiple parallel light beams, and then convert it into parallel light beams again.

In FIG. 1, the biconvex lens 101 concentrates the multiple parallel light beams (total light beam). The biconvex lens 101 has convex shapes on both sides, for example. However, the biconvex lens 101 may be a lens having a convex shape only on one side.

The biconcave lens 102 converts the multiple concentrated light beams (total light beam) into parallel light beams. The biconcave lens 102 has concave shapes on both sides, for example. However, the biconcave lens 102 may be a lens having a concave shape only on one side.

The deflecting mirror 71 is disposed on the −X axis direction side of the biconvex lens 101.

The concentrated light beams exiting the biconvex lens 101 are incident on the deflecting mirror 71 at an angle B. In FIG. 1, an angle formed by light reflected by or passing through the light combining element 70 and a reflection surface of the deflecting mirror 71 is the angle B.

In FIG. 1, for example, if the angle A is 45 degrees, a central light ray of the concentrated light beams exiting the biconvex lens 101 is parallel to the X axis. Thus, the concentrated light beams exiting the biconvex lens 101 are incident on the deflecting mirror 71 inclined by the angle B with respect to an X-Y plane.

Here, an angle of clockwise rotation from an X-Y plane as viewed from the +Y axis is the angle B. In FIG. 1, the angle B is an angle having a value obtained by subtracting an incident angle P1 from 90 degrees. The incident angle P1 is defined as the angle between the traveling direction of the light and the normal to the boundary surface.

The biconcave lens 102 is disposed on the −Z axis direction side of the deflecting mirror 71.

The concentrated light beams reflected by the deflecting mirror 71 travel toward the biconcave lens 102. The concentrated light beams reflected by the deflecting mirror 71 travel in the −Z axis direction.

The concentrated light beams reflected by the deflecting mirror 71 are incident on the biconcave lens 102. The parallel light beams exiting the biconcave lens 102 travel in the −Z axis direction.

The color separation filter 72 is disposed on the −Z axis direction side of the biconcave lens 102.

The parallel light beams exiting the biconcave lens 102 travel in the −Z axis direction. The parallel light beams exiting the biconcave lens 102 travel toward the color separation filter 72.

The parallel light beams exiting the biconcave lens 102 are incident on the color separation filter 72. The parallel light beams emitted from the biconcave lens 102 pass through the color separation filter 72. The parallel light beams passing through the color separation filter 72 travel in the −Z axis direction.

The condensing lens group 400 is disposed on the −Z axis direction side of the color separation filter 72.

The light beams passing through the color separation filter 72 travel in the −Z axis direction. The light beams passing through the color separation filter 72 travel toward the condensing lens group 400.

The light beams passing through the color separation filter 72 are incident on the condensing lens group 400. The light beams passing through the color separation filter 72 pass through the condensing lens group 400. The light beams passing through the condensing lens group 400 travel in the −Z axis direction.

The condensing lens group 400 includes, for example, two convex lenses 401 and 402. The condensing lens group 400 concentrates the light beams passing through the color separation filter 72 on the phosphor element 40G.

The phosphor element 40G is disposed on the −Z axis direction side of the condensing lens group 400.

The light beams passing through the condensing lens group 400 travel in the −Z axis direction. The light beams passing through the condensing lens group 400 travel toward the phosphor element 40G. The light beams passing through the condensing lens group 400 are concentrated on the phosphor element 40G.

The color separation filter 72 has, for example, an optical characteristic of reflecting incident light in a green wavelength range and incident light in a red wavelength range. The color separation filter 72 also has an optical characteristic of transmitting incident light in a blue wavelength range.

For example, the color separation filter 72 can be formed by a dichroic mirror having a dielectric multi-layer film. “Wavelength range” refers to a range of wavelengths of light.

Different light wavelengths are classified, for example, as follows: a blue wavelength range is from 430 nm to 485 nm; a green wavelength range is from 500 nm to 570 nm; a red wavelength range is from 600 nm to 650 nm.

The phosphor element 40G absorbs the incident light beams as excitation light. The phosphor element 40G then outputs light in a green wavelength range having a main wavelength of 550 nm.

As described above, the light beams emitted from the first excitation light source group 110A illustrated in FIG. 1 and the light beams emitted from the second excitation light source group 110B are combined by the light combining element 70 on the same optical path. Thereby, the light beams emitted from the excitation light source groups 110A and 110B can double the luminance.

Further, the biconvex lens 101 and biconcave lens 102 narrow intervals between multiple parallel light beams emitted from the excitation light source groups 110A and 110B. This reduces the diameter of the total light beam formed of a bundle of the multiple parallel light beams incident on the phosphor element 40G. Further, it is possible to reduce the diameter of the lens 402 and make it compact.

The main wavelength of the green wavelength range emitted by the phosphor element 40G is not limited to 550 nm and may be, for example, 520 nm.

The use of such an optical system makes it possible to irradiate the phosphor element 40G with a light beam having a diameter of 2 mm, for example.

For example, a light diffusion element may be disposed between the biconcave lens 102 and the color separation filter 72 so as to equalize the intensity distribution of the light beam concentrated on the phosphor element 40G. The light diffusion element reduces unevenness of light density of the light beam in the position on which the light is concentrated.

This reduces temperature rise on the phosphor element 40G. This improves the conversion efficiency of the phosphor element 40G. Further, the lifetime of the phosphor element 40G can be prolonged.

In the first embodiment, the phosphor element 40G is disposed in a fixed manner. However, this is not mandatory.

For example, a green phosphor applied to a rotating plate may be used instead of the phosphor element 40G. For example, the green phosphor may be applied to a peripheral part of the rotating plate. This makes it possible to simplify a cooling mechanism for the phosphor element 40G. Specifically, the position at which the light is concentrated on the green phosphor is not fixed and continuously changed due to rotation of the rotating plate, so that partial temperature rise of the green phosphor can be reduced.

In FIG. 1, the condensing lens group 400 includes the two convex lenses 401 and 402. In a case where the light emitted from the phosphor element 40G is collimated using the two convex lenses 401 and 402, it is preferable in design that the convex lens 402 have an aspherical shape.

In the first embodiment, the condensing lens group 400 consists of two lenses. However, the number of lenses of the condensing lens group 400 is not limited to two. The condensing lens group 400 may consist of three lenses.

If the condensing lens group 400 consists of three lenses, glass material such as synthetic quartz can be used in the lens closest to the phosphor element 40G. Synthetic quartz is glass material having a small linear expansion coefficient and a high heatproof temperature. Glass material, such as synthetic quartz, having high heat resistance typically has a low refractive index. Thus, in a two-lens configuration, depending on the configuration, it is difficult to improve light concentration efficiency.

Further, the lens closest to the phosphor element 40G is close to the light concentration position of the light beam, so that it is subjected to light of high intensity and a temperature gradient is likely to occur in the lens. If a temperature gradient occurs in the lens, a tensile stress due to the temperature gradient occurs in the lens. Then, a crack is likely to occur in the lens. By using glass material, such as synthetic quartz, having a small linear expansion coefficient and high heat resistance, it is possible to prolong the lifetime of a high-power light source device. In FIG. 1, the lens closest to the phosphor element 40G is the convex lens 401.

The condensing lens group 400 is disposed on the +Z axis direction side of the phosphor element 40G.

The light emitted from the phosphor element 40G travels in the +Z axis direction. The light emitted from the phosphor element 40G is incident on the condensing lens group 400.

The condensing lens group 400 collimates and emits the light emitted from the phosphor element 40G.

The color separation filter 72 is disposed on the +Z axis direction side of the condensing lens group 400. The color separation filter 72 is also disposed on the +Z axis direction side of the phosphor element 40G.

The light passing through the condensing lens group 400 travels in the +Z axis direction. The light passing through the condensing lens group 400 reaches the color separation filter 72.

The light (green fluorescence) passing through the condensing lens group 400 is reflected by the color separation filter 72.

The color separation filter 73 is disposed on the −X axis direction side of the color separation filter 72.

The light reflected by the color separation filter 72 travels in the −X axis direction. The light reflected by the color separation filter 72 reaches the color separation filter 73.

The light (green fluorescence) reflected by the color separation filter 72 is reflected by the color separation filter 73.

The condensing optical system 80 is disposed on the +Z axis direction side of the color separation filter 73.

The light reflected by the color separation filter 73 travels in the +Z axis direction. The light reflected by the color separation filter 73 reaches the condensing optical system 80.

The light reflected by the color separation filter 73 is concentrated by the condensing optical system 80.

The light intensity equalizing element 113 is disposed on the +Z axis direction side of the condensing optical system 80.

The light concentrated by the condensing optical system 80 travels in the +Z axis direction.

The concentrated light concentrated by the condensing optical system 80 is concentrated on an incident end surface 113i of the light intensity equalizing element 113. In FIG. 1, the incident end surface 113i is an end surface on the −Z axis direction side of the light intensity equalizing element 113.

The color separation filter 73 has an optical characteristic of transmitting light in a red wavelength range. The color separation filter 73 also has an optical characteristic of reflecting light in a green wavelength range and light in a blue wavelength range. For example, the color separation filter 73 can have a dichroic mirror formed of a dielectric multi-layer film.

The above-described biconvex lens 101 and biconcave lens 102 has a function of collimating an incident light beam. However, this is not mandatory. It is sufficient that the light emitted by the excitation light source groups 110A and 110B is concentrated on the phosphor element 40G by the combination of the biconvex lens 101, biconcave lens 102, and condensing lens group 400.

However, it is necessary that the light (light emitted by the phosphor) emitted from the phosphor element 40G is concentrated on the incident end surface 113i of the light intensity equalizing element 113 by the combination of the condensing lens group 400 and condensing optical system 80.

Thus, as described in the first embodiment, it is preferable in design that the light beam traveling from the condensing lens group 400 toward the color separation filter 72 be already collimated. That is, it is preferable that the biconvex lens 101 and biconcave lens 102 have a function of collimating an incident light beam.

The light intensity equalizing element 113 is an optical element that equalizes a light intensity distribution of an incident light beam. The light intensity equalizing element 113 equalizes a light intensity distribution in a plane perpendicular to an optical axis of the light intensity equalizing element 113.

In FIG. 1, the optical axis of the light intensity equalizing element 113 coincides with an optical axis of the light entering through the incident end surface 113i. The light intensity equalizing element 113 equalizes a light intensity distribution in a cross-section perpendicular to the optical axis of the light entering through the incident end surface 113i.

The light propagating in the light intensity equalizing element 113 is repeatedly totally reflected by an inner surface of the light intensity equalizing element 113. Thereby, the light propagating in the light intensity equalizing element 113 becomes superposed light in the vicinity of an emitting end surface 113o.

Thereby, the light intensity distribution in the emitting end surface 113o is more uniform than the light intensity distribution in the incident end surface 113i. That is, the light intensity equalizing element 113 receives light, converts it into light having a light intensity distribution with. enhanced uniformity, and emits it. In the following description, to simplify the explanation, it is assumed that the light emitted from the emitting end surface 113o has a uniform light intensity distribution.

In the vicinity of the emitting end surface 113o, the light propagating in the light intensity equalizing element 113 can obtain a uniform light intensity distribution. Thus, the emitting end surface 113o of the light intensity equalizing element 113 becomes a surface light source that emits light with uniform brightness. In FIG. 1, the emitting end surface 113o is an end surface on the +Z axis direction side of the light intensity equalizing element 113.

Thereby, the light intensity distribution of the light beam to be incident on the light valve 121 is equalized. Thus, the light valve 121 receives a light beam having a uniform light intensity distribution. The light valve 121 then converts the light beam having the uniform light intensity distribution into modulated light, and emits it.

For example, the light intensity equalizing element 113 is made of transparent optical material. The transparent optical material is glass material, transparent resin material, or the like.

For example, the light intensity equalizing element 113 is a polygonal column (rod). The light intensity equalizing element 113 has the incident end surface 113i and emitting end surface 113o. The side surfaces are surfaces connecting the incident end surface 113i and the emitting end surface 113o.

The side surfaces of the polygonal column are used as total reflection surfaces. The light propagating in the light intensity equalizing element 113 is totally reflected at an interface between the optical material and external air.

The light intensity equalizing element 113 may be, for example, a hollow pipe (light pipe). The hollow portion has side surfaces of light reflecting mirrors. Specifically, light reflecting films for reflecting light are formed on the inner side surfaces of the hollow pipe. The hollow pipe has a cross-section of a polygonal shape, for example.

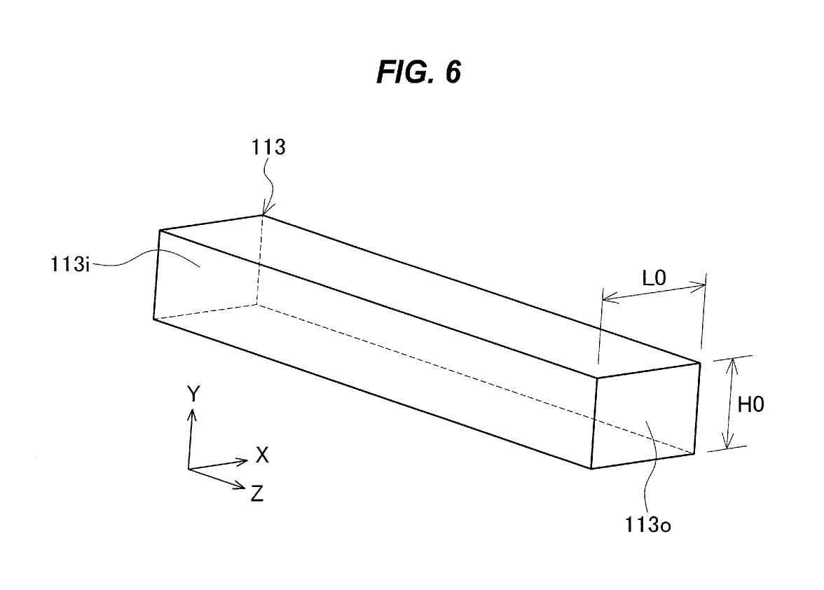

FIG. 6 is a perspective view illustrating an example of the light intensity equalizing element 113. The light intensity equalizing element 113 illustrated in FIG. 6 has a quadrangular prism shape. The light intensity equalizing element 113 has a rectangular cross-section in an X-Y plane.

The side surfaces of the light intensity equalizing element 113 are configured to serve as light reflecting mirrors or total reflection surfaces.

The light intensity equalizing element 113 has a longitudinal direction in the Z axis direction. Here, “longitudinal direction” refers to a direction parallel to long sides of the quadrangular prism. “Long sides of the quadrangular prism” refers to the longest sides of the twelve sides of the quadrangular prism. The number of longest sides of the quadrangular prism is typically four.

The light intensity equalizing element 113 has a column shape. “Column” refers to a columnar spatial figure having two congruent plane figures as bases. The distance between the two bases is referred to as a height of the column. The surfaces of the column other than the bases are referred to as side surfaces.

In FIG. 6, the two bases are parallel to an X-Y plane. The direction of the height of the column is the Z axis direction. In the first embodiment, the incident end surface 113i and emitting end surface 113o are formed at the bases of the column shape.

In the first embodiment, the emitting end surface 113o of the light intensity equalizing element 113 and a light modulating surface of the light valve 121 are in optically conjugate relation with each other. “Conjugate relation” refers to a relation between an object and an image in an optical system. In the conjugate relation, light emitted from one point concentrates at one point.

In the optical system in the first embodiment, an image on the emitting end surface 113o is formed on the light modulating surface of the light valve 121. Thus, in view of light use efficiency, it is preferable that an aspect ratio L:H of the light modulating surface of the light valve 121 be equal to an aspect ratio L0:H0 of the emitting end surface 113o of the light intensity equalizing element 113.

Here, L and L0 denote horizontal dimensions. H and H0 denote vertical dimensions. If the resolution is XGA (the number of horizontal pixels x the number of vertical pixels=1024×768), L:H is typically 4:3. The first embodiment assumes that long sides are horizontal and short sides are vertical.

As illustrated in FIG. 1, the relay lens group 115 is disposed on the +Z axis direction side of the light intensity equalizing element 113.

The light emitted from the emitting end surface 113o of the light intensity equalizing element 113 travels in the +Z axis direction. The light emitted from the emitting end surface 113o of the light intensity equalizing element 113 then reaches a relay optical system. In FIG. 1, the light emitted from the emitting end surface 113o of the light intensity equalizing element 113 is incident on the relay lens group 115.

The relay optical system guides the light beam having the uniform light intensity distribution to the light valve 121. Here, “relay optical system” refers to an optical system from the relay lens group 115 to the light valve 121.

The relay lens group 115 includes, for example, the concave-convex lens (meniscus lens) 116, convex lens 117, and biconvex lens 118. The concave-convex lens is a lens having two lens surfaces one of which is concave and the other of which is convex.

In FIG. 1, the relay lens group 115 consists of the three lenses 116, 117, and 118. However, the relay lens group 115 may consist of two lenses. In this case, it is preferable in design to narrow the distance between the light intensity equalizing element 113 and the deflecting mirror 120.

The deflecting mirror 120 is disposed on the +Z axis direction side of the relay lens group 115.

The light emitted from the relay lens group 115 travels in the +Z axis direction. The light emitted from the relay lens group 115 then reaches the deflecting mirror 120. The light beam emitted from the emitting end surface 113o of the light intensity equalizing element 113 passes through the relay lens group 115 and reaches the deflecting mirror 120.

The deflecting mirror 120 has a function of folding the optical path of the light beam.

The light beam passing through the relay lens group 115 is reflected by the deflecting mirror 120 toward the condensing lens 122.

In FIG. 1, the condensing lens 122 is disposed on the +X axis direction side of the deflecting mirror 120. The condensing lens 122 is disposed between the deflecting mirror 120 and the light valve 121.

The light beam passing through the relay lens group 115 is reflected by the deflecting mirror 120 toward the light valve 121.

The light reflected by the deflecting mirror 120 reaches the condensing lens 122. The condensing lens 122 concentrates the incident light.

The light valve 121 is disposed on the +X axis direction side of the condensing lens 122.

The light concentrated by the condensing optical system 122 travels toward the +X axis direction side.

The concentrated light concentrated by the condensing optical system 122 is concentrated on the light valve 121.

The light beam reflected by the deflecting mirror 120 passes through the condensing lens 122 and is incident on the light valve 121.

The above-described various optical members 400, 72, 73, 80, 113, 115, 120, and 122 constitute a light guiding optical system that guides the light emitted from the phosphor element 40G to the light valve 121. “Light guiding” refers to guiding light. In the first embodiment, the light emitted by the phosphor element 40G is guided from the phosphor element 40G to the light valve 121.

The controller 3 has a function of controlling the operation of the light valve 121. The controller 3 may also have a function of controlling timing for causing the first excitation light source group 110A, second excitation light source group 110B, blue light source group 210B, or red light source group 310R to emit light.

The timing for light emission is controlled individually for each light source in accordance with the image signal VS. The controller 3 controls the operation of the light valve 121 in synchronization with the light emitting timing of each of the first excitation light source group 110A, second excitation light source group 110B, blue light source group 210B, and red light source group 310R.

### <Reduction of Local Light Saturation of Phosphor Element 40G>

Here, the angle A of the light beam incident on the light combining element 70 and the angle B of the light beam incident on the deflecting mirror 71 will be described.

As described above, in the first embodiment, if the angle A is 45 degrees, the central light ray of the concentrated light beams exiting the biconvex lens 101 is parallel to the X axis. The deflecting mirror 71 is rotated clockwise by the angle B relative to an X-Y plane as viewed from the +Y axis.

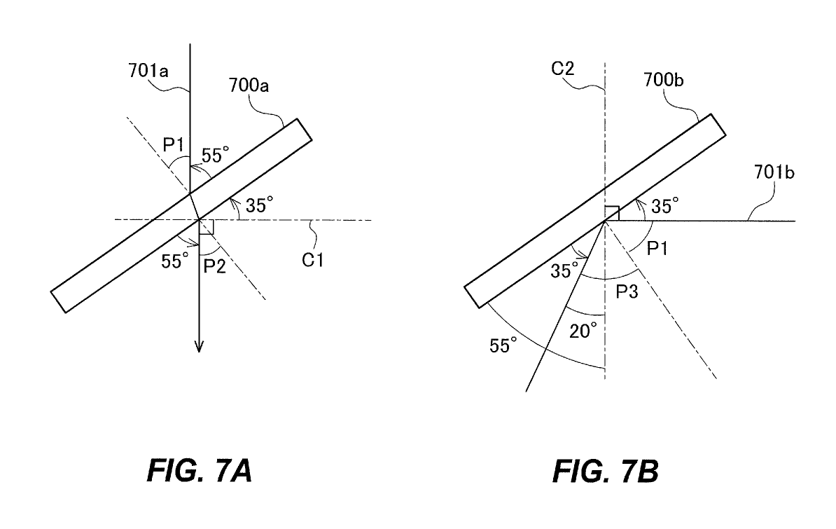

FIGS. 7A and 7B are diagrams for explaining characteristics of the light combining element 70. FIG. 7A is a diagram for explaining a characteristic when light passes through the light combining element 70. FIG. 7B is a diagram for explaining a characteristic when light is reflected by the light combining element 70. FIG. 7A illustrates a light combining element 700a as the light combining element 70. FIG. 7B illustrates a light combining element 700b as the light combining element 70.

The parallel light beams emitted from the first excitation light sources 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, and 55a pass through the light combining element 70 regardless of the angle A without change in their traveling directions. Thus, as illustrated in FIG. 7A, a light ray 701a passing through the light combining element 700a travels in a direction parallel to the X axis in FIG. 1. The light combining element 700a illustrated in FIG. 7A corresponds to the light combining element 70 illustrated in FIG. 1. The angle of 35 degrees illustrated in FIG. 7A corresponds to the angle A illustrated in FIG. 1. The light beams passing through the light combining element 70 are light beams collimated by the first collimator lens group 115A.

As illustrated in FIG. 7A, the light ray 701a is incident on the light combining element 700a at 55 degrees and exits from the light combining element 700a at 55 degrees. Here, the angle of 55 degrees at which the light ray 701a is incident on the light combining element 700a is an angle having a value obtained by subtracting an incident angle P1 from 90 degrees. The angle of 55 degrees at which the light ray 701a exits from the light combining element 700a is an angle having a value obtained by subtracting an emission angle P2 from 90 degrees.

The incident angle P1 is defined as an angle between the traveling direction of the light and the normal to the boundary surface. The emission angle P2 is defined as an angle between the traveling direction of the light and the normal to the boundary surface.

In FIG. 1, the angle formed by an optical axis of light emitted from the first excitation light source unit 10a and an optical axis of light emitted from the second excitation light source unit 10b is 90 degrees. Thus, the angle of 55 degrees at which the light ray 701a is incident on the light combining element 700a is an angle having a value obtained by subtracting the angle A illustrated in FIG. 1 from 90 degrees. The light ray 701a is incident on the light combining element 700a at an angle of 90 degrees with respect to an axis C1 and exits the light combining element 700a at an angle of 90 degrees with respect to the axis C1.

The axis C1 is defined as follows. From a state in which the light ray 701a is perpendicularly incident on the light combining element 700a, the light combining element 700a is rotated about an axis (a rotational axis of the light combining element 700a) perpendicular to the light ray 701a. In this case, the axis C1 is a normal to a plane including the light ray 701a and the rotational axis of the light combining element 700a.

In FIG. 7B, the optical axis of light emitted from the second excitation light source unit 10b coincides with the axis C1.

The axis C1 illustrated in FIG. 7A corresponds to the Z axis illustrated in FIG. 1. In FIG. 7A, the light combining element 700a is rotated by 35 degrees about the rotational axis of the light combining element 700a. The angle formed by an incident surface of the light combining element 700a and the light ray 701a is 55 degrees.

On the other hand, the parallel light beams emitted from the second excitation light sources 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, and 55b are incident on the light combining element 70 at the angle A and reflected at the angle A. Thus, as illustrated in FIG. 7B, a light ray 701b incident on the light combining element 700b at an angle of 35 degrees is emitted from the light combining element 700b at an angle of 35 degrees. The light combining element 700b illustrated in FIG. 7B corresponds to the light combining element 70 illustrated in FIG. 1. The angle of 35 degrees illustrated in FIG. 7B corresponds to the angle A illustrated in FIG. 1. The light beams reflected by the light combining element 70 are light beams collimated by the second collimator lens group 115B.

The angle formed by a reflection surface of the light combining element 700b and the light ray 701b incident on the light combining element 700b is 35 degrees. The angle formed by the reflection surface of the light combining element 700b and the light ray 701b reflected by the light combining element 700b is also 35 degrees.

Thus, as illustrated in FIG. 7B, the light ray 701b does not travel in a direction parallel to the X axis in FIG. 1. The axis C2 illustrated in FIG. 7B corresponds to the X axis illustrated in FIG. 1. As described above, the angle of 35 degrees at which the light ray 701b is incident on the light combining element 700b corresponds to the angle A illustrated in FIG. 1.

The angle of 35 degrees at which the light ray 701b is reflected by the light combining element 700b is an angle having a value obtained by subtracting a reflection angle P3 from 90 degrees. The reflection angle P3 is defined as an angle between the traveling direction of the reflected light and the normal to the boundary surface.

The light ray 701b is incident on the light combining element 700b at an angle of 90 degrees with respect to the axis C2. The light ray 701b incident on the light combining element 700b is reflected at an angle of 20 degrees with respect to the axis C2. “20 degrees” described here is a value obtained by subtracting the angle of 35 degrees, at which it is reflected by the light combining element 700b, from the angle of 55 degrees, by which the light combining element 700b is inclined to the axis C2.

That is, the light ray 701b is not reflected in a direction parallel to the axis C2. Thus, if the angle A is not 45 degrees, the light emitted from the second excitation light source group 110B and reflected by the light combining element 70 does not travel in a direction parallel to the X axis in FIG. 1.

The axis C2 is defined as follows. From a state in which the light ray 701b is perpendicularly incident on the light combining element 700b, the light combining element 700b is rotated about an axis (a rotational axis of the light combining element 700b) perpendicular to the light ray 701b. In this case, the axis C2 is a normal to a plane including the light ray 701b and the rotational axis of the light combining element 700b.

The axis C1 is perpendicular to the axis C2. The rotational axis is perpendicular to a plane including the axes C1 and C2.

The axis C2 illustrated in FIG. 7B corresponds to the X axis illustrated in FIG. 1. The rotational axis corresponds to the Y axis illustrated in FIG. 1.

In FIG. 7B, the light combining element 700b is rotated by 55 degrees about the rotational axis of the light combining element 700b. The angle formed by the reflection surface of the light combining element 700b and the light ray 701b is 35 degrees.

If the angle A is 45 degrees, the deflecting mirror 71 is similar to the light combining element 70. If the angle B is not 45 degrees, the light beams reflected by the deflecting mirror 71 do not travel in a direction parallel to the Z axis.

However, the deflecting mirror 71 does not change the angular relationship between the parallel light beams emitted from the first excitation light source unit 10a and the parallel light beams emitted from the second excitation light source unit 10b. This is because both of them are incident on the deflecting mirror 71 from the same direction (+X axis direction) and reflected by the deflecting mirror 71.

In the light combining element 70, the angular relationship between the parallel light beams emitted from the first excitation light source unit 10a and the parallel light beams emitted from the second excitation light source unit 10b can be changed by changing the angle A.

If the angle A is 45 degrees, the parallel light beams emitted from the first excitation light source unit 10a and the parallel light beams emitted from the second excitation light source unit 10b travel parallel to the X axis. The parallel light beams emitted from the first excitation light source unit 10a and the parallel light beams emitted from the second excitation light source unit 10b travel toward the biconvex lens 101.

On the other hand, if the angle A is not 45 degrees, the parallel light beams emitted from the first excitation light source unit 10a are parallel to the X axis. However, the parallel light beams emitted from the second excitation light source unit 10b have an angle relative to the X axis. That is, the parallel light beams emitted from the second excitation light source unit 10b are inclined to the X axis. That is, the parallel light beams emitted from the second excitation light source unit 10b are not parallel to the X axis.

In FIG. 7B, if the light combining element 70a or 70b illustrated in FIG. 5A or 5B is employed, the reflection surfaces of the reflection regions 74 are formed on the surface on which the light ray 701b of the light combining element 700b is incident. Thus, the reflection surfaces of the reflection regions 74 and the transmission surfaces of the transmission regions 75 are formed on the same surface.

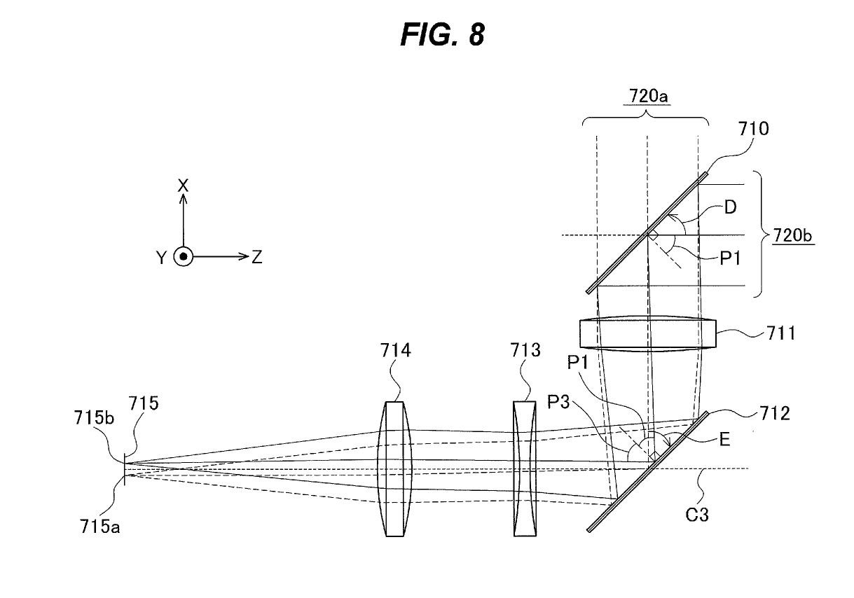

FIG. 8 is a diagram illustrating a result of simulation of light rays showing advantages of the first embodiment.

A first light ray group 720a is light emitted from the first excitation light source unit 10a. A second light ray group 720b is light emitted from the second excitation light source unit 10b. In FIG. 8, the first light ray group 720a is indicated by dashed lines. In FIG. 8, the second light ray group 720b is indicated by solid lines.

A light combining element 710 corresponds to the light combining element 70 illustrated in FIG. 1. A deflecting mirror 712 corresponds to the deflecting mirror 71 illustrated in FIG. 1. A biconvex lens 711 corresponds to the biconvex lens 101 illustrated in FIG. 1. A biconcave lens 713 corresponds to the biconcave lens 102 illustrated in FIG. 1. A condensing lens 714 corresponds to the condensing lens group 400 illustrated in FIG. 1. The light concentration surface 715 corresponds to the phosphor element 40G illustrated in FIG. 1.

The first light ray group 720a travels in the −X axis direction. The first light ray group 720a traveling in the −X axis direction passes through the light combining element 710. The light ray group 720a passing through the light combining element 710 travels in the −X axis direction.

The biconvex lens 711 is disposed on the −X axis direction side of the light combining element 710.

The first light ray group 720a passing through the light combining element 710 passes through the biconvex lens 711.

The first light ray group 720a passing through the biconvex lens 711 travels in the −X axis direction.

The deflecting mirror 712 is disposed on the −X axis direction side of the biconvex lens 711.

A central light ray of the first light ray group 720a passing through the biconvex lens 711 is incident on the deflecting mirror 712 at an angle E. Here, the angle E is an angle having a value obtained by subtracting an incident angle P1 from 90 degrees.

The central light ray of the first light ray group 720a passing through the biconvex lens 711 is parallel to the X axis. The angle E indicates an angle by which the deflecting mirror 712 is rotated clockwise relative to an X-Y plane as viewed from the +Y axis direction.

The first light ray group 720a reflected by the deflecting mirror 712 travels in the −Z axis direction.

The biconcave lens 713 is disposed on the −Z axis direction side of the deflecting mirror 712.

The first light ray group 720a reflected by the deflecting mirror 712 is incident on the biconcave lens 713. The first light ray group 720a incident on the biconcave lens 713 is converted into a parallel light beam by the biconcave lens 713.

The first light ray group 720a converted into the parallel light beam travels in the −Z axis direction.

The condensing lens 714 is disposed on the −Z axis direction side of the biconcave lens 713.

The first light ray group 720a converted into the parallel light beam is incident on the condensing lens 714. The first light ray group 720a converted into the parallel light beam is concentrated by the condensing lens 714 at a light concentration position 715a on the light concentration surface 715.

The light concentration surface 715 is located on the −Z axis direction side of the condensing lens 714.

The light concentration position 715a of the first light ray group 720a is on the −X axis direction side of an optical axis C3. The optical axis C3 is an optical axis of the biconcave lens 713 and condensing lens 714.

The second light ray group 720b travels in the −Z axis direction. The second light ray group 720b traveling in the −Z axis direction is incident on the light combining element 710 at an angle D. Here, the angle D is an angle having a value obtained by subtracting the incident angle P1 from 90 degrees. The angle D corresponds to the angle A illustrated in FIG. 1.

The angle D indicates an angle by which the light combining element 710 is rotated counterclockwise relative to a Y-Z plane as viewed from the +Y axis direction.

The second light ray group 720b traveling in the −Z axis direction is reflected by the light combining element 710. The second light ray group 720b reflected by the light combining element 710 travels in the −X axis direction.

The biconvex lens 711 is disposed on the −X axis direction side of the light combining element 710.

The second light ray group 720b reflected by the light combining element 710 travels toward the biconvex lens 711. The second light ray group 720b reflected by the light combining element 710 passes through the biconvex lens 711. The second light ray group 720b passing through the biconvex lens 711 travels in the −X axis direction.

The deflecting mirror 712 is disposed on the −X axis direction side of the biconvex lens 711.

A central light ray of the second light ray group 720b passing through the biconvex lens 711 is incident on the deflecting mirror 712 at an angle greater than the angle E. Specifically, the central light ray of the second light ray group 720b passing through the biconvex lens 711 is incident at an angle greater than the angle E by an angle twice as great as a value obtained by subtracting 45 degrees from the angle D.

The second light ray group 720b passing through the biconvex lens 711 travels in the −X axis direction on the +Z axis direction side relative to the first light ray group 720a passing through the biconvex lens 711.

Strictly speaking, since the central light ray of the second light ray group 720b passes through the biconvex lens 711 at an angle different from a right angle, the angle is slightly different from that described above.

The second light ray group 720b reflected by the deflecting mirror 712 travels in the −Z axis direction.

The biconcave lens 713 is disposed on the −Z axis direction side of the deflecting mirror 712.

The second light ray group 720b reflected by the deflecting mirror 712 is incident on the biconcave lens 713. The second light ray group 720b incident on the biconcave lens 713 is converted by the biconcave lens 713 into a parallel light beam.

The second light ray group 720b converted into the parallel light beam travels in the −Z axis direction.

The condensing lens 714 is disposed on the −Z axis direction side of the biconcave lens 713.

The second light ray group 720b converted into the parallel light beam is incident on the condensing lens 714. The second light ray group 720b converted into the parallel light beam is concentrated by the condensing lens 714 at a light concentration position 715b on the light concentration surface 715.

The light concentration surface 715 is located on the −Z axis direction side of the condensing lens 714.

The light concentration position 715b of the second light ray group 720b is on the +X axis direction side of the optical axis C3.

Here, the angle D is an angle greater than 45 degrees. The angle D is, for example, 45.8 degrees. The angle D illustrated in FIG. 8 corresponds to the angle A illustrated in FIG. 1.

Thus, after the second light ray group 720b is reflected by the light combining element 710, it travels in the −X axis direction while inclined in the +Z axis direction. That is, on the −X axis direction side of the light combining element, 710, the second light ray group 720b is displaced in the +Z axis direction relative to the first light ray group 720a.

The angle E is an angle less than 45 degrees. The angle E is, for example, 44.5 degrees. The angle E illustrated in

FIG. 8 corresponds to the angle B illustrated in FIG. 1.

Thus, after the first light ray group 720a is reflected by the deflecting mirror 712, it travels in the −Z axis direction while inclined to the optical axis C3 in the −X axis direction. After the second light ray group 720b is reflected by the deflecting mirror 712, it travels in the −Z axis direction on the +X axis direction side relative to the first light ray group 720a. For example, in FIG. 8, after the second light ray group 720b is reflected by the deflecting mirror 712, it travels in the −Z axis direction while inclined to the optical axis C3 in the +X axis direction.

This is because the incident angle P1 of the second light ray group 720b with respect to the deflecting mirror 712 is less than the incident angle P1 of the first light ray group 720a. Reflection angles P3 are equal to incident angles P1 from the light reflection law. Thus, the reflection angle P3 of the second light ray group 720b with respect to the deflecting mirror 712 is less than the reflection angle P3 of the first light ray group 720a.

As described above, by adjusting the angles D and E, it is possible to separate the light concentration position 715a of the first light ray group 720a and the light concentration position 715b of the second light ray group 720b in the X axis direction on the light concentration surface 715, as illustrated in FIG. 8. That is, it is possible to locate the light concentration position 715a of the first light ray group 720a and the light concentration position 715b of the second light ray group 720b at different positions on a surface of the light concentration position 715.

This makes it possible to reduce by half the energy density of the light beam concentrated on the light concentration surface 715 without using a complicated optical element as in Patent Reference 1.

In the example of FIG. 8, the angle D of the light combining element 710 is greater than the angle E of the deflecting mirror 712. However, it is sufficient that the light can be concentrated at different positions on the light concentration surface 715 with the optical axis C3 as the center, and the relationship between the angles E and D is not limited to the above-described example.

However, to separate the light concentration position 715a of the first light ray group 720a and the light concentration position 715b of the second light ray group 720b in the X axis direction so that they are spaced by the same distance from the optical axis C3, it is preferable that the difference between the angle D and 45 degrees be greater than the difference between the angle E and 45 degrees.

Adjustment mechanisms may be provided to the light combining element 70 and deflecting mirror 71 in FIG. 1. This makes it possible to correct the tolerances (mounting variations) when the light combining element 70 and deflecting mirror 71 are mounted.

In the manufacturing process of the projection display device 1, the angle A of the light combining element 70 and the angle B of the deflecting mirror 71 may be adjusted by using an adjustment tool or the like. This eliminates the need for the adjustment mechanisms, thereby allowing the projection display device 1 to be downsized and reduced in cost.

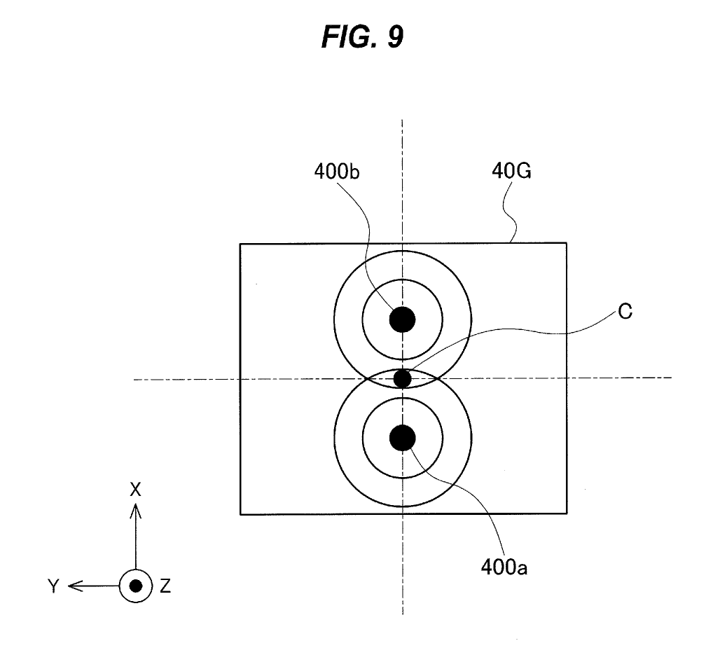

FIG. 9 is a diagram illustrating a schematic diagram of spot images of excitation light on the phosphor element 40G. FIG. 9 is a diagram of the phosphor element 40G as viewed from the +Z axis direction. FIG. 9 illustrates light intensity distributions with contour lines. The centers of the spot images are indicated by black circles. The contour lines represent distributions in which the light intensity increases toward the centers of the spot images. That is, the nearer the centers of the spot images, the higher the light intensity. A phosphor screen of the phosphor element 40G corresponds to the light concentration surface 715 illustrated in FIG. 8. The optical axis C corresponds to the optical axis C3 illustrated in FIG. 8.

The light emitted from the first excitation light source unit 10a is concentrated at a light concentration position 400a. The light concentration position 400a corresponds to the light concentration position 715a illustrated in FIG. 8. The light concentration position 400a is located on the −X axis direction side of the optical axis C.

The light emitted from the second excitation light source unit 10b is concentrated at a light concentration position 400b. The light concentration position 400b corresponds to the light concentration position 715b illustrated in FIG. 8. The light concentration position 400b is located on the +X axis direction side of the optical axis C.

Actually, the concentrated light has the light intensity distributions with their centers at the light concentration positions 400a and 400b, as illustrated in FIG. 9.

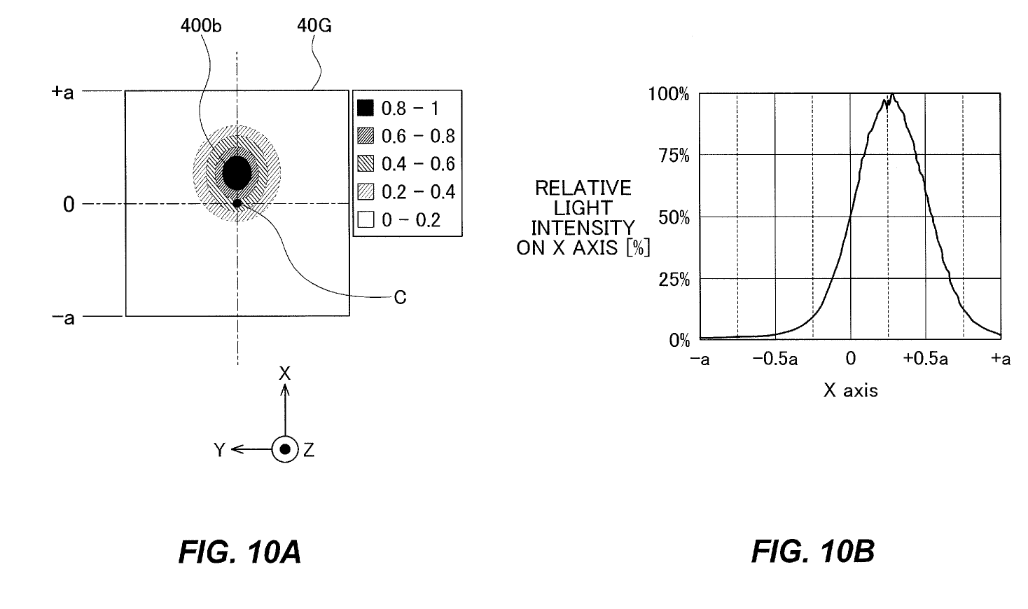

FIGS. 10 to 13 are diagrams illustrating an example of simulation results of a spot image of excitation light on the phosphor element 40G. For convenience, the simulations were made for a case in which a light diffusion element is disposed between the biconcave lens 102 and color separation filter 72 illustrated in FIG. 1.

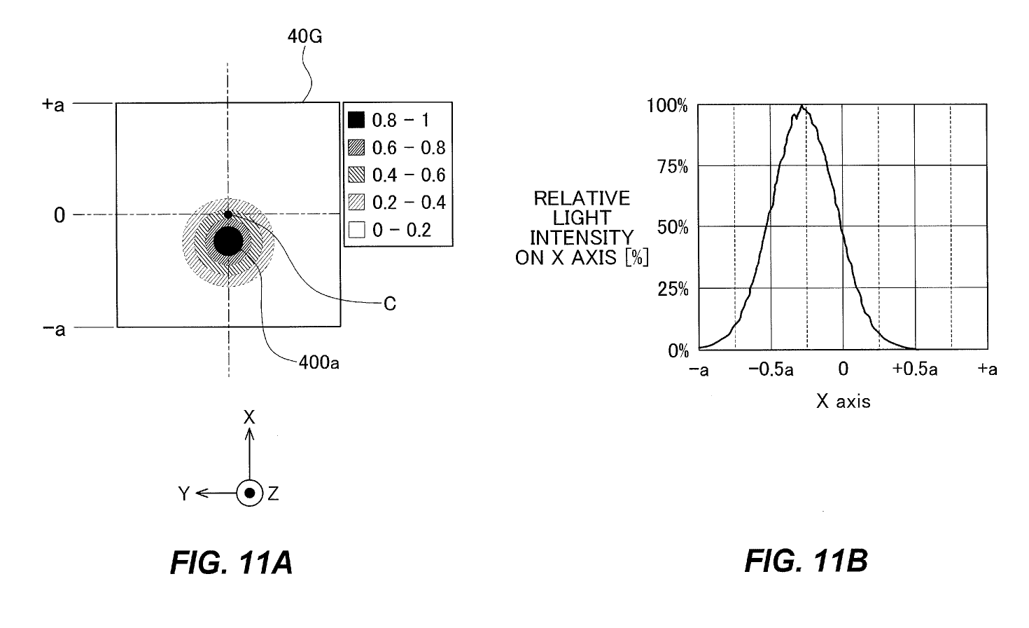

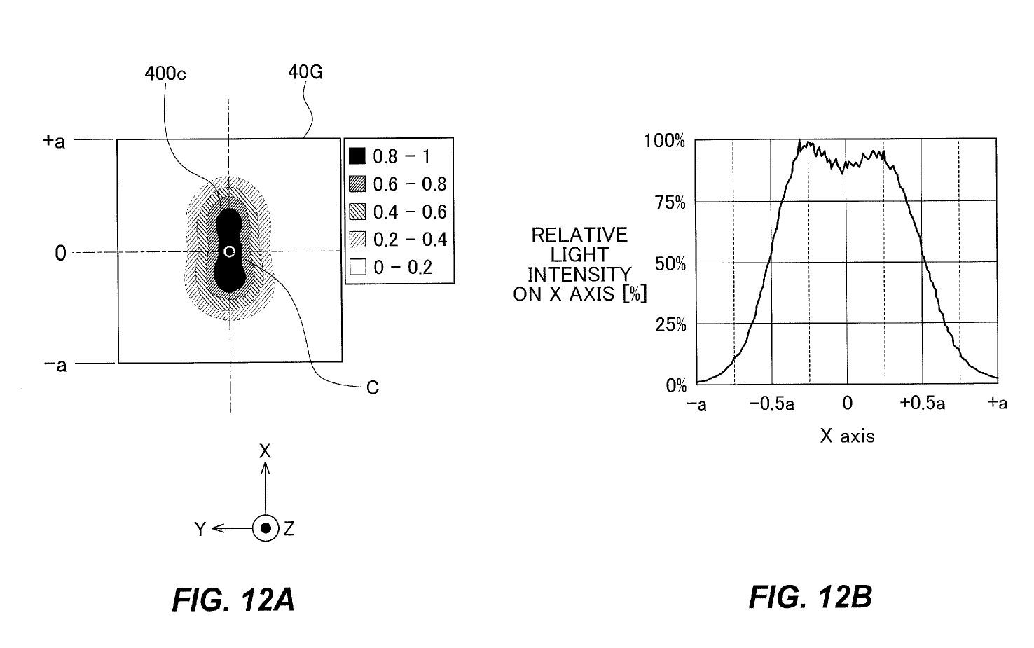

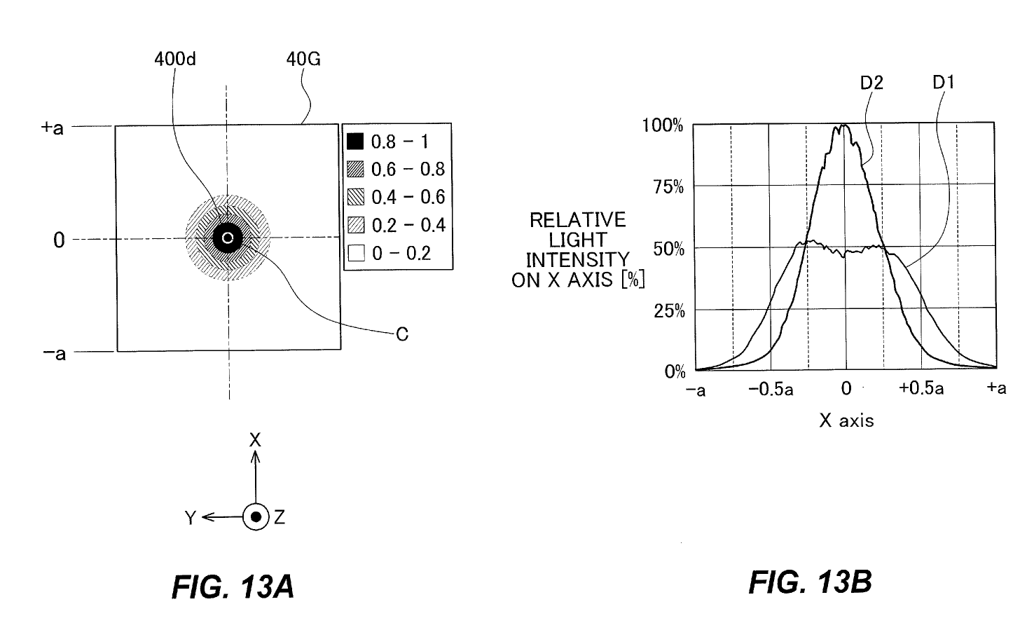

FIGS. 10A and 10B illustrate a light intensity distribution when light emitted from the second excitation light source group 110B is concentrated on the phosphor element 40G. FIGS. 11A and 11B illustrate a light intensity distribution when light emitted from the first excitation light source group 110A is concentrated on the phosphor element 40G. FIGS. 12A and 12B illustrate a light intensity distribution when light emitted from the first excitation light source group 110A and light emitted from the second excitation light source group 110B are concentrated on the phosphor element 40G. FIGS. 13A and 13B illustrate a light intensity distribution when light emitted from the first excitation light source group 110A and light emitted from the second excitation light source group 110B are concentrated on the phosphor element 40G in a case where the configuration of the first embodiment is not employed.

FIGS. 10A, 11A, 12A, and 13A illustrate light intensity distributions on the surface (X-Y plane) of the phosphor element 40G. In the light intensity distributions of FIGS. 10A, 11A, 12A, and 13A, a relative light intensity is divided into five levels. With the maximum light intensity as 1, the light intensity is divided into five levels: 0 to 0.2, 0.2 to 0.4, 0.4 to 0.6, 0.6 to 0.8, and 0.8 to 1. Regions of 0 to 0.2, 0.2 to 0.4, 0.4 to 0.6, 0.6 to 0.8, and 0.8 to 1 are depicted. The higher the light intensity of the region, the darker the region is represented. The closer the region is to the center of the spot image, the higher the light intensity of the region. A central region of the spot image is the region of 0.8 to 1. An outermost region of the spot image is the region of 0 to 0.2.

In FIGS. 10A, 11A, 12A, and 13A, the length in the X axis direction of the surface of the phosphor element 40G is 2a. Specifically, FIGS. 10A, 11A, 12A, and 13A represent the X axis in the range of −a to +a. In FIGS. 10A, 11A, 12A, and 13A, the horizontal axis is the Y axis, and the vertical axis is the X axis. In FIGS. 10A, 11A, 12A, and 13A, the left side is the +Y axis direction side, and the upper side is the +X axis direction side. In FIGS. 10A, 11A, 12A, and 13A, the optical axis C is represented by the origin (0, 0).

FIGS. 10B, 11B, 12B, and 13B illustrate relative light intensity distributions on a line passing through the optical axis C of the phosphor element 40G and parallel to the X axis. In FIGS. 10B, 11B, 12B, and 13B, the horizontal axis represents the X axis, and the vertical axis represents relative light intensity [%]. In FIGS. 10B, 11B, 12B, and 13B, for the horizontal axis, the right side is the +X axis direction side. In FIGS. 10B, 11B, 12B, and 13B, the value at the left end of the horizontal axis is −a, and the value at the right end of the horizontal axis is +a. In FIGS. 10B, 11B, 12B, and 13B, the vertical axis represents relative light intensity obtained by normalizing the light intensity distribution on the X axis by the maximum value of the light intensity. In FIGS. 10B, 11B, 12B, and 13B, the vertical axis is represented by percentage; the minimum value of the relative light intensity is 0% and the maximum value of the relative light intensity is 100%.

FIG. 10A illustrates the light intensity distribution of light emitted from the second excitation light source group 110B. At the brightest point in the light intensity distribution of FIG. 10A, the value of X is positive. That is, at the brightest point in the light intensity distribution of FIG. 10A, the value of X is within the range of 0 to +a. FIG. 10B shows that the light intensity is maximum near +0.25a.

FIG. 11A illustrates the light intensity distribution of light emitted from the first excitation light source group 110A. At the brightest point in the light intensity distribution of FIG. 11A, the value of X is negative. That is, at the brightest point in the light intensity distribution of FIG. 11A, the value of X is within the range of −a to 0. FIG. 11B shows that the light intensity is maximum near −0.25a.

The above shows that the light emitted from the first excitation light source group 110A and the light emitted from the second excitation light source group 110B are concentrated at positions axially symmetric with respect to an axis passing through the optical axis C and parallel to the Y axis.

The light intensity distribution illustrated in FIG. 10A has an elliptical shape elongated in the X axis direction. On the other hand, the light intensity distribution illustrated in FIG. 11A has an elliptical shape elongated in the Y axis direction. The difference in the long side directions of the elliptical shapes is due to the polarization directions of the excitation light sources.

In the first embodiment, for example, light emitted by the first excitation light source group 110A is P-polarized light. Here, the polarization direction of the P-polarized light emitted from the first excitation light source group 110A is a direction parallel to the Z axis. After passing through the collimator lens group 115A, light emitted by the first excitation light source group 110A has an illuminance distribution elongated in the Y axis direction.

On the other hand, light emitted by the second excitation light source group 110B is S-polarized light. Here, the polarization direction of the S-polarized light emitted from the second excitation light source group 110B is a direction parallel to the Y axis. After passing through the collimator lens group 115B, light emitted by the second excitation light source group 110B has an illuminance distribution elongated in the X axis direction.

The first embodiment combines light emitted by the first excitation light source group 110A and light emitted by the second excitation light source group 110B by using polarization. However, for example, if they are combined by using a stripe mirror or the like, since it does not depend on polarization, the long side directions of the elliptical illuminance distributions can be changed.

FIG. 12A illustrates the light intensity distribution of light emitted from the first excitation light source group 110A and light emitted from the second excitation light source group 110B. The light intensity distribution of FIG. 12A has two brightest points.

One of the brightest points in the light intensity distribution of FIG. 12A is on the +X axis direction side, and the other one is on the −X axis direction side. The center of the light intensity distribution of the light emitted from the first excitation light source group 110A is the brightest point on the −X axis direction side in the light intensity distribution. The center of the light intensity distribution of the light emitted from the second excitation light source group 110B is the brightest point on the +X axis direction side in the light intensity distribution.

The brightest point on the +X axis direction side in the light intensity distribution and the brightest point on the −X axis direction side in the light intensity distribution are located symmetrically with respect to the optical axis C. That is, as described above, the brightest points in the two light intensity distributions are located axially symmetrically with respect to an axis passing through the optical axis C and parallel to the Y axis.

FIG. 12B shows that although the light intensity has the two separate peak positions, a region centered at the optical axis C is uniform in light intensity. In FIG. 12B, the region centered at the optical axis C is the region from X=−0.25a to X=+0.25a. That is, in FIG. 12B, the region from X=−0.25a to X=+0.25a is uniform in light intensity.

FIG. 13A illustrates the light intensity distribution when light emitted from the first excitation light source group 110A and light emitted from the second excitation light source group 110B are concentrated at one point. That is, it illustrates a case in which the angles A and B are 45 degrees. The brightest point in the light intensity distribution of FIG. 13A is located on the optical axis C.

FIG. 13B illustrates two light intensity distributions by curves D1 and D2. The curve D1 represents the value of the light intensity on the X axis of the light intensity distribution illustrated in FIG. 12A. That is, the curve D1 represents the light intensity illustrated in FIG. 12B. The curve D2 represents the value of the light intensity on the X axis of the light intensity distribution illustrated in FIG. 13A.

The vertical axis of FIG. 13B represents relative light intensity obtained by normalization by the maximum value of the light intensity in the intensity distribution on the X axis of the curve D2.

The curve D2 shows a steep light intensity curve with its center at the optical axis C (X=0). The curve D2 is triangular in shape. On the other hand, the maximum value of the relative light intensity of the curve D1 is 50 percent of the maximum value of the relative intensity of the curve D2. The maximum value of the light intensity of the curve D1 is half of the maximum value of the light intensity of the curve D2. That is, a local light intensity of the curve D1 is half of a local light intensity of the curve D2. The curve D2 is trapezoidal in shape.

Thus, the light having the relative light intensity characteristic of the curve D1 can reduce local light saturation of the phosphor element 40G. The light having the relative light intensity characteristic of the curve D1 also improves the conversion efficiency of the phosphor element 40G. The light having the relative light intensity characteristic of the curve D1 can also prolong the lifetime of the phosphor element 40G.

Further, such reduction in local light saturation of the phosphor element 40G can be achieved with a simple configuration in which the light combining element 70 and deflecting mirror 71 are rotated and arranged. Such a simple configuration improves assemblability and can reduce the cost.

### <Red Light Source Unit 30R and Red Light Beam>

The light source device 2 includes the red light source unit 30R. The red light source unit 30R includes the red light source group 310R that emits light in a red wavelength range. The red light source unit 30R also includes the collimator lens group 315R.

The red light source group 310R includes multiple red light sources 311, 312, 313, 321, 322, 323, 331, 332, and 333. The red wavelength range has a center wavelength of 640 nm, for example.

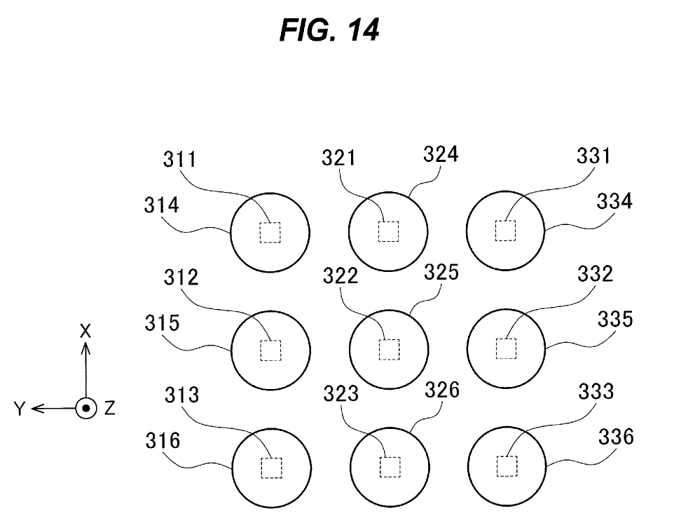

FIG. 14 is an example of a configuration diagram illustrating an arrangement configuration of the red light source unit 30R. As illustrated in FIG. 14, the red light source unit 30R includes the red light source group 310R and collimator lens group 315R.

The red light source group 310R includes the red light sources 311, 312, 313, 321, 322, 323, 331, 332, and 333.

The red light sources 311, 312, 313, 321, 322, 323, 331, 332, and 333 are arranged on an X-Y plane. In FIG. 14, for example, the red light sources 311, 312, 313, 321, 322, 323, 331, 332, and 333 are arranged in a matrix on the X-Y plane.

The collimator lens group 315R includes collimator lenses 314, 315, 316, 324, 325, 326, 334, 335, and 336.

The collimator lenses 314, 315, 316, 324, 325, 326, 334, 335, and 336 are arranged on an X-Y plane. In FIG. 14, for example, the collimator lenses 314, 315, 316, 324, 325, 326, 334, 335, and 336 are arranged in a matrix on the X-Y plane.

The collimator lenses 314, 315, 316, 324, 325, 326, 334, 335, and 336 are disposed on the +Z axis direction side of the red light sources 311, 312, 313, 321, 322, 323, 331, 332, and 333. For example, the collimator lens 314 is disposed on the +Z axis direction side of the red light source 311. Thus, in FIG. 14, the red light source 311 is indicated by a dashed line.

The collimator lenses 314, 315, 316, 324, 325, 326, 334, 335, and 336 are disposed at positions corresponding to the red light sources 311, 312, 313, 321, 322, 323, 331, 332, and 333. “Corresponding positions” refers to positions at which light emitted from the red light sources 311, 312, 313, 321, 322, 323, 331, 332, and 333 passes through the collimator lenses 314, 315, 316, 324, 325, 326, 334, 335, and 336.

The collimator lenses 314, 315, 316, 324, 325, 326, 334, 335, and 336 collimate light beams emitted from the red light sources 311, 312, 313, 321, 322, 323, 331, 332, and 333. For example, the collimator lens 314 collimates the light beam emitted from the red light source 311.

The collimator lenses 314, 315, 316, 324, 325, 326, 334, 335, and 336 emit the collimated light beams in a direction toward the lens group 300. Here, the direction toward the lens group 300 is the +Z axis direction.

In the first embodiment, the red light sources 311, 312, 313, 321, 322, 323, 331, 332, and 333 are laser light sources.

Red light emitted from the red light source group 310R travels in the +Z axis direction.

As illustrated in FIG. 1, the collimator lens group 315R is disposed on the +Z axis direction side of the red light source group 310R.

The collimator lens group 315R includes the multiple collimator lenses 314, 315, 316, 324, 325, 326, 334, 335, and 336.

The red light emitted from the red light source group 310R is converted by the collimator lens group 315R into parallel light beams. For example, the red light emitted from the red light source 311 is converted by the collimator lens 314 into a parallel light beam.

The parallel light beams converted by the collimator lens group 315R travel in the +Z axis direction. For example, the parallel light beam converted by the collimator lens 314 travels in the +Z axis direction.

The lens group 300 is disposed on the +Z axis direction side of the collimator lens group 315R.

The lens group 300 includes, for example, the convex lens 301 and concave lens 302.

The lens group 300 has the same characteristics as the above-described biconvex lens 101 and biconcave lens 102. That is, a bundle (total light beam) of the parallel light beams emitted from the collimator lens group 315R is converted by the lens group 300 into parallel light beams (total light beam) with a reduced diameter.

The red light beams emitted from the convex lens 301 and concave lens 302 travel in the +Z axis direction.

The color separation filter 73 is disposed on the +Z axis direction side of the lens group 300.

The red light beams emitted from the lens group 300 reach the color separation filter 73. The red light beams emitted from the lens group 300 then pass through the color separation filter 73.

The red light beams passing through the color separation filter 73 travel in the +Z axis direction.

The condensing optical system 80 is disposed on the +Z axis direction side of the color separation filter 73.

The red light beams passing through the color separation filter 73 reach the condensing optical system 80. The red light beams passing through the color separation filter 73 then pass through the condensing optical system 80.

The red light beams passing through the color separation filter 73 are concentrated by the condensing optical system 80 on the incident end surface 113i of the light intensity equalizing element 113.

Even when the lens group 300 is eliminated, if the condensing optical system 80 has a size such that it can receive the total light beam emitted from the collimator lens group 315R, the light beams emitted from the collimator lens group 315R are concentrated on the incident end surface 113i of the light intensity equalizing element 113. That is, the condensing optical system 80 receives the multiple light beams (total light beam) emitted from the collimator lens group 315R and guides them (it) to the light intensity equalizing element 113. For example, the condensing optical system 80 receives the light beam emitted from the collimator lens 314 and guides it to the light intensity equalizing element 113.

The red light beams enter the light intensity equalizing element 113 through the incident end surface 113i. The light intensity distribution of the red light beams entering the light intensity equalizing element 113 is equalized. The equalized red light beam is then emitted from the emitting end surface 113o.

The red light beam emitted from the emitting end surface 113o is incident on the light valve 121 through the relay lens group 115, deflecting mirror 120, and condensing lens 122, similarly to the green light beam.

The light intensity equalizing element 113 receives the multiple concentrated light beams through the incident end surface 113i and converts them into a light beam having a uniform light intensity distribution to emit the light beam.

The light valve 121 receives the uniform light beam and converts it into modulated light to emit the modulated light. The light valve 121 converts the incident uniform light beam into modulated light and emits it.

### <Blue Light Source Unit 20B and Blue Light Beam>

The light source device 2 includes the blue light source unit 20B. The blue light source unit 20B includes the blue light source group 210B that emits light in a blue wavelength range. The blue light source unit 20B also includes the collimator lens group 215B.

The blue light source group 210B includes multiple blue light sources 211, 212, 213, 221, 222, 223, 231, 232, and 233. The blue wavelength range has a center wavelength of 460 nm, for example.

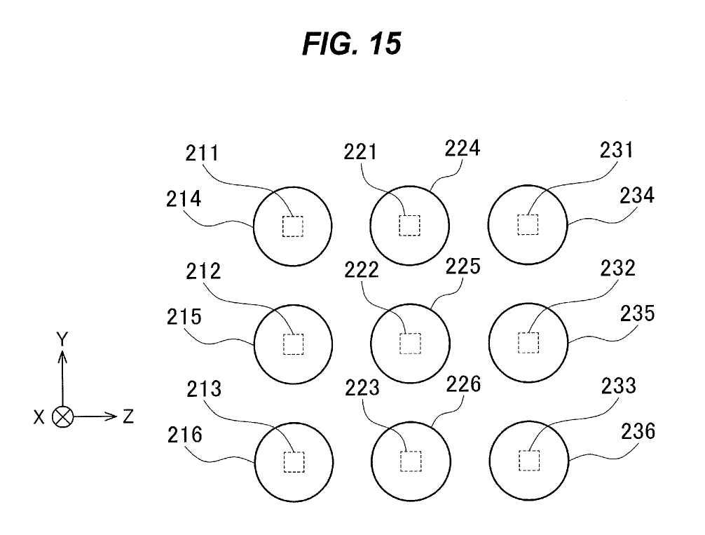

FIG. 15 is an example of a configuration diagram illustrating an arrangement configuration of the blue light source unit 20B. As illustrated in FIG. 15, the blue light source unit 20B includes the blue light source group 210B and collimator lens group 215B.

The blue light source group 210B includes the blue light sources 211, 212, 213, 221, 222, 223, 231, 232, and 233.

The blue light sources 211, 212, 213, 221, 222, 223, 231, 232, and 233 are arranged on a Y-Z plane. In FIG. 15, for example, the blue light sources 211, 212, 213, 221, 222, 223, 231, 232, and 233 are arranged in a matrix on the Y-Z plane.

The collimator lens group 215B includes collimator lenses 214, 215, 216, 224, 225, 226, 234, 235, and 236.

The collimator lenses 214, 215, 216, 224, 225, 226, 234, 235, and 236 are arranged on a Y-Z plane. In FIG. 15, for example, the collimator lenses 214, 215, 216, 224, 225, 226, 234, 235, and 236 are arranged in a matrix on the Y-Z plane.

The collimator lenses 214, 215, 216, 224, 225, 226, 234, 235, and 236 are disposed on the −X axis direction side of the blue light sources 211, 212, 213, 221, 222, 223, 231, 232, and 233. For example, the collimator lens 214 is disposed on the −X axis direction side of the blue light source 211. Thus, in FIG. 15, the blue light source 211 is indicated by a dashed line.

The collimator lenses 214, 215, 216, 224, 225, 226, 234, 235, and 236 are disposed at positions corresponding to the blue light sources 211, 212, 213, 221, 222, 223, 231, 232, and 233. “Corresponding positions” refers to positions at which light emitted from the blue light sources 211, 212, 213, 221, 222, 223, 231, 232, and 233 passes through the collimator lenses 214, 215, 216, 224, 225, 226, 234, 235, and 236.

The collimator lenses 214, 215, 216, 224, 225, 226, 234, 235, and 236 collimate light beams emitted from the blue light sources 211, 212, 213, 221, 222, 223, 231, 232, and 233. For example, the collimator lens 214 collimates the light beam emitted from the blue light source 211.

The collimator lenses 214, 215, 216, 224, 225, 226, 234, 235, and 236 emit the collimated light beams in a direction toward the lens group 200. Here, the direction toward the lens group 200 is the −X axis direction.

In the first embodiment, the blue light sources 211, 212, 213, 221, 222, 223, 231, 232, and 233 are laser light sources.

The blue light emitted from the blue light source group 210B travels in the −X axis direction.

As illustrated in FIG. 1, the collimator lens group 215B is disposed on the −X axis direction side of the blue light source group 210B.

The collimator lens group 215B includes the multiple collimator lenses 214, 215, 216, 224, 225, 226, 234, 235, and 236.

The blue light emitted from the blue light source group 210B is converted by the collimator lens group 215B into parallel light beams. For example, the blue light emitted from the blue light source 211 is converted by the collimator lens 214 into a parallel light beam.

The parallel light beams converted by the collimator lens group 215B travel in the −X axis direction. For example, the parallel light beam converted by the collimator lens 214 travels in the −X axis direction.

The lens group 200 is disposed on the −X axis direction side of the collimator lens group 215B.

The lens group 200 includes, for example, the convex lens 201 and concave lens 202.

The lens group 200 has the same characteristics as the above-described biconvex lens 101 and biconcave lens 102. That is, a bundle (total light beam) of the parallel light beams emitted from the collimator lens group 215B is converted by the lens group 200 into parallel light beams (total light beam) with a reduced diameter.

The blue light beams emitted from the convex lens 201 and concave lens 202 travel in the −X axis direction.

The color separation filter 72 is disposed on the −X axis direction side of the lens group 200.

The blue light beams emitted from the lens group 200 reach the color separation filter 72. The blue light beams emitted from the lens group 200 then pass through the color separation filter 72.

The blue light beams passing through the color separation filter 72 travel in the −X axis direction.

The color separation filter 73 is disposed on the −X axis direction side of the color separation filter 72.

The blue light beams passing through the color separation filter 72 reach the color separation filter 73. The blue light beams passing through the color separation filter 72 are then reflected by the color separation filter 73.

The blue light beams reflected by the color separation filter 73 travel in the +Z axis direction. The blue light beams passing through the color separation filter 72 are reflected by the color separation filter 73 in the +Z axis direction.

The condensing optical system 80 is disposed on the +Z axis direction side of the color separation filter 73.

The blue light beams reflected by the color separation filter 73 reach the condensing optical system 80. The blue light beams reflected by the color separation filter 73 then pass through the condensing optical system 80.

The blue light beams reflected by the color separation filter 73 are concentrated by the condensing optical system 80 on the incident end surface 113i of the light intensity equalizing element 113.

Even when the lens group 200 is eliminated, if the condensing optical system 80 has a size such that it can receive the total light beam emitted from the collimator lens group 215B, the light beams emitted from the collimator lens group 215B are concentrated on the incident end surface 113i of the light intensity equalizing element 113. That is, the condensing optical system 80 receives the multiple light beams (total light beam) emitted from the collimator lens group 215B and guides them (it) to the light intensity equalizing element 113. For example, the condensing optical system 80 receives the light beam emitted from the collimator lens 214 and guides it to the light intensity equalizing element 113.

The blue light beams enter the light intensity equalizing element 113 through the incident end surface 113i. The light intensity distribution of the blue light beams entering the light intensity equalizing element 113 is equalized. The equalized blue light beam is then emitted from the emitting end surface 113o.

The blue light beam emitted from the emitting end surface 113o is incident on the light valve 121 through the relay lens group 115, deflecting mirror 120, and condensing lens 122, similarly to the green and red light beams.

The light intensity equalizing element 113 receives the multiple concentrated light beams through the incident end surface 113i and converts them into a light beam having a uniform light intensity distribution to emit the light beam.

The light valve 121 receives the uniform light beam and converts it into modulated light to emit the modulated light. The light valve 121 converts the incident uniform light beam into modulated light and emits it.

The center wavelength of light emitted by the blue light source group 210B is at least 10 nm longer than the center wavelength of light emitted by the first excitation light source group 110A and the center wavelength of light emitted by the second excitation light source group 110B.

This makes it possible to improve the hue of the blue color as compared to a case where the first excitation light source group 110A and second excitation light source group 110B are used as a blue light source. The use of a blue light source having a center wavelength of 460 nm or greater improves the hue of the blue color. Light having a wavelength of 450 nm is strongly purplish blue. Light having a wavelength of 460 nm is closer to blue than light having a wavelength of 450 nm.

### <Positional Relationship of Condensing Lens 122, Light Valve 121, and Projection Optical System 124>

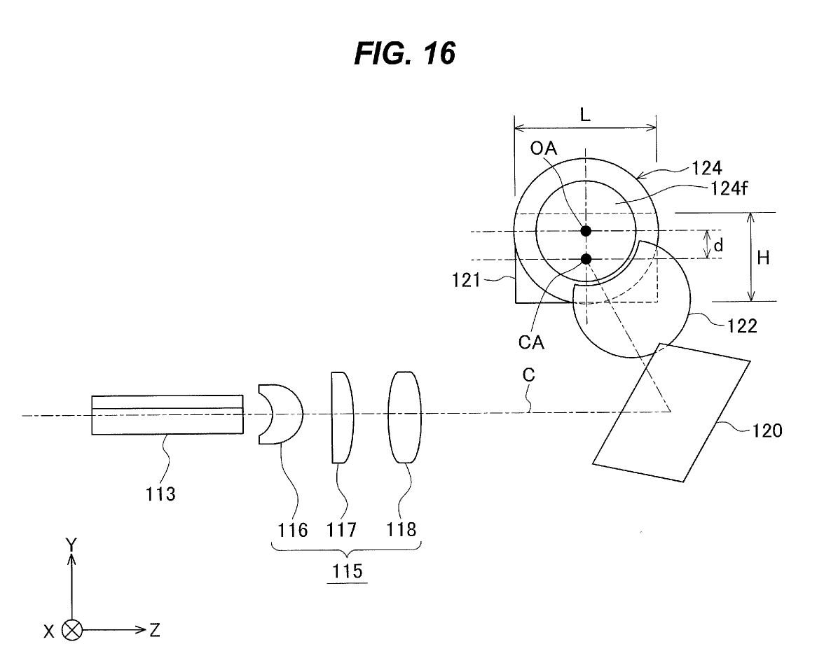

FIG. 16 is a schematic diagram generally illustrating a part of the configuration of the projection display device 1 as viewed from the front side. “Viewed from the front side” refers to being viewed from the −X axis direction side in the +X axis direction.

For convenience of explanation, FIG. 16 depicts optical elements after the light intensity equalizing element 113. “After” refers to a direction in which light travels. That is, FIG. 16 depicts elements through which light emitted from the light intensity equalizing element 113 passes or elements by which light emitted from the light intensity equalizing element 113 is reflected.

A light beam reflected by the deflecting mirror 120 passes through the condensing lens 122. The light beam passing through the condensing lens 122 is incident on the light valve 121.

As described above, the light valve 121 spatially modulates the incident light in accordance with the modulation control signal MC. The light valve 121 converts the incident light into modulated light and emits it.

The projection optical system 124 receives the modulated light emitted from the light modulating surface (light emitting surface) of the light valve 121. The projection optical system 124 magnifies and projects the incident modulated light onto the projection surface 150.

The modulated light is projected on the projection surface 150. Then, an optical image is displayed on the projection surface 150. The projection surface 150 is, for example, an external screen or the like.

As illustrated in FIG. 16, the optical axis OA of the projection optical system 124 is displaced from a center axis CA of the light emitting surface (light modulating surface) of the light valve 121 in the +Y axis direction by a distance d. The distance d is the distance from the optical axis OA of the projection optical system 124 to the center axis CA of the light emitting surface (light modulating surface) of the light valve 121 in the normal direction (Y axis direction) to a Z−X plane. “+Y axis direction” refers to the height direction of the projection display device 1.

The optical axis OA and center axis CA are axes perpendicular to a Y-Z plane. Thus, FIG. 16 indicates the optical axis OA and center axis CA by black dots.

The light valve 121 is located on the +X axis direction side of the projection optical system 124, so a part of the light valve 121 is indicated by a dashed line.

The condensing lens 122 has a shape having a partial cutout so as not to interference with the projection optical system 124. Here, “interference” refers to contact between parts. In FIG. 16, the condensing lens 122 has the cutout at its upper left side so as to avoid the projection optical system 124, which has a cylindrical shape.

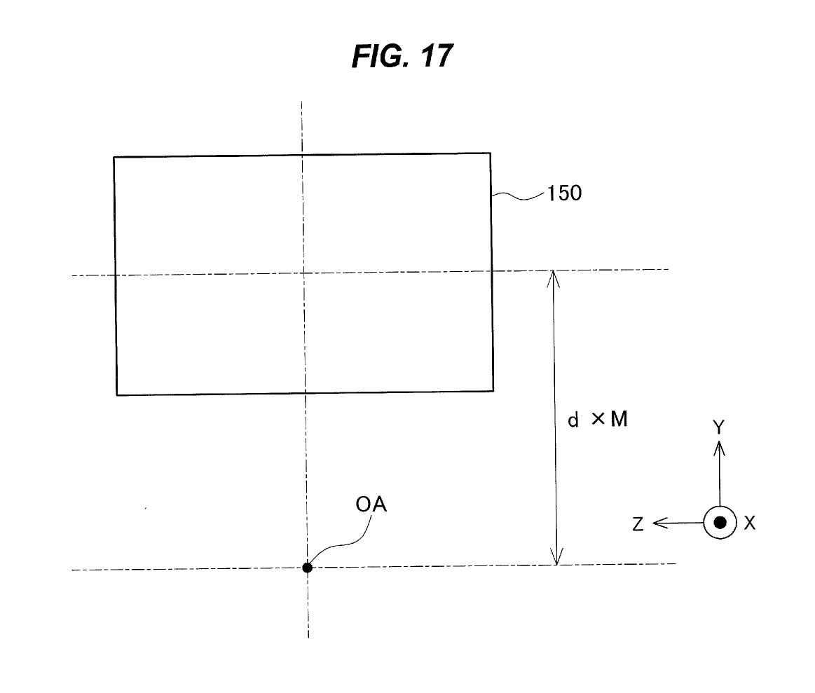

FIG. 17 is a schematic diagram for explaining the relationship between the projection optical system 124 and the projection surface 150.

As illustrated in FIG. 17, a center position of the projection surface 150 is displaced from the optical axis OA of the projection optical system 124 in the +Y axis direction by a distance of d×M. As described above, d denotes the distance from the center axis CA of the light valve 121 to the optical axis OA of the projection optical system 124 in the Y axis direction. M denotes the magnification ratio of the projection optical system 124.

In the case of the relay optical system from the relay lens group 115 to the light valve 121 illustrated in the first embodiment, the center axis CA of the light valve 121 and the optical axis OA of the projection lens do not coincide with each other. The optical axis OA is an axis perpendicular to a Y-Z plane. Thus, FIG. 17 indicates the optical axis OA by a black dot. The “projection surface 150” illustrated in FIG. 17 indicates a position where an image is projected on the projection surface 150 such as a screen.

As described above, the projection light Ro emitted from the projection display device 1 reaches the projection surface 150.

If the center of the projection surface 150 is on the +Y axis direction side of the optical axis OA of the projection optical system 124 of the projection display device 1, the optical axis OA of the projection optical system 124 is displaced from the center axis CA of the light valve 121 in the +Y axis direction as illustrated in FIG. 16. This makes it possible to shift the projection surface 150 in the +Y axis direction as illustrated in FIG. 17.

On the other hand, if the center of the projection surface 150 is on the −Y axis direction side of the optical axis OA of the projection optical system 124 of the projection display device 1, the projection display device 1 should be rotated about the X axis by 180 degrees. This makes it possible to shift the center of the projection surface 150 in the −Y axis direction in FIG. 17. However, if the projection optical system 124 is not at the center of the projection display device 1 in the Z axis direction, it is required to shift the projection display device 1 in the Z axis direction.

### <Relationship Between Phosphor Element 40G and Light Intensity Equalizing Element 113>

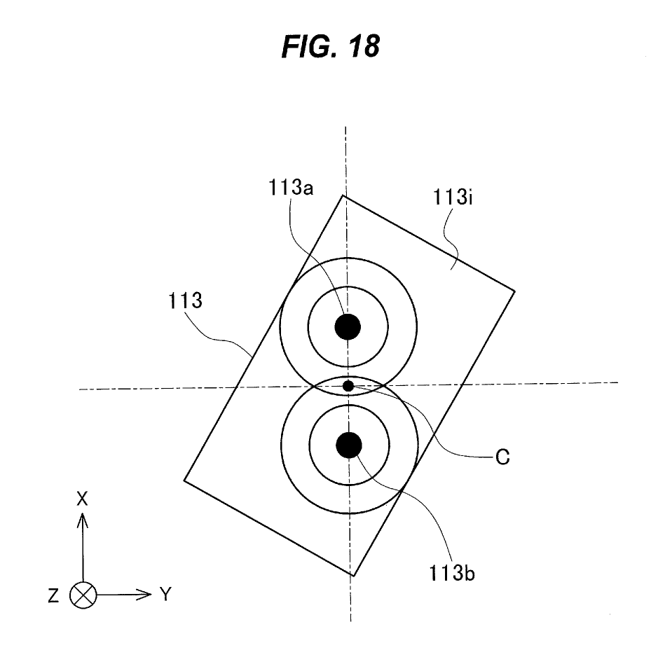

FIG. 18 illustrates a schematic diagram of light intensity distributions of light beams concentrated on the light intensity equalizing element 113. FIG. 18 is a schematic diagram illustrating the light intensity distributions on the incident end surface 113i of the light intensity equalizing element 113. The light intensity distributions illustrated in FIG. 18 are schematically represented by contour lines. Centers of spot images are indicated by black circles. The contour lines indicate higher light intensity as they are closer to the centers of the spot images. That is, the nearer the centers of the spot images, the higher the light intensity. FIG. 18 is a diagram of the incident end surface 113i of the light intensity equalizing element 113 as viewed from the −Z axis direction.

In the first embodiment, as illustrated in FIG. 18, the light intensity equalizing element 113 is inclined to the X and Y axes. For example, the light intensity equalizing element 113 is rotated about the optical axis C. In FIG. 18, short sides of the incident end surface 113i are rotated clockwise from the positions where they are parallel to the Y axis.

As illustrated in FIG. 9, the light beams emitted from the first excitation light source group 110A are concentrated on the −X axis direction side of the optical axis C on the phosphor element 40G. The light beams emitted from the first excitation light source group 110A are concentrated at the light concentration position 400a. Thus, the position at which the light intensity of the light beams emitted from the first excitation light source group 110A is maximum is located on the −X axis direction side of the optical axis C.

The light beams emitted from the second excitation light source group 110B are concentrated on the +X axis direction side of the optical axis C on the phosphor element 40G. The light beams emitted from the second excitation light source group 110B are concentrated at the light concentration position 400b. Thus, the position at which the light intensity of the light beams emitted from the second excitation light source group 110B is maximum is located on the +X axis direction side of the optical axis C.

Thus, a light beam having a light intensity distribution with its center at the light concentration position 400a is emitted from the phosphor element 40G. The light beam having the light intensity distribution with its center at the light concentration position 400a is collimated by the condensing lens group 400. The collimated light beam is concentrated by the condensing optical system 80 on the incident end surface 113i of the light intensity equalizing element 113. The light concentration position of the collimated light beam on the incident end surface 113i is on the +X axis direction side of the optical axis C. The light beam having the light intensity distribution with its center at the light concentration position 400a is concentrated at a light concentration position 113a on the incident end surface 113i. The light concentration position 113a is on the +X axis direction side of the optical axis C.

On the other hand, a light beam having a light intensity distribution with its center at the light concentration position 400b is emitted from the phosphor element 40G. The light beam having the light intensity distribution with its center at the light concentration position 400b is collimated by the condensing lens group 400. The collimated light beam is concentrated by the condensing optical system 80 on the incident end surface 113i of the light intensity equalizing element 113. The light concentration position of the collimated light beam on the incident end surface 113i is on the −X axis direction side of the optical axis C. The light beam having the light intensity distribution with its center at the light concentration position 400b is concentrated at a light concentration position 113b on the incident end surface 113i. The light concentration position 113b is on the −X axis direction side of the optical axis C.

The light valve 121 is used in such a manner that a light beam is incident on the light valve 121 from obliquely below. Thus, the light intensity equalizing element 113 is rotated about the optical axis C so that the long side direction of the emitting end surface 113o of the light intensity equalizing element 113 optically coincides with the long side direction of the light valve 121. The rotation of the light beam about the optical axis C is compensated by the deflecting mirror 120. The optical axis C is perpendicular to an X-Y plane. Thus, FIG. 18 indicates the optical axis C by a black dot.

As illustrated in FIG. 9, a case where the angular relationship between the light combining element 710 and the deflecting mirror 712 as illustrated in FIG. 8 is followed will be described. That is, the angle A illustrated in FIG. 1 is set to be greater than 45 degrees and the angle B is set to be less than 45 degrees.

In this case, the light emitted from the first excitation light source group 110A is concentrated on the −X axis direction side of the optical axis C on the phosphor element 40G. The light emitted from the second excitation light source group 110B is concentrated on the +X axis direction side of the optical axis C on the phosphor element 40G. The light combining element 710 in FIG. 8 corresponds to the light combining element 70 in FIG. 1. The deflecting mirror 712 in FIG. 8 corresponds to the deflecting mirror 71 in FIG. 1.

A case where the angle A illustrated in FIG. 1 is set to be less than 45 degrees and the angle B is set to be greater than 45 degrees will also be described.

In this case, the light emitted from the first excitation light source group 110A is concentrated on the +X axis direction side of the optical axis C on the phosphor element 40G. The light emitted from the second excitation light source group 110B is concentrated on the −X axis direction side of the optical axis C on the phosphor element 40G. The angle A illustrated in FIG. 1 corresponds to the angle D illustrated in FIG. 8. The angle B illustrated in FIG. 1 corresponds to the angle E illustrated in FIG. 8.

In the first embodiment, for convenience, a central light intensity range is narrow. However, by arranging a light diffusion element between the color separation filter 72 and the biconcave lens 102 or other ways, it is possible to broaden the central light intensity range to smooth the intensity distribution.

In the simulations whose results are illustrated in FIGS. 10 to 13, the light diffusion element is disposed between the color separation filter 72 and the biconcave lens 102.

If no light diffusion element is disposed, the diameter of the light beam is small, and the effect of smoothing the intensity distribution is hard to obtain. However, even if no light diffusion element is used, the first embodiment can divide the light intensity into two parts and therefore provide an advantage of improving the conversion efficiency of the phosphor and prolonging the lifetime of the phosphor.

The phosphor element 40G and the incident end surface 113i of the light intensity equalizing element 113 are in conjugate relation with each other. Thus, the light intensity distribution on the phosphor element 40G becomes the light intensity distribution on the incident end surface 113i of the light intensity equalizing element 113. That is, the shape of the light intensity distribution on the phosphor element 40G illustrated in FIG. 9 is similar to the shape of the light intensity distribution on the incident end surface 113i illustrated in FIG. 18.

Here, for the phosphor element 40G, when the light beam emitted from the first excitation light source group 110A is concentrated on the phosphor surface, it is converted into a green light beam that is a perfectly diffused light beam and is emitted toward the condensing lens group 400.

Similarly, for the phosphor element 40G, when the light beam emitted from the second excitation light source group 110B is concentrated on the phosphor surface, it is converted into a green light beam that is a perfectly diffused light beam and is emitted toward the condensing lens group 400.

An emission angle S1 and an emission area SA of a light source have a relationship of the following formula (1). The light source here is the phosphor of the phosphor element 40G. Thus, an emission angle of converted green light corresponds to the emission angle S1. A diameter of a spot of excitation light on the phosphor element 40G corresponds to the emission area SA.

SA×(sin (S1))²=constant (1)

Suppose that a divergence angle (emission angle S1) of the light beam emitted from the phosphor element 40G is 80 degrees and an effective incident angle of the light intensity equalizing element 113 is 30 degrees. In this case, the area of the light beam incident on the incident end surface 113i of the light intensity equalizing element 113 is about four times the area of the spot of excitation light on the phosphor element 40G. Thus, the optimum position and size (spot diameter) of the light beam concentrated on the phosphor element 40G can be determined from the area of the light beam incident on the incident end surface 113i of the light intensity equalizing element 113.

For example, the divergence angle (80 degrees) of the light beam emitted from the phosphor element 40G and the effective incident angle (30 degrees) of the light intensity equalizing element 113 have a relationship of the following formula (2).

(sin (80))²≈4×(sin (30))² (2)

As shown in formula (2), if it is assumed that the area of the spot diameter is SA (emission area), the area (L0×H0) of the incident end surface 113i of the light intensity equalizing element 113 illustrated in FIG. 6 is comparable to 4×SA. From this, the area SA of the spot diameter can be determined. Here, in FIG. 6, it is assumed that the incident end surface 113i and emitting end surface 113o have the same aspect ratio (L:H) and the same area.

The reason why the area of the incident end surface 113i is “comparable” to 4×SA is because, strictly speaking, the emitting end surface 113o is rectangular and the spot diameter is circular, so “equal” cannot be used. “Comparable” refers to nearly equal.

It is assumed that the emission area SA of the light source is comparable to the area of the spot diameter of excitation light. The emission area SA of the light source is the area of the region in which the phosphor emits fluorescence.

Here, the area and effective incident angle of the light beam incident on the incident end surface 113i of the light intensity equalizing element 113 are determined from the area and effective incident angle of the light beam incident on the light valve 121. Regarding this, they are also calculated by using formula (1). Here, since the emitting end surface 113o of the light intensity equalizing element 113 and the light valve 121 are in conjugate relation with each other, formula (1) can be applied.

It is assumed that an angle of the light beam incident on the incident end surface 113i is the same as an angle of the light beam emitted from the emitting end surface 113o.

From the above, it is possible to determine the light intensity distribution of the light concentrated on the phosphor element 40G from the area and effective angle of the light beam incident on the incident end surface 113i of the light intensity equalizing element 113.

In FIG. 18, the light intensity equalizing element 113 is inclined to the X and Y axes. Thus, it does not efficiently receive the light beams from the phosphor element 40G. However, the inclination with respect to the X and Y axes may be eliminated by rotating light beams before the light intensity equalizing element 113 about the center C of the light intensity equalizing element 113.

The inclination of the light emitted from the light intensity equalizing element 113 may be eliminated by devising the optical system after the light intensity equalizing element 113. For example, the inclination of the light intensity equalizing element 113 can be eliminated by modifying the illumination optical system to include a total reflection prism.

The light combining element 70 and deflecting mirror 71 need to be rotated in directions such that two light beams emitted from the light source (phosphor element 40G) are formed in the long side direction of the incident end surface 113i of the light intensity equalizing element 113. That is, the light concentration position 113a and light concentration position 113b need to be aligned in the long side direction of the incident end surface 113i. Thus, the arrangement of the first excitation light source unit 10a and second excitation light source unit 10b also need to be devised.

As described above, the two light source images are formed on the phosphor element 40G. A local light intensity distribution on the phosphor element 40G is reduced. Here, “local light intensity distribution” indicates that energy density is locally high. Local light saturation of the phosphor element 40G can be reduced. The conversion efficiency of the phosphor element 40G is improved.

Further, the reduction of the local light intensity distribution on the phosphor element 40G can be achieved by rotating the light combining element 70 and deflecting mirror 71. Thus, it is not necessary to add an optical element, so that by preventing the increase in the number of parts, it is possible to downsize the device, improve the assemblability, or reduce the cost.

It is possible to cause the two light beams emitted from the light source (phosphor element 40G) to be incident on the incident end surface 113i of the light intensity equalizing element 113.

The first embodiment has a configuration in which the light beams travel in the order of the light combining element 70, biconvex lens 101, deflecting mirror 71, and biconcave lens 102. However, a configuration may be employed in which the light beams travel in the order of the light combining element 70, deflecting mirror 71, biconvex lens 101, and biconcave lens 102. Even in this case, the light combining element 70 and deflecting mirror 71 should be rotated about the Y axis in the same direction.

In the first embodiment, the biconvex lens 101 and biconcave lens 102 are arranged to reduce the light beam diameter. However, the biconvex lens 101 and biconcave lens 102 may be omitted. That is, even if the biconvex lens 101 and biconcave lens 102 are omitted, the same advantages are obtained.

Likewise, the lens groups 200 and 300 may be omitted.

As above, the light source device 2 includes the light combining element 70 and phosphor element 40G. The light combining element 70 transmits first excitation light and reflects second excitation light. The phosphor element 40G receives the first excitation light and second excitation light and emits fluorescence.

The emission angle of the first excitation light emitted from the light combining element 70 and the reflection angle of the second excitation light reflected by the light combining element 70 are different from each other, so that the position 400a at which the first excitation light passing through the light combining element 70 reaches the phosphor element 40G and the position 400b at which the second excitation light reflected by the light combining element 70 reaches the phosphor element 40G are different from each other.

In the first embodiment, the first excitation light is the light emitted from the first excitation light source group 110A. The second excitation light is the light emitted from the second excitation light source group 110B.

In the first embodiment, the first light source 110A is described as the “first excitation light source group”, which includes multiple light sources. However, it is an example in which multiple light sources are used to increase the amount of light, and if a light source with a large amount of light is used, there is no need to use a “light source group”.

In the description of the first embodiment, the two light sources (light source groups) are used, but light from a single light source may be divided into first excitation light and second excitation light.

The light source device 2 includes the first light source 110A and second light source 110B. The first excitation light is emitted from the first light source 110A, and the second excitation light is emitted from the second light source 110B.

In the first embodiment, the first light source 110A is described as the first excitation light source group 110A. The second light source 110B is described as the second excitation light source group 110B.

The first excitation light passes through the reflection surface of the light combining element 70 for reflecting the second excitation light.

The light combining element 70 includes the transmission regions 75 for transmitting the first excitation light and the reflection surfaces of the reflection regions 74 for reflecting the second excitation light. The reflection regions 74 are regions different from the transmission regions 75.

The transmission regions 75 have the transmission surfaces. The transmission surfaces are on the same surface as the reflection surfaces of the reflection regions 74.

The transmission regions 75 are formed by openings provided in the light combining element 70.

The reflection surfaces of the light combining element 70 includes a normal to a surface including a central light ray of the light beam of the first excitation light and a central light ray of the light beam of the second excitation light, and is disposed in such a manner that it is rotated about the normal.

The transmission surfaces of the light combining element 70 includes a normal to a surface including a central light ray of the light beam of the first excitation light and a central light ray of the light beam of the second excitation light, and is disposed in such a manner that it is rotated about the normal.

The angle formed by the central light ray of the light beam of the first excitation light incident on the light combining element 70 and the central light ray of the light beam of the second excitation light incident on the light combining element 70 is 90 degrees.

If a reflection surface of the light combining element 70 is located, for example, on the side from which the first excitation light is emitted, the reflection surface of the light combining element 70 is disposed in such a manner that it is rotated about a normal to a surface including a central light ray of the light beam of the first excitation light and a central light ray of the light beam of the second excitation light, from a position at which an emission angle of the first excitation light with respect to the reflection surface of the light combining element 70 is 45 degrees.

If a reflection surface of the light combining element 70 is located, for example, on the side on which the first excitation light is incident, a transmission surface of the light combining element 70 is disposed in such a manner that it is rotated about a normal to a surface including a central light ray of the light beam of the first excitation light and a central light ray of the light beam of the second excitation light, from a position at which an emission angle of the first excitation light with respect to the transmission surface of the light combining element 70 is 45 degrees.

Thus, the light combining element 70 is disposed in such a manner that it is rotated about the normal to the surface including the central light ray of the light beam of the first excitation light and the central light ray of the light beam of the second excitation light.

The light source device 2 includes the deflecting mirror 71. The deflecting mirror 71 reflects the first excitation light passing through the light combining element 70 and the second excitation light reflected by the light combining element 70.

The reflection surface of the deflecting mirror 71 includes a normal to a plane including a central light ray of the light beam of the first excitation light incident on the deflecting mirror 71 and a central light ray of the light beam of the first excitation light reflected by the deflecting mirror 71, and is disposed in such a manner that it is rotated about the normal.

The reflection surface of the deflecting mirror 71 is disposed in such a manner that it is rotated about the normal to the plane including the central light ray of the light beam of the first excitation light incident on the deflecting mirror 71 and the central light ray of the light beam of the first excitation light reflected by the deflecting mirror 71, from a position at which an incident angle of the central light ray of the first excitation light with respect to the reflection surface of the deflecting mirror 71 is 45 degrees.

The light source device 2 includes the collimator lens 115A for converting the first excitation light emitted from the first light source 110A into a parallel light beam. The light source device 2 also includes the collimator lens 115B for converting the second excitation light emitted from the second light source 110B into a parallel light beam.

### Second Embodiment

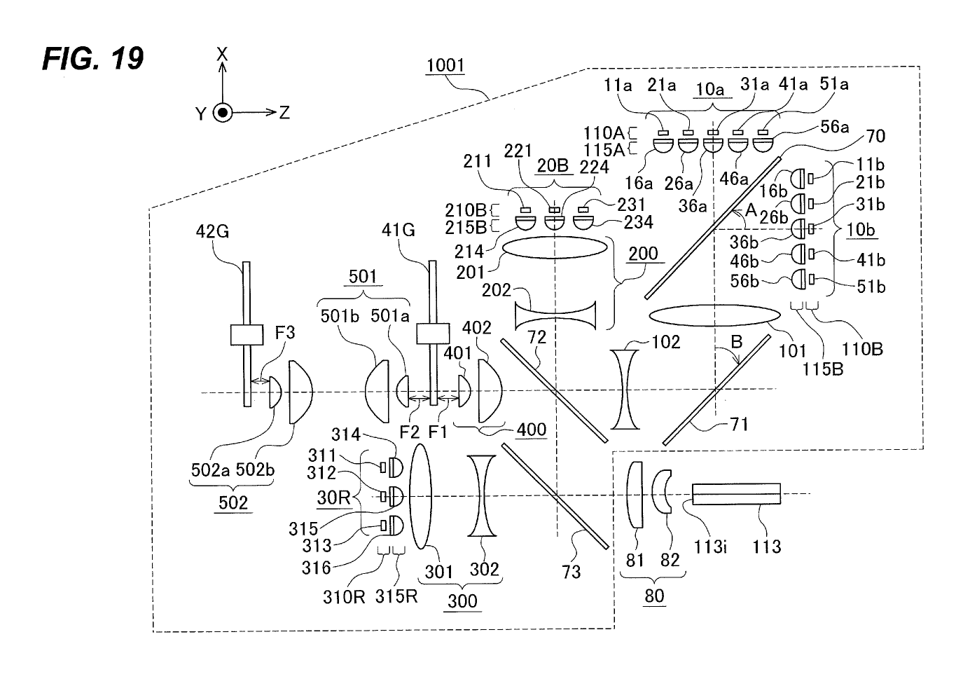

FIG. 19 is a configuration diagram schematically illustrating the main components of a light source device 1001 of a second embodiment of the present invention. The second embodiment differs from the first embodiment in having rotary phosphor elements 41G and 42G, a collimating lens group 501, and a condensing lens group 502. Elements that are the same as the elements of the projection display device 1 described in the first embodiment will be given the same reference characters, and descriptions thereof will be omitted.

Elements that are the same as in the first embodiment are the first excitation light source unit 10a, second excitation light source unit 10b, light combining element 70, biconvex lens 101, biconcave lens 102, deflecting mirror 71, color separation filter 72, color separation filter 73, condensing lens group 400 (convex lens 401 and aspheric convex lens 402), blue light source unit 20B, red light source unit 30R, and lens groups 200 and 300.

The condensing optical system 80 and light intensity equalizing element 113 are also the same as those of the projection display device 1 of the first embodiment. The elements after the light intensity equalizing element 113 are also the same as those of the projection display device 1 of the first embodiment. That is, elements that are the same as in the first embodiment are the relay lens group 115 (concave-convex lens (meniscus lens) 116, convex lens 117, and biconvex lens 118), deflecting mirror 120, condensing lens 122, light valve 121, projection optical system 124, and controller 3.

The light source devices 2 and 1001 include, as an afocal optical system, the biconvex lens 101 and biconcave lens 102. The condensing lens group 400 of the light source devices 2 and 1001 includes the convex lens 401 and aspheric convex lens 402. The relay lens group 115 of the light source devices 2 and 1001 includes the concave-convex lens (meniscus lens) 116, convex lens 117, and biconvex lens 118.

Regarding the configurations, functions, operations, or the like of the elements that are the same as in the first embodiment, if their descriptions are omitted in the second embodiment, descriptions in the first embodiment will be used therefor. Also, descriptions regarding the first embodiment in the second embodiment will be used as descriptions of the first embodiment. Here, “operations” includes the behavior of light.

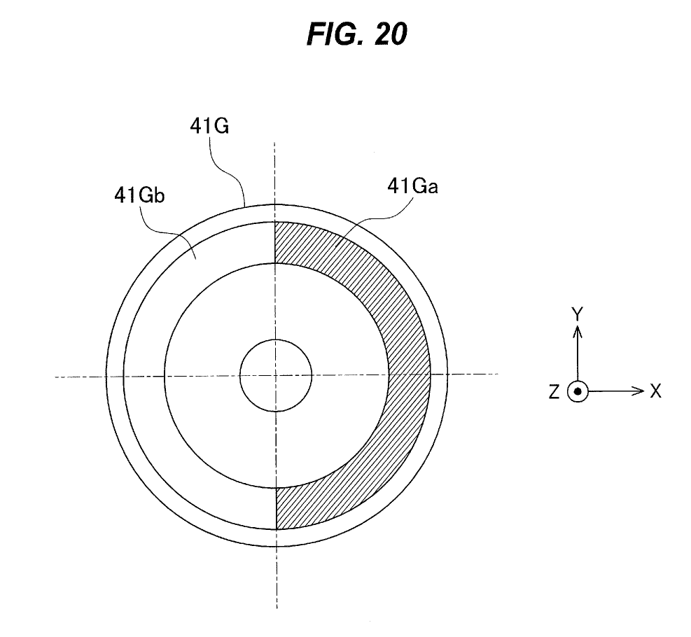

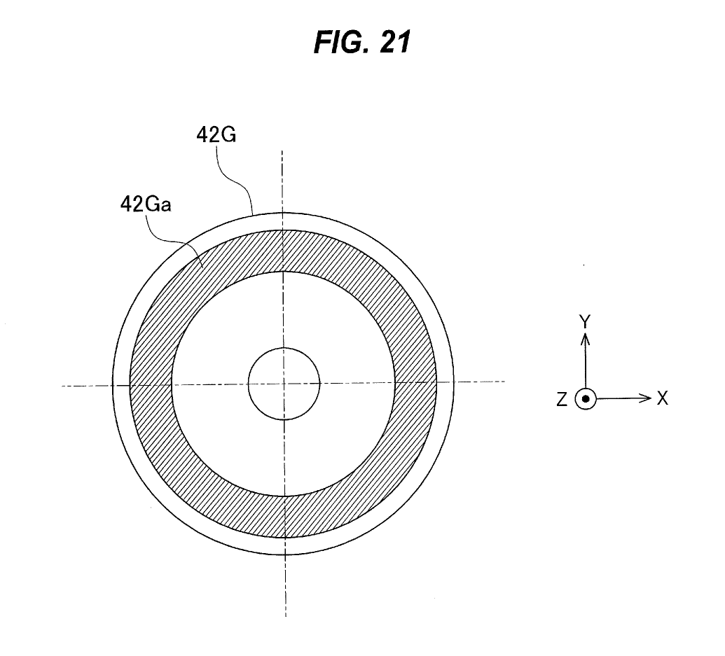

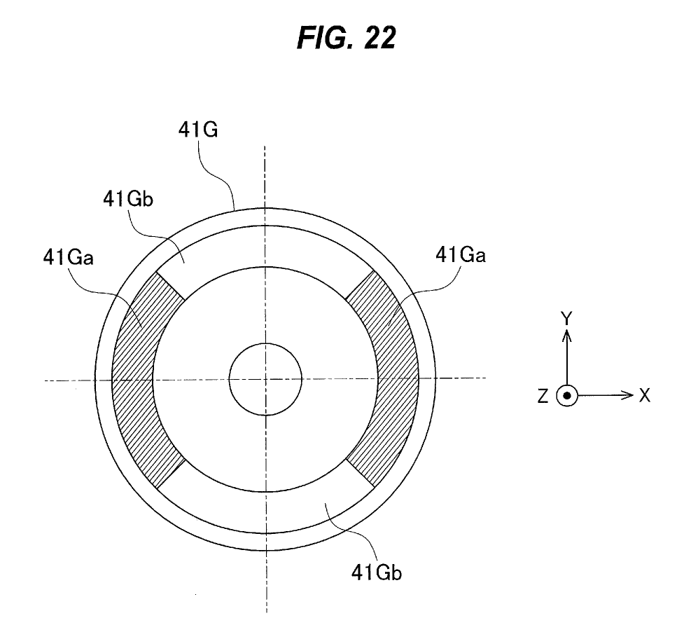

FIG. 20 is a schematic diagram of the rotary phosphor element 41G as viewed from the +Z axis direction. FIG. 21 is a schematic diagram of the rotary phosphor element 42G as viewed from the +Z axis direction. FIG. 22 is a schematic diagram of another example of the rotary phosphor element 41G as viewed from the +Z axis direction.

### <Configuration of Rotary Phosphor Element>

In FIG. 20, the rotary phosphor element 41G has, for example, a disk shape. Phosphor is applied to a part of a peripheral part of the disk. The rotary phosphor element 41G is not limited to a disk shape.

A region 41Ga of the rotary phosphor element 41G is a region to which the phosphor is applied. The peripheral part of the disk is a region onto which a light beam is irradiated.

A region 41Gb of the rotary phosphor element 41G is a region (transmission region) for transmitting light. That is, a light beam incident on the region 41Gb passes through the region 41Gb.

In FIG. 20, the right half (+X axis direction side) of the peripheral part of the rotary phosphor element 41G is the region 41Ga. The left half (−X axis direction side) of the peripheral part of the rotary phosphor element 41G is the region 41Gb.

In FIG. 22, the peripheral part of the rotary phosphor element 41G is divided into four parts, and regions 41Ga and regions 41Gb are arranged alternately.

In FIG. 22, the right side (+X axis direction side) and left side (−X axis direction side) of the peripheral part of the rotary phosphor element 41G are the regions 41Ga. The upper side (+Y axis direction side) and lower side (−Y axis direction side) of the peripheral part of the rotary phosphor element 41G are the regions 41Gb.

In FIG. 21, the rotary phosphor element 42G has, for example, a disk shape. Phosphor is applied to the whole of a peripheral part of the disk. The rotary phosphor element 42G is not limited to a disk shape.

A region 42Ga of the rotary phosphor element 42G is the region to which the phosphor is applied. The peripheral part of the disk is a region onto which a light beam is irradiated.

<Behavior of Light Emitted from Excitation Light Source Groups 110A and 1103>

The light beams emitted from the first excitation light source unit 10a and second excitation light source unit 10b are collimated by the biconvex lens 101 and biconcave lens 102. The light beams emitted from the first excitation light source unit 10a and second excitation light source unit 10b are then incident on the condensing lens group 400.

As in the first embodiment, the deflecting mirror 71 is disposed between the biconvex lens 101 and the biconcave lens 102.

As in the first embodiment, the traveling direction of the light beams traveling in the −X axis direction from the biconvex lens 101 is changed by the deflecting mirror 71 to the −Z axis direction.

The light beams incident on the condensing lens group 400 are concentrated by the condensing lens group 400 on the rotary phosphor element 41G.

Light beams concentrated on the region 41Ga of the rotary phosphor element 41G are converted by the phosphor into a green light beam (fluorescence).

The green light beam converted by the region 41Ga into fluorescence travels in the +Z axis direction. The green light beam emitted from the rotary phosphor element 41G then reaches the condensing lens group 400. The green light beam emitted from the rotary phosphor element 41G is collimated by the condensing lens group 400. The collimated green light beam then travels in the +Z axis direction. The collimated green light beam travels toward the color separation filter 72.

On the other hand, light beams concentrated on the region 41Gb of the rotary phosphor element 41G passes through the rotary phosphor element 41G.

The light beams passing through the rotary phosphor element 41G travel in the −Z axis direction.

The collimating lens group 501 is disposed on the −Z axis direction side of the rotary phosphor element 41G.

The collimating lens group 501 includes a convex lens 501a and a convex lens 501b. The convex lens 501a is disposed on the +Z axis direction side of the collimating lens group 501. The convex lens 501b is disposed on the −Z axis direction side of the collimating lens group 501.

The light beams passing through the rotary phosphor element 41G reach the collimating lens group 501. The light beams passing through the rotary phosphor element 41G are then collimated again by the collimating lens group 501.

The light beams collimated by the collimating lens group 501 travel in the −Z axis direction.

The condensing lens group 502 is disposed on the −Z axis direction side of the collimating lens group 501.

The condensing lens group 502 includes a convex lens 502a and a convex lens 502b. The convex lens 502b is disposed on the +Z axis direction side of the condensing lens group 502. The convex lens 502a is disposed on the −Z axis direction side of the condensing lens group 502.

The light beams collimated by the collimating lens group 501 reach the condensing lens group 502. The light beams collimated by the collimating lens group 501 are concentrated by the condensing lens group 502 on the region 42Ga of the rotary phosphor element 42G.

The light beams concentrated by the condensing lens group 502 travel in the −Z axis direction.

The rotary phosphor element 42G is disposed on the −Z axis direction side of the condensing lens group 502.

The light beams concentrated by the condensing lens group 502 reach the rotary phosphor element 42G. The light beams concentrated on the region 42Ga of the rotary phosphor element 42G are converted by the phosphor into a green light beam (fluorescence).

The green light beam converted by the region 42Ga travels in the +Z axis direction. The green light beam emitted from the rotary phosphor element 42G then reaches the condensing lens group 502.

The green light beam emitted from the rotary phosphor element 42G is collimated by the condensing lens group 502. The green light beam collimated by the condensing lens group 502 then travels in the +Z axis direction.

The light beam collimated by the condensing lens group 502 reaches the collimating lens group 501. The light beam collimated by the condensing lens group 502 is concentrated by the collimating lens group 501 on the region 41Gb of the rotary phosphor element 41G.

Since the region 41Gb is a transmission region, the light beam concentrated on the region 41Gb passes through the rotary phosphor element 41G. Although the rotary phosphor element 41G is rotating, since a light beam reaching the rotary phosphor element 42G has passed through the region 41Gb, fluorescence emitted from the region 42Ga also passes through the region 41Gb.

The light beam passing through the rotary phosphor element 41G reaches the condensing lens group 400. The light beam passing through the rotary phosphor element 41G is collimated by the condensing lens group 400.

The light beam collimated by the condensing lens group 400 travels in the +Z axis direction. The light beam collimated by the condensing lens group 400 travels toward the color separation filter 72.

Thus, light beams concentrated on the regions 41Ga and 42Ga, to which phosphor is applied, of the rotary phosphor elements 41G and 42G reach them at different times.

When light beams are concentrated on the region 41Ga, the light beams are converted by the rotary phosphor element 41G into a green light beam. When light beams are concentrated on the region 41Gb, the light beams are converted by the rotary phosphor element 42G into a green light beam.

Thus, it becomes possible to temporally divide and halve local energy density of each phosphor. Then, it is possible to improve the efficiency of conversion into light emitted by the phosphors of the rotary phosphor elements 41G and 42G. It is also possible to prolong the lifetime of phosphor.

Here, the lenses 401, 501a, and 502a may be identical to each other. The lenses 402, 501b, and 502b may be identical to each other. The collimating lens groups 501 and 502 are identical to the condensing lens group 400. By using common lenses, it is possible to facilitate modularization and improve assemblability, which makes it possible to reduce the increase in cost.

It is preferable that the condensing lens group 400, collimating lens group 501, and condensing lens group 502 have the same focus.

This is because it is preferable that the diameter of the light beam concentrated on the rotary phosphor element 42G be equal to the diameter of the light beam concentrated on the rotary phosphor element 41G after exiting the rotary phosphor element 42G.

Thus, it is preferable that distances F1, F2, and F3 be equal to each other. The distance F1 is the distance between the lens 401 and the rotary phosphor element 41G. The distance F2 is the distance between the rotary phosphor element 41G and the lens 501a. The distance F3 is the distance between the lens 502a and the rotary phosphor element 42G.

A case where the rotary phosphor element 41G and rotary phosphor element 42G are not controlled temporally has been described. However, if they are controlled temporally, when the transmission region 41Gb of the rotary phosphor element 41G is on the light beams, the region 42Ga, to which phosphor is applied, of the rotary phosphor element 42G should be on the light beams. For example, as illustrated in FIG. 22, the number of transmission regions 41Gb of the rotary phosphor element 41G is arbitrary.

The rotary phosphor element 41G and rotary phosphor element 42G may be identical to each other. For example, the rotary phosphor element 41G illustrated in FIG. 20 or 22 is employed as the rotary phosphor element 42G.

By driving the rotary phosphor elements 41G and 42G in a time-division manner, it becomes possible to obtain a single rotary phosphor. As viewed from the rotational axis direction (Z axis direction), the rotary phosphor elements 41G and 42G should rotate so that the region 41Gb of the rotary phosphor element 41G and the region 42Ga of the rotary phosphor element 42G overlap each other.

In this case, light beams passing through the region 41Gb of the rotary phosphor element 41G are concentrated on the region 42Ga of the rotary phosphor element 42G. The parts can be made common, the assemblability improves, and the cost can be reduced.

The second embodiment describes a case where the first excitation light source unit 10a and second excitation light source unit 10b are disposed, but it is possible to remove the light combining element 70 and second excitation light source unit 10b and shift the first excitation light source unit 10a in the −X axis direction. That is, it is possible to shift the first excitation light source unit 10a in a direction toward the biconvex lens 101.

Thereby, it is possible to downsize the projection display device 1001 in the X axis direction. It becomes possible to downsize the projection display device 1001 while maintaining the advantage of prolonging the lifetime of the phosphor by the time-division driving.

As above, the light source device 1001 includes the first condensing lens 400, first rotary phosphor element 41G, and second condensing lens 502. The light source device 1001 also includes the phosphor element 42G.

In the second embodiment, the first condensing lens 400 is described as the condensing lens group 400. The second condensing lens 502 is described as the condensing lens group 502. The phosphor element 42G is described as the rotary phosphor element 42G.

The first condensing lens 400 converts excitation light into first concentrated light. The first rotary phosphor element 41G is disposed at a position at which the first concentrated light is concentrated. The first rotary phosphor element 41G includes the first phosphor region 41Ga to which phosphor is applied and that receives the first concentrated light and emits fluorescence, and the transmission region 41Gb that transmits the first concentrated light. The second condensing lens 502 converts the first concentrated light passing through the first rotary phosphor element 41G into second concentrated light.

The first concentrated light reaches the first phosphor region 41Ga or transmission region 41Gb due to rotation of the first rotary phosphor element 41G.

The phosphor element 42G is disposed at a position at which the second concentrated light is concentrated. The phosphor element 42G includes the second phosphor region 42Ga to which a phosphor element is applied and that receives the second concentrated light and emits second fluorescence.

The light source device 1001 includes the third condensing lens 501 that collimates the first concentrated light passing through the first rotary phosphor element 41G.

In the second embodiment, the third condensing lens 501 is described as the condensing lens group 501.

In the second embodiment, the light beams incident on the first condensing lens 400 and the light beams incident on the second condensing lens 502 are parallel light beams. However, the light beams incident on the first condensing lens 400 need not necessarily be parallel light beams. It is sufficient that the light beams be concentrated by the first condensing lens 400 at a position of the first rotary phosphor element 41G. It is sufficient that light converted into fluorescence by the first rotary phosphor element 41G be collimated.

Further, the light beams incident on the second condensing lens 502 need not necessarily be parallel light beams. It is sufficient that the light beams be concentrated by the second condensing lens 502 at a position of the second rotary phosphor element 42G. It is sufficient that light converted into fluorescence by the second rotary phosphor element 42G be collimated. This is because, since the fluorescence is light having a great divergence angle, in order to concentrate the fluorescence at a position of the first rotary phosphor element 41G, it is preferable to collimate the fluorescence.

The light source device 1001 includes the light source 110A and collimator lens 115A. The light source 110A emits excitation light. The collimator lens 115A converts the excitation light emitted from the light source 110A into a first parallel light beam.

The light source device 1001 includes the third condensing lens 501. The third condensing lens 501 converts the first concentrated light passing through the first rotary phosphor element 41G into a parallel light beam.

### Third Embodiment

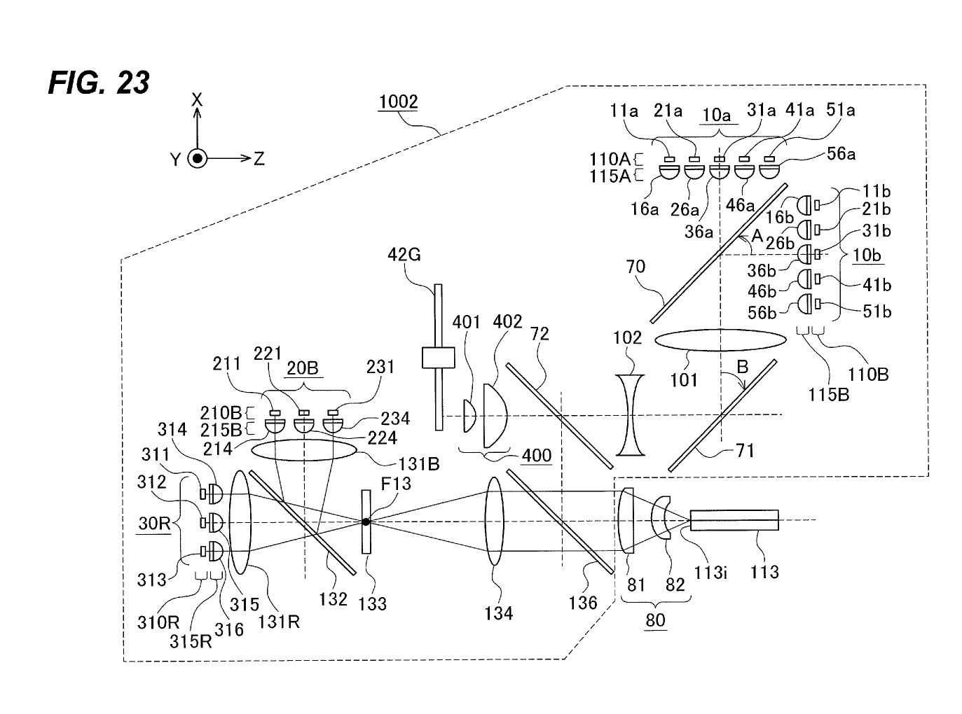

FIG. 23 is a configuration diagram schematically illustrating the main components of a light source device 1002 of a third embodiment of the present invention.

The third embodiment differs from the first embodiment in the characteristics of a color separation filter 136. The color separation filter 136 corresponds to the color separation filter 73 in the first embodiment. It also differs from the first embodiment in the optical paths of light emitted from the blue light source unit 20B and light emitted from the red light source unit 30R.

In the first embodiment, the lens groups 200 and 300 convert the red light beams and blue light beams into the parallel light beams and emit them. However, in the third embodiment, convex lenses 131B and 131R convert red light beams and blue light beams into concentrated light beams and emit them.

Elements that are the same as the elements of the projection display device 1 described in the first embodiment will be given the same reference characters, and descriptions thereof will be omitted.

Elements that are the same as in the first embodiment are the first excitation light source unit 10a, second excitation light source unit 10b, light combining element 70, biconvex lens 101, biconcave lens 102, deflecting mirror 71, and condensing lens group 400 (convex lens 401 and aspheric convex lens 402).

The condensing optical system 80 and light intensity equalizing element 113 are also the same as those of the projection display device 1 of the first embodiment. The elements after the light intensity equalizing element 113 are also the same as those of the projection display device 1 of the first embodiment. That is, elements that are the same as in the first embodiment are the relay lens group 115 (concave-convex lens (meniscus lens) 116, convex lens 117, and biconvex lens 118), deflecting mirror 120, condensing lens 122, light valve 121, projection optical system 124, and controller 3.

The light source devices 2, 1001, and 1002 include, as an afocal optical system, the biconvex lens 101 and biconcave lens 102.

The condensing lens group 400 of the light source devices 2, 1001, and 1002 includes the convex lens 401 and aspheric convex lens 402.

The relay lens group 115 of the light source devices 2, 1001, and 1002 includes the concave-convex lens (meniscus lens) 116, convex lens 117, and biconvex lens 118.

The positions at which the blue light source unit 20B and red light source unit 30R are disposed differ from those in the first embodiment, but the functions, characteristics, and the like of the blue light source unit 20B and red light source unit 30R are the same as those in the first embodiment. Thus, the reference characters of the elements constituting the blue light source unit 20B and red light source unit 30R are the same as those in the first embodiment.

As an element corresponding to the phosphor element 40G of the first embodiment, the rotary phosphor element 42G described in the second embodiment is used. However, in the light source device 1002 of the third embodiment, the phosphor element 40G of the first embodiment may be employed.

Regarding the configurations, functions, operations, or the like of the elements that are the same as in the first or second embodiment, if their descriptions are omitted in the third embodiment, descriptions in the first or second embodiment will be used therefor. Also, descriptions regarding the first or second embodiment in the third embodiment will be used as descriptions of the first or second embodiment. Here, “operations” includes the behavior of light.

### <Blue Light Source Unit 20B and Blue Light Beam>

The light source device 1002 includes the blue light source unit 20B. The blue light source unit 20B includes the blue light source group 210B that emits light in a blue wavelength range. The blue light source unit 20B also includes the collimator lens group 215B.

The blue light source group 210B includes the multiple blue light sources 211, 212, 213, 221, 222, 223, 231, 232, and 233.

The blue light source 211, 212, 213, 221, 222, 223, 231, 232, and 233 are arranged on a Y-Z plane, as in the first embodiment.

Light beams emitted from the blue light source group 210B travel in the −X axis direction.

As illustrated in FIG. 23, the collimator lens group 215B is disposed on the −X axis direction side of the blue light source group 210B.

The collimator lens group 215B includes multiple collimator lenses 214, 215, 216, 224, 225, 226, 234, 235, and 236.

The blue light beams emitted from the blue light source group 210B are collimated by the collimator lens group 215B.

The blue light beams collimated by the collimator lens group 215B travel in the −X axis direction.

The lens 131B is disposed on the −X axis direction side of the collimator lens group 215B.

The blue light beams collimated by the collimator lens group 215B reach the lens 131B. The blue light beams collimated by the collimator lens group 215B are concentrated by the lens 131B.

The blue light beams concentrated by the lens 131B travel in the −X axis direction.

A color separation filter 132 is disposed on the −X axis direction side of the lens 131B.

The blue light beams concentrated by the lens 131B reach the color separation filter 132. The blue light beams concentrated by the lens 131B are reflected by the color separation filter 132.

The traveling direction of the blue light beams reflected by the color separation filter 132 is changed from the −X axis direction to the +Z axis direction.

A light diffusion element 133 is disposed on the +Z axis direction side of the color separation filter 132.

The blue light beams reflected by the color separation filter 132 are concentrated at a position F13 on the light diffusion element 133.

The blue light beams concentrated at the light concentration position F13 of the light diffusion element 133 are diffused by the light diffusion element 133.

The blue light beams diffused by the light diffusion element 133 travel in the +Z axis direction.

A lens 134 is disposed on the +Z axis direction side of the light diffusion element 133.

The blue light beams diffused by the light diffusion element 133 reach the lens 134. The blue light beams reaching the lens 134 are collimated.

The blue light beams collimated by the lens 134 travel in the +Z axis direction.

The color separation filter 136 is disposed on the +Z axis direction side of the lens 134.

The blue light beams collimated by the lens 134 reach the color separation filter 136. The blue light beams collimated by the lens 134 pass through the color separation filter 136.

The blue light beams passing through the color separation filter 136 travel in the +Z axis direction.

The condensing optical system 80 is disposed on the +Z axis direction side of the color separation filter 136.

The blue light beams passing through the color separation filter 136 reach the condensing optical system 80. The blue light beams passing through the color separation filter 136 are concentrated by the condensing optical system 80.

The blue light beams concentrated by the condensing optical system 80 travel in the +Z axis direction.

The light intensity equalizing element 113 is disposed on the +Z axis direction side of the condensing optical system 80.

The blue light beams concentrated by the condensing optical system 80 are concentrated on the incident end surface 113i of the light intensity equalizing element 113.

Here, it is preferable that a focal position of the lens 134 be at the position F13. Thereby, a light beam emitted from the position F13 is collimated by the lens 134.

### <Red Light Source Unit 30R and Red Light Beam>

The light source device 1002 includes the red light source unit 30R. The red light source unit 30R includes the red light source group 310R that emits light in a red wavelength range. The red light source unit 30R also includes the collimator lens group 315R.

The red light source group 310R includes the multiple red light sources 311, 312, 313, 321, 322, 323, 331, 332, and 333.

The red light sources 311, 312, 313, 321, 322, 323, 331, 332, and 333 are arranged on an X-Y plane, as in the first embodiment.

Light beams emitted from the red light source group 310R travel in the +Z axis direction.

As illustrated in FIG. 23, the collimator lens group 315R is disposed on the +Z axis direction side of the red light source group 310R.

The collimator lens group 315R includes the multiple collimator lenses 314, 315, 316, 324, 325, 326, 334, 335, and 336.

The red light beams emitted from the red light source group 310R are collimated by the collimator lens group 315R.

The red light beams collimated by the collimator lens group 315R travel in the +Z axis direction.

The lens 131R is disposed on the +Z axis direction side of the collimator lens group 315R.

The red light beams collimated by the collimator lens group 315R reach the lens 131R. The red light beams collimated by the collimator lens group 315R are concentrated by the lens 131R.

The red light beams concentrated by the lens 131R travel in the +Z axis direction.

The color separation filter 132 is disposed on the +Z axis direction side of the lens 131R.

The red light beams concentrated by the lens 131R reach the color separation filter 132. The red light beams emitted from the lens 131R pass through the color separation filter 132.

The red light beams passing through the color separation filter 132 travel in the +Z axis direction.

The light diffusion element 133 is disposed on the +Z axis direction side of the color separation filter 132.

The red light beams passing through the color separation filter 132 are concentrated at the position F13 on the light diffusion element 133.

The red light beams concentrated at the light concentration position F13 of the light diffusion element 133 are diffused by the light diffusion element 133.

The red light beams diffused by the light diffusion element 133 travel in the +Z axis direction.

The lens 134 is disposed on the +Z axis direction side of the light diffusion element 133.

The red light beams diffused by the light diffusion element 133 reach the lens 134. The red light beams reaching the lens 134 are collimated.

The red light beams collimated by the lens 134 travel in the +Z axis direction.

The color separation filter 136 is disposed on the +Z axis direction side of the lens 134.

The red light beams collimated by the lens 134 reach the color separation filter 136. The red light beams collimated by the lens 134 pass through the color separation filter 136.

The red light beams passing through the color separation filter 136 travel in the +Z axis direction.

The condensing optical system 80 is disposed on the +Z axis direction side of the color separation filter 136.

The red light beams passing through the color separation filter 136 reach the condensing optical system 80. The red light beams passing through the color separation filter 136 are concentrated by the condensing optical system 80.

The red light beams concentrated by the condensing optical system 80 travel in the +Z axis direction.

The light intensity equalizing element 113 is disposed on the +Z axis direction side of the condensing optical system 80.

The red light beams concentrated by the condensing optical system 80 are concentrated on the incident end surface 113i of the light intensity equalizing element 113.

Here, it is preferable that a focal position of the lens 134 be at the position F13. Thereby, a light beam emitted from the position F13 is collimated by the lens 134.

In view of color magnification, the light concentration position of the blue light beams emitted from the blue light source group 210B may be on the +Z axis direction side of the light concentration position of the red light beams emitted from the red light source group 310R. In this case, there are two positions F13: the light concentration position of the blue light beams, and the light concentration position of the red light beams. The light diffusion element 133 may be disposed between the light concentration position of the blue light beams and the light concentration position of the red light beams.

### <Color Separation Filters 132 and 136>

Here, the color separation filter 132 should have a characteristic of reflecting light beams in a blue wavelength range and transmitting light beams in a red wavelength range.

The positions of the blue light source unit 20B and red light source unit 30R may be interchanged. In this case, the color separation filter 132 should have a characteristic of transmitting light beams in a blue wavelength range and reflecting light beams in a red wavelength range.

The light beams in the blue wavelength range and the light beams in the red wavelength range collimated by the lens 134 pass through the color separation filter 136. The light beams in the blue wavelength range and the light beams in the red wavelength range are concentrated by the condensing optical system 80 on the incident end surface 113i of the light intensity equalizing element 113.

Here, the color separation filter 136 should have a characteristic of transmitting light beams in a blue wavelength range and light beams in a red wavelength range and reflecting light beams in a green wavelength range.

The configuration of the third embodiment makes it possible to separate the optical path of light emitted by laser light sources and the optical path of excitation light and fluorescence of a light source using a phosphor.

In the third embodiment, the laser light sources are the blue light source group 210B and red light source group 310R. The light source using a phosphor includes the rotary phosphor element 42G. The excitation light of the phosphor is emitted from the first excitation light source group 110A and second excitation light source group 110B.

Laser light is light likely to cause visible speckle. In contrast, fluorescence of a phosphor is light less likely to cause visible speckle.

By separating the two optical paths, it is possible to place the light diffusion element 133 only on the optical path of light emitted by the laser light sources. Thus, it is possible to prevent reduction in light use efficiency caused by placing the light diffusion element 133 on the optical path of fluorescence.

If the visibility of the speckle is high, the light diffusion element 133 may be rotated. This temporally varies spotty brightness unevenness generated on the irradiated surface 150, such as a screen. This can reduce the visibility of the speckle.

“Speckle” refers to spotty brightness unevenness occurring on a screen that is an irradiated surface due to interference between laser light beams emitted from light source units. The speckle may cause degradation in image quality.

In the case of the configuration of the first embodiment, the light diffusion element 133 is disposed near the incident end surface 113i of the light intensity equalizing element 113. In this case, light use efficiency of the green light beam emitted from the phosphor element 40G is reduced due to diffusion of the light.

If the light diffusion element 133 is disposed at a position at which it is conjugate relation with the light sources 210B and 310R, the speckle reduction effect tends to be improved. In another preferable aspect, the light diffusion element 133 is disposed immediately after the light sources 210B and 310R. In another preferable aspect, the light diffusion element 133 is disposed near the incident end surface 113i of the light intensity equalizing element 113. In another preferable aspect, the light diffusion element 133 is disposed at a pupil position between the light intensity equalizing element 113 and the light valve 121. “Pupil position” refers to a position on an optical axis at which principal rays intersect.

Thus, as described in the third embodiment, the position F13 is at a position conjugated with the light sources 210B and 310R, the position being located before the light intensity equalizing element 113. Here, “before” refers to the −Z axis direction side. This eliminates the need to place the light diffusion element 133 on the optical path of the light beam (fluorescence) emitted from the rotary phosphor element 42G.

The third embodiment describes a case where visible speckle is likely to occur. However, if visible speckle is less likely to occur, in the configuration of FIG. 1, on the optical path of light emitted from the blue light source unit 20B, a light diffusion element 133 may be disposed between the collimator lens group 215B and the color separation element 72. Also, on the optical path of light emitted from the red light source unit 30R, a light diffusion element 133 may be disposed between the collimator lens group 315R and the color separation filter 73.

One of the reasons why visible speckle is less likely to occur may be that the light source units 20B and 30R include a large number of light sources. Another of the reasons may be that the light sources constituting the light source unit 20B have different center wavelengths and the light sources constituting the light source unit 30R have different center wavelengths. The reasons may include others.

If the light sources of the different colors are greatly different in visibility of speckle, the light source unit with low visibility of speckle may be disposed on the +X axis direction side of the color separation filter 72, as in FIG. 1. That is, the light source unit with low visibility of speckle is disposed before the color separation filter 72.

For example, in a case where the speckle visibility of the red light beams emitted from the red light source unit 30R is higher than the speckle visibility of the blue light beams emitted from the blue light source unit 20B, it is possible to arrange only the blue light source unit 20B on the +X axis direction side of the color separation filter 72.

In a case where the magnitude relationship between the speckle visibilities is opposite, it is possible to arrange only the red light source unit 30R on the +X axis direction side of the color separation filter 72. “Case where the magnitude relationship between the speckle visibilities is opposite” refers to a case where the speckle visibility of the blue light beams emitted from the blue light source unit 20B is higher than the speckle visibility of the red light beams emitted from the red light source unit 30R.

As above, the light source device 1002 includes the first laser light source 210B, second laser light source 310R, and color separation filter 136.

In the third embodiment, the first laser light source 210B is described as the blue light source group 210B. The second laser light source 310R is described as the red light source group 310R.

The first laser light source 210B emits first laser light in a wavelength range different from the wavelength range of the fluorescence. The second laser light source 310R emits second laser light in a wavelength range different from the wavelength range of the fluorescence and the wavelength range of the first laser light. The color separation filter 136 reflects or transmits light depending on the wavelength of the light.

The color separation filter 136 reflects the fluorescence if it transmits the first laser light and second laser light and transmits the fluorescence if it reflects the first laser light and second laser light, thereby arranging the first laser light, second laser light, and fluorescence on the same optical path.

The third embodiment is described using the rotary phosphor element 42G. However, in place of the rotary phosphor element 42G, the phosphor element 40G described in the first embodiment may be used. The rotary phosphor elements 41G and 42G described in the second embodiment may also be used in place of the rotary phosphor element 42G.

In the description of the third embodiment, the phosphor emits green light. However, the phosphor may emit fluorescence of a color other than green. For example, the color of the fluorescence may be red or blue.

Likewise, in the description, the laser light sources are the blue laser light source 210B and red laser light source 310R. However, the laser light sources may be laser light sources of other colors. For example, a laser light source may be a green laser light source.

### Fourth Embodiment

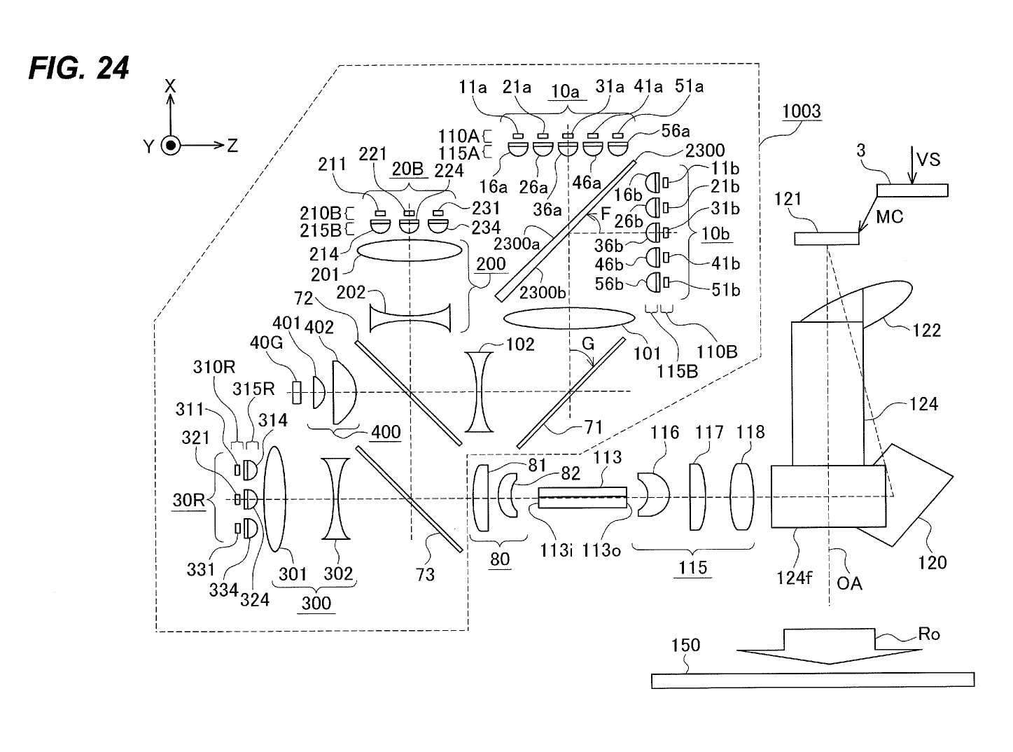

FIG. 24 is a configuration diagram schematically illustrating the main components of a light source device 1003 of a fourth embodiment of the present invention. The fourth embodiment differs from the first embodiment in having a light combining element 2300. Elements that are the same as the elements of the projection display device 1 described in the first embodiment will be given the same reference characters, and descriptions thereof will be omitted.

Elements that are the same as in the first embodiment are the first excitation light source unit 10a (first excitation light source group 110A and first collimator lens group 115A), second excitation light source unit 10b (second excitation light source group 110B and second collimator lens group 115B), biconvex lens 101, biconcave lens 102, deflecting mirror 71, color separation filter 72, color separation filter 73, condensing lens group 400 (convex lens 401 and aspheric convex lens 402), phosphor element 40G, blue light source unit 20B (blue light source group 210B and collimator lens group 215B), red light source unit 30R (red light source group 310R and collimator lens group 315R), and lens groups 200 and 300.

The condensing optical system 80 and light intensity equalizing element 113 are also the same as those of the projection display device 1 of the first embodiment. The elements after the light intensity equalizing element 113 are also the same as those of the projection display device 1 of the first embodiment. That is, elements that are the same as in the first embodiment are the relay lens group 115 (concave-convex lens (meniscus lens) 116, convex lens 117, and biconvex lens 118), deflecting mirror 120, condensing lens 122, light valve 121, projection optical system 124, and controller 3.

The light source devices 2, 1001, 1002, and 1003 include, as an afocal optical system, the biconvex lens 101 and biconcave lens 102.

The condensing lens group 400 of the light source device 2, 1001, 1002, and 1003 includes the convex lens 401 and aspheric convex lens 402.

The relay lens group 115 of the light source device 2, 1001, 1002, and 1003 includes the concave-convex lens (meniscus lens) 116, convex lens 117, and biconvex lens 118.

Regarding the configurations, functions, operations, or the like of the elements that are the same as in the first embodiment, if their descriptions are omitted in the fourth embodiment, descriptions in the first embodiment will be used therefor. Also, descriptions regarding the first embodiment in the fourth embodiment will be used as descriptions of the first embodiment. Here, “operations” includes the behavior of light.

### <Light Combining Element 2300>

The light combining element 2300, which is an element different from that in the first embodiment, will be described.

The light combining element 2300 has a surface 2300a on the +X axis direction side. The surface 2300a is an incident surface through which light emitted from the first excitation light source unit 10a enters the light combining element 2300.

The light combining element 2300 also has a surface 2300b on the −X axis direction side. The surface 2300b is a reflection surface that reflects light emitted from the second excitation light source unit 10b. The surface 2300b is an emitting surface from which light emitted from the first excitation light source unit 10a and passing through the light combining element 2300 exits.

The surface 2300a may be a reflection surface that reflects light emitted from the second excitation light source unit 10b. In this case, light emitted from the second excitation light source unit 10b passes through the surface 2300b, and is then reflected by the surface 2300a and emitted from the surface 2300b. The following description assumes that the surface 2300b is a reflection surface.

The surface 2300a is a transmission surface. For example, no reflection film is formed on the surface 2300a.

The surface 2300b transmits parallel light beams emitted from the first excitation light source unit 10a. The surface 2300b also reflects parallel light beams emitted from the second excitation light source unit 10b. In FIG. 24, the parallel light beams emitted from the second excitation light source unit 10b are reflected by the surface 2300b in the −X axis direction.

For example, the surface 2300b has the wavelength transmission characteristic illustrated in FIG. 4. Suppose that the first excitation light source group 110A is P-polarized light and the second excitation light source group 110B is S-polarized light. Here, the polarization direction of the P-polarized light is different by 90 degrees from the polarization direction of the S-polarized light.

The light emitted from the first excitation light source group 110A passes through the light combining element 2300. The light emitted from the first excitation light source group 110A passes through the surfaces 2300a and 2300b.

The light emitted from the second excitation light source group 110B is incident on the surface 2300b at an angle F. Here, the angle F is an angle having a value obtained by subtracting the incident angle from 90 degrees. The angle F is an angle corresponding to the angle A illustrated in FIG. 1 of the first embodiment. The light emitted from the second excitation light source group 110B is reflected by the surface 2300b of the light combining element 2300.

The light emitted from the first excitation light source group 110A and the light emitted from the second excitation light source group 110B travel in the same direction. In FIG. 24, the light emitted from the first excitation light source group 110A and the light emitted from the second excitation light source group 110B travel in the −X axis direction.

In FIG. 24, the light emitted from the first excitation light source group 110A and the light emitted from the second excitation light source group 110B are mutually superposed on the surface 2300b.

The light emitted from the first excitation light source group 110A and the light emitted from the second excitation light source group 110B need not necessarily be mutually superposed. However, coincidence of a central light ray of the light sources of the first excitation light source group 110A and a central light ray of the light sources of the second excitation light source group 110B provides a new advantage of allowing the optical system after the light combining element 2300 to be downsized.

In FIG. 24, the angle F is an angle formed by the light emitted from the second excitation light source group 110B and the surface 2300b (reflection surface) of the light combining element 2300. The incident angle is defined as an angle between the traveling direction of the light and the normal to the boundary surface. Here, the angle F is an angle by which the surface 2300b of the light combining element 2300 is rotated counterclockwise from a Y-Z plane as viewed from the +Y axis.

The deflecting mirror 71 is disposed on the −X axis direction side of the biconvex lens 101.

As described above, in the first embodiment, the central light ray of the concentrated light beam exiting the biconvex lens 101 is parallel to the X axis. The deflecting mirror 71 is rotated clockwise by the angle B from an X-Y plane as viewed from +Y axis.

Thus, the concentrated light beam exiting the biconvex lens 101 is incident on the deflecting mirror 71 at an angle G. Here, the angle G is an angle having a value obtained by subtracting the incident angle P1 from 90 degrees. The angle G is an angle corresponding to the angle B illustrated in FIG. 1 of the first embodiment.

In FIG. 24, if the light beams emitted from the second excitation light source unit 10b are taken as a basis, an angle formed by a central light ray of the light reflected by the light combining element 2300 and the reflection surface of the deflecting mirror 71 is the angle G. If the light beams emitted from the first excitation light source unit 10a are taken as a basis, an angle formed by a central light ray of the light passing through the light combining element 2300 and the reflection surface of the deflecting mirror 71 is the angle G. The angle G is an angle by which the deflecting mirror 71 is rotated clockwise from an X-Y plane as viewed from +Y axis.

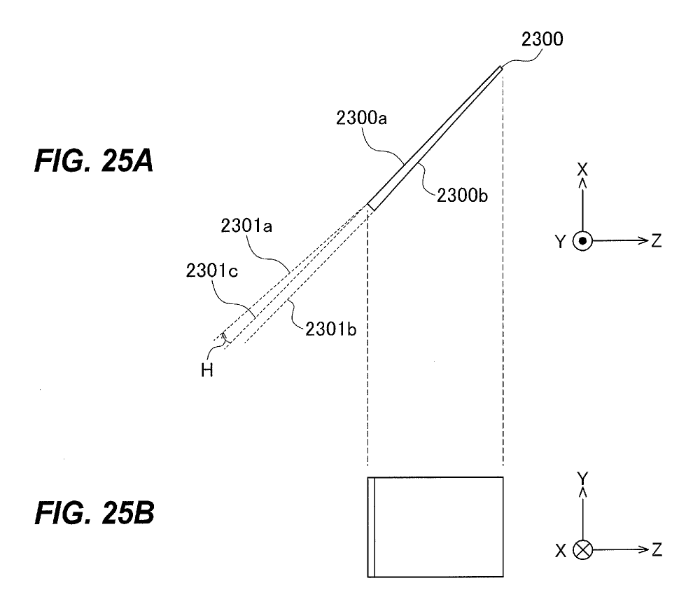

FIG. 25 shows a schematic diagram illustrating the shape of the light combining element 2300. The light combining element 2300 has a trapezoidal shape as viewed from the Y axis direction. The light combining element 2300 has a wedge shape as viewed from the Y axis direction. A wedge shape is a shape gradually narrowing from one end to another end. The light combining element 2300 has a rectangular shape as viewed from the X axis direction.

A surface 2301a is a surface obtained by extending the surface 2300a in the −Z axis direction. That is, the surface 2301a is flush with the surface 2300a. A surface 2301b is a surface obtained by extending the surface 2300b in the −Z axis direction. That is, the surface 2301b is flush with the surface 2300b. A surface 2301c is a surface parallel to the surface 2301b. An end on the +Z axis direction side of the surface 2301c is connected to an end on the −Z axis direction side of the surface 2300a.

The surfaces 2300a and 2300b are not parallel to each other. That is, the surface 2300a is inclined to the surface 2300b. A distance between the surfaces 2300a and 2300b on the +Z axis direction side is less than a distance between the surfaces 2300a and 2300b on the −Z axis direction side.

An angle formed by the surfaces 2301a and 2301c is an angle H. The angle H is not 0 degrees. The angle H is, for example, 3 degrees.

### <Behavior of Light Ray>

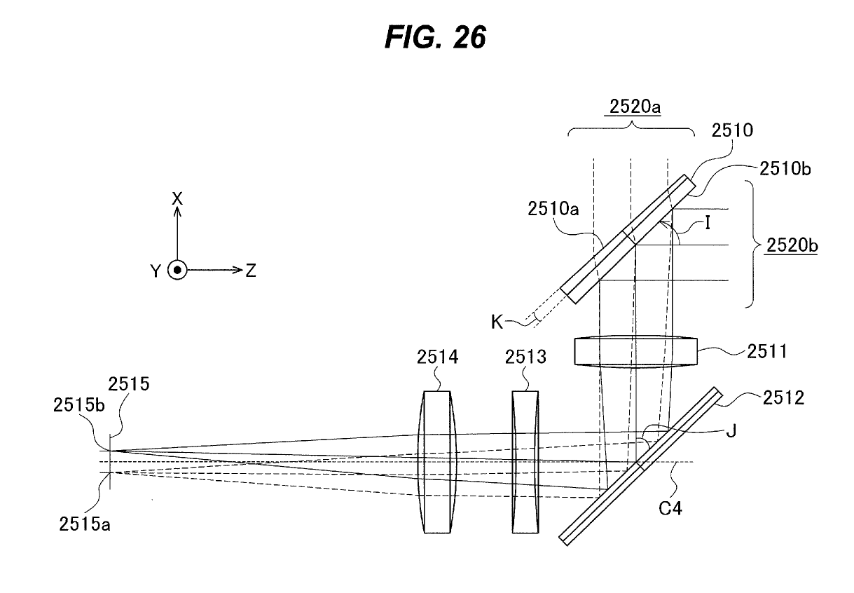

FIG. 26 is a diagram illustrating a simulation result of light rays showing advantages of the fourth embodiment.

A light combining element 2510 illustrated in FIG. 26 corresponds to the light combining element 2300 illustrated in FIG. 24. A surface 2510a illustrated in FIG. 26 corresponds to the surface 2300a illustrated in FIG. 24. A surface 2510b illustrated in FIG. 26 corresponds to the surface 2300b illustrated in FIG. 24. A biconvex lens 2511 illustrated in FIG. 26 corresponds to the biconvex lens 101 illustrated in FIG. 24. A deflecting mirror 2512 illustrated in FIG. 26 corresponds to the deflecting mirror 71 illustrated in FIG. 24. A biconcave lens 2513 illustrated in FIG. 26 corresponds to the biconcave lens 102 illustrated in FIG. 24. A condensing lens 2514 illustrated in FIG. 26 corresponds to the condensing lens group 400 illustrated in FIG. 24. A light concentration surface 2515 illustrated in FIG. 26 corresponds to the phosphor surface of the phosphor element 40G illustrated in FIG. 24.

A first light ray group 2520a is light emitted from the first excitation light source unit 10a. A second light ray group 2520b is light emitted from the second excitation light source unit 10b. In FIG. 26, the first light ray group 2520a is represented by dashed lines. In FIG. 26, the second light ray group 2520b are represented by solid lines.

A distance between the surfaces 2510a and 2510b on the +Z axis direction side is less than a distance between the surfaces 2510a and 2510b on the −Z axis direction side.

<Behavior of First Light Ray Group 2520a>

The first light ray group 2520a is emitted from the first excitation light source unit 10a and travels in the −X axis direction. The first light ray group 2520a traveling in the −X axis direction reaches the surface 2510a of the light combining element 2510.

The surface 2510a is inclined by an angle K with respect to the surface 2510b of the light combining element 2510. The angle K corresponds to the angle H illustrated in FIG. 25.

The first light ray group 2520a reaching the surface 2510a passes through the light combining element 2510. The first light ray group 2520a passing through the light combining element 2510 is emitted from the surface 2510b.

The first light ray group 2520a emitted from the surface 2510b has an angle relative to the X axis. This is because an angle at which the first light ray group 2520a is refracted at the surface 2510a is different from an angle at which the first light ray group 2520a is refracted at the surface 2510b. In FIG. 26, the first light ray group 2520a travels in the −X axis direction with inclination in the −Z axis direction with respect to the X axis.

The light ray group 2520a passing through the light combining element 2510 travels in the −X axis direction.

The biconvex lens 2511 is disposed on the −X axis direction side of the light combining element 2510.

The first light ray group 2520a passing through the light combining element 2510 reaches the biconvex lens 2511. The first light ray group 2520a reaching the biconvex lens 2511 passes through the biconvex lens 2511.

The first light ray group 2520a passing through the biconvex lens 2511 travels in the −X axis direction.

The deflecting mirror 2512 is disposed on the −X axis direction side of the biconvex lens 2511.

The first light ray group 2520a passing through the biconvex lens 2511 reaches the deflecting mirror 2512.

A central light ray of the first light ray group 2520a is incident on the deflecting mirror 2512 at an angle less than an angle J.

The angle J is an angle at which a central light ray of the second light ray group 2520b, described later, reaches the deflecting mirror 2512. Since the second light ray group 2520b travels parallel to the X axis, the angle J is an angle with respect to an X-Y plane. The angle J is an angle corresponding to the angle G in FIG. 24.

Strictly speaking, since the central light ray of the first light ray group 2520a passes through the biconvex lens 2511 at an angle different from a right angle, the angle is slightly different from that described above. The incident angle on the deflecting mirror 2512 is greater than the angle J.

Here, the angle J is an angle greater than 45 degrees. The angle J is, for example, 45.8 degrees.

The first light ray group 2520a reflected by the deflecting mirror 2512 travels in the −Z axis direction.

The biconcave lens 2513 is disposed on the −Z axis direction side of the deflecting mirror 2512.

The first light ray group 2520a reflected by the deflecting mirror 2512 is incident on the biconcave lens 2513.

The first light ray group 2520a incident on the biconcave lens 2513 is converted into parallel light beams by the biconcave lens 2513. The first light ray group 2520a is converted into parallel light beams and then emitted from the biconcave lens 2513.

The first light ray group 2520a converted into the parallel light beams travels in the −Z axis direction.

The condensing lens 2514 is disposed on the −Z axis direction side of the biconcave lens 2513.

The first light ray group 2520a converted into the parallel light beams is incident on the condensing lens 2514. The first light ray group 2520a incident on the condensing lens 2514 is converted into concentrated light beams and then emitted.

The first light ray group 2520a converted into the concentrated light beams is concentrated at a light concentration position 2515a on the light concentration surface 2515.

The light concentration surface 2515 is located on the −Z axis direction side of the condensing lens 2514. The light concentration position 2515a of the first light ray group 2520a is located on the −X axis direction side of an optical axis C4. The optical axis C4 is an optical axis of the biconcave lens 2513 and condensing lens 2514.

If a distance between the surfaces 2510a and 2510b on the +Z axis direction side is greater than a distance between the surfaces 2510a and 2510b on the −Z axis direction side, the light concentration position 2515a is located on the +X axis direction side of the optical axis C4. This is a case where the angle K has a negative value.

In this case, the angle J is an angle less than 45 degrees. For example, it is 44.2 degrees.

<Behavior of Second Light Ray Group 2520b>

The second light ray group 2520b is emitted from the second excitation light source unit 10b and travels in the −Z axis direction. The second light ray group 2520b traveling in the −Z axis direction reaches the surface 2510b of the light combining element 2510.

The second light ray group 2520b traveling in the −Z axis direction is incident on the surface 2510b at an angle I. Here, the angle I is an angle having a value obtained by subtracting the incident angle P1 of the second light ray group 2520b from 90 degrees. The angle I corresponds to the angle F in FIG. 24.

In the simulation, the angle I is 45 degrees. The surface 2510b is a surface that is rotated counterclockwise by 45 degrees about an axis parallel to the Y axis relative to a Y-Z plane as viewed from the +Y axis direction.

The second light ray group 2520b reaching the surface 2510b is reflected by the surface 2510b.

The second light ray group 2520b reflected by the light combining element 2510 travels in the −X axis direction.

The biconvex lens 2511 is disposed on the −X axis direction side of the light combining element 2510.

The second light ray group 2520b reflected by the light combining element 2510 reaches the biconvex lens 2511. The second light ray group 2520b reaching the biconvex lens 2511 passes through the biconvex lens 2511.

The second light ray group 2520b passing through the biconvex lens 2511 travels in the −X axis direction. The second light ray group 2520b passing through the biconvex lens 2511 reaches the deflecting mirror 2512.

A central light ray of the second light ray group 2520b is incident on the deflecting mirror 2512 at the angle J. The angle J is an angle having a value obtained by subtracting the incident angle P1 of the central light ray of the second light ray group 2520b from 90 degrees.

The second light ray group 2520b reflected by the deflecting mirror 2512 travels in the −Z axis direction.

The biconcave lens 2513 is disposed on the −Z axis direction side of the deflecting mirror 2512.

The second light ray group 2520b reflected by the deflecting mirror 2512 is incident on the biconcave lens 2513. The second light ray group 2520b incident on the biconcave lens 2513 is converted by the biconcave lens 2513 into parallel light beams. The second light ray group 2520b is converted into parallel light beams and emitted from the biconcave lens 2513.

The second light ray group 2520b converted into the parallel light beams travels in the −Z axis direction.

The condensing lens 2514 is disposed on the −Z axis direction side of the biconcave lens 2513.

The second light ray group 2520b converted into the parallel light beams is incident on the condensing lens 2514. The second light ray group 2520b incident on the condensing lens 2514 is converted into concentrated light beams and then emitted.

The second light ray group 2520b converted into the concentrated light beams is concentrated at a light concentration position 2515b on the light concentration surface 2515.

The light concentration surface 2515 is located on the −Z axis direction side of the condensing lens 2514. The light concentration position 2515b of the second light ray group 2520b is located on the +X axis direction side of the optical axis C4.

If a distance between the surfaces 2510a and 2510b on the +Z axis direction side is greater than a distance between the surfaces 2510a and 2510b on the −Z axis direction side, the light concentration position 2515b is located on the −X axis direction side of the optical axis C4. This is a case where the angle K has a negative value.

In this case, the angle J is an angle less than 45 degrees. For example, it is 44.2 degrees.

As described above, the distance between the surfaces 2510a and 2510b on the +Z axis direction side is less than the distance between the surfaces 2510a and 2510b on the −Z axis direction side.

In this case, in order to concentrate the first light ray group 2520a and second light ray group 2520b in such a manner that they are mutually separated in the X axis direction with their center at the optical axis C4, the angle J is an angle greater than 45 degrees. The angle J is, for example, 45.8 degrees.

The angle K illustrated in FIG. 26 corresponds to the angle H illustrated in FIG. 25. The angle K is, for example, 3 degrees.

Thereby, after passing through the light combining element 2510, the first light ray group 2520a travels in the −X axis direction with inclination in the −Z axis direction. That is, on the −X axis direction side of the light combining element 2510, the first light ray group 2520a is displaced from the second light ray group 2520b in the −Z axis direction.

The angle I is, for example, 45 degrees. The angle I illustrated in FIG. 26 corresponds to the angle F illustrated in FIG. 24.

Thus, after the second light ray group 2520b is reflected by the light combining element 2510, it travels in the −X axis direction without inclination to the X axis.

As described above, by adjusting the angles K and J, it is possible to separate the light concentration position 2515a and light concentration position 2515b in the X axis direction on the light concentration surface 2515, as illustrated in FIG. 26. The light concentration position 2515a is a light concentration position of the first light ray group 2520a. The light concentration position 2515b is a light concentration position of the second light ray group 2520b. The light concentration position 2515a and light concentration position 2515b are different positions on the light concentration surface 2515.

This makes it possible to halve the energy density of the light beam concentrated on the light concentration surface 2515 without using a complicated optical element as in Patent Reference 1.

In the example illustrated in FIG. 26, the angle I of the light combining element 2510 is an angle less than the angle J of the deflecting mirror 2512. However, it is sufficient that they can be concentrated at different positions on the light concentration surface 2515 with their center at the optical axis C4, and the relationship between the angles I and J is not limited to the above example.

Further, by adjusting the angles K and I, it is possible to separate the light concentration position 2515a and light concentration position 2515b in the X axis direction on the light concentration surface 2515 as illustrated in FIG. 26. The light concentration position 2515a and light concentration position 2515b are different positions on the light concentration surface 2515.

For example, by setting the angle K to 0.8 degrees, the angle I to 45.8 degrees, and the angle J to 45 degrees, the same advantages are obtained in the configuration of FIG. 26. It is sufficient that they can be concentrated at different positions on the light concentration surface 2515 with their center at the optical axis C4, and the relationship between the angles K and I is not limited to the above example.

The first embodiment separates the light concentration positions on the phosphor element 40G by adjusting both the light combining element 70 and deflecting mirror 71. However, the fourth embodiment uses the light combining element 2300 having the angle H (the light combining element 2510 having the angle K), so that it provides the same advantages as the first embodiment by adjusting only the light combining element 2300 (light combining element 2510).

This indicates that even if the deflecting mirror 71 is omitted, advantages are obtained. This makes it possible to reduce the number of parts.

To separate the light concentration positions on the phosphor element 40G in the X axis direction with their center at the optical axis C4, it is sufficient to adjust the angles K and I of the light combining element 2510. There is no need to use the deflecting mirror 71 (deflecting mirror 712) to separate the light concentration positions on the phosphor element 40G in the X axis direction with their center at the optical axis C3 as described in the first embodiment. This makes it possible to reduce the number of parts, thereby reducing the cost as compared to the first embodiment.

Further, the surface 2510a of the light combining element 2510 may be a reflection surface that reflects light emitted from the second excitation light source unit 10b.

In this case, the surface 2510b is a transmission surface that transmits light emitted from the first excitation light source unit 10a and light emitted from the second excitation light source unit 10b. Further, the surface 2510a is a surface that transmits light emitted from the first excitation light source unit 10a.

Thereby, compared to the case where the surface 2510b is a reflection surface, it becomes possible to increase the difference between an emission angle at which the light emitted from the first excitation light source unit 10a is emitted from the light combining element 2510 and an emission angle at which the light emitted from the second excitation light source unit 10b is emitted from the light combining element 2510. Thus, when the light concentration positions on the phosphor element 40G are greatly separated with their center at the optical axis C4, it is preferable that the surface 2510a be a reflection surface. This reflection surface is a reflection surface for light emitted from the second excitation light source unit 10b. Light emitted from the first excitation light source unit 10a passes through this reflection surface.

In each of the above embodiments, the phosphor element 40G is described by taking the reflection type element as an example. However, the phosphor element 40G may be a transmission type element. In this case, the optical path should be devised so that the light reaches the light intensity equalizing element 113.

### <Modifications>

Each of the above embodiments describes the light source device of the projection display device 1. However, for example, it can be used as a light source device for a headlight of a vehicle.

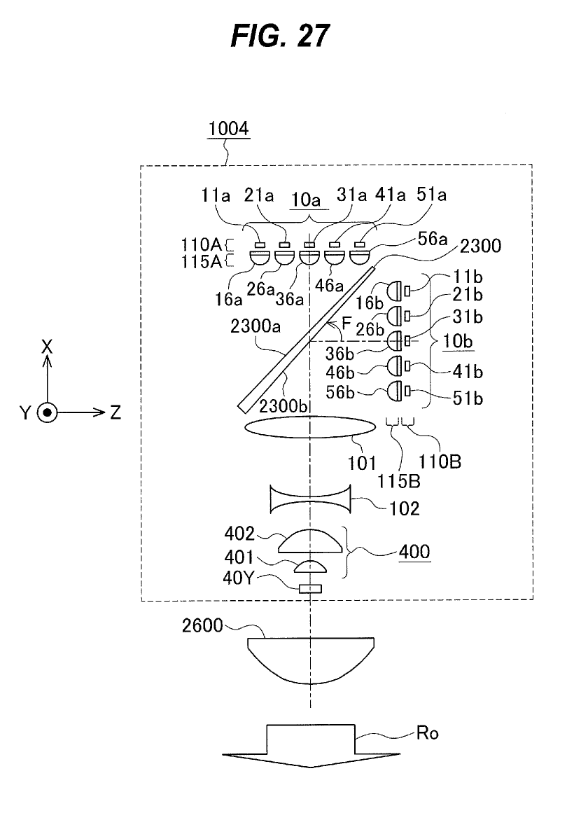

FIG. 27 is a configuration diagram illustrating an example in which the light source device 1003 is applied to a headlight 1004 of a vehicle. As illustrated in FIG. 27, a phosphor element 40Y is of a transmission type. For example, the phosphor element 40Y emits yellow fluorescence. The yellow fluorescence of the phosphor element 40Y mixes with blue excitation light of the excitation light source units 10a and 10b to make white light.

The white light is emitted from the phosphor element 40Y in the −X axis direction. A projection lens 2600 is disposed on the −X axis direction side of the phosphor element 40Y. The projection lens 2600 projects the white light in the −X axis direction. “Projection” is used interchangeably with “projection”. “Projection” and “projection” refer to projecting light.

Although not illustrated, a color separation filter for transmitting the wavelength band of the excitation light source units 10a and 10b and reflecting the yellow wavelength band emitted by the phosphor element 40Y may be disposed on the +X axis direction side of the phosphor element 40Y.

This makes it possible to increase a proportion of white light component emitted in the −X axis direction. The color separation filter can be formed by a dichroic mirror formed by a dielectric multi-layer film.

When it is used in a headlight, there may be a case where brightness is not required as in the projection display device 1. Thus, the excitation light source units 10a and 10b may be formed by a single light source instead of multiple light sources. In this case, it is necessary to select an excitation light source that can provide a desired brightness.

The biconvex lens 101 and biconcave lens 102 can be omitted. In this case, all of the parallel light beams emitted from the first excitation light source unit 10a and second excitation light source unit 10b should reach the aspheric convex lens 402. Thereby, downsizing is possible.

If the above configuration of the first embodiment is applied, it is possible to provide the light combining element 70 with an angle adjustment mechanism and adjust the light concentration position of the light beams emitted from the second excitation light source unit 10b on the phosphor element 40G. This makes it possible to control the projecting direction of the headlight.

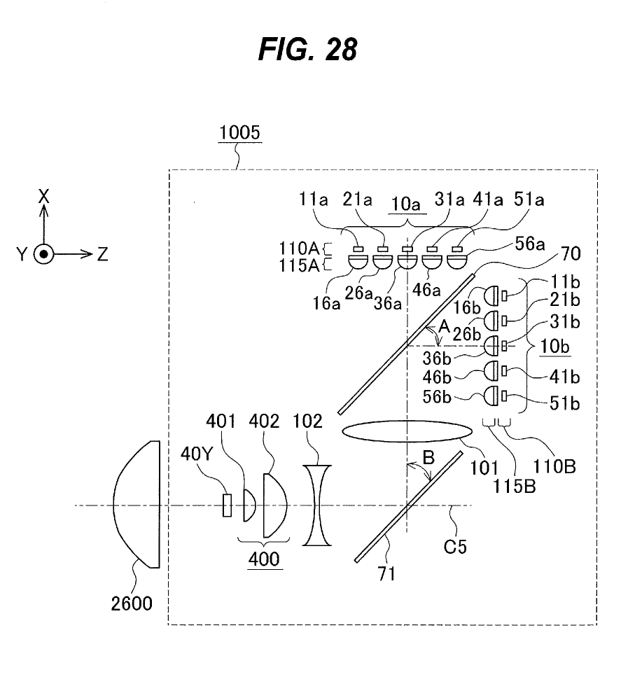

FIG. 28 is a configuration diagram illustrating an example of a light source device 1005 where the first embodiment is applied to a headlight.

As in the first embodiment, the angle A of the light combining element 70 is adjusted. The position at which the light beams emitted from the second excitation light source unit 10b are concentrated on the phosphor element 40Y is shifted in the −X axis direction with respect to an optical axis C5 of a projection lens 2600.

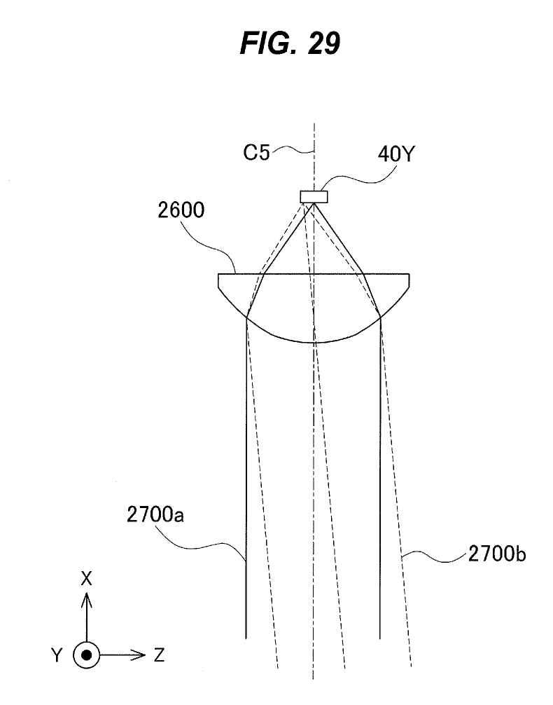

In this case, it becomes possible to shift a light beam emitted from the projection lens 2600 in the +X axis direction. This will be detailed later with reference to FIG. 29.

On the other hand, in this case, the light beams emitted from the first excitation light source unit 10a are concentrated at the same position on the phosphor element 40Y regardless of the adjustment of the angle of the light combining element 70. Thus, the projecting direction of the light beam emitted from the projection lens 2600 is not changed.

Further, an angle adjustment mechanism is provided to the deflecting mirror 71 and the angle B is adjusted.

In this case, it is possible to maintain the distance between the position in the X axis direction at which the light beams emitted from the first excitation light source unit 10a are concentrated on the phosphor element 40Y and the position in the X axis direction at which the light beams emitted from the second excitation light source unit 10b are concentrated on the phosphor element 40Y. It becomes possible to control the emitting direction of a light beam emitted from the projection lens 2600 while maintaining the distance. A control direction is the −X axis direction.

Further, angle adjustment mechanisms may be provided to both the light combining element 70 and deflecting mirror 71.

In this case, it is possible to control the light concentration positions of the light beams emitted from the first excitation light source unit 10a and the light beams emitted from the second excitation light source unit 10b. This makes it possible to continuously control the directions of the light beams emitted from the projection lens 2600.

Further, for example, in FIG. 27, an angle adjustment mechanism is provided to the light combining element 2300. It is possible to maintain the distance between the position in the Z axis direction at which the light beams emitted from the first excitation light source unit 10a are concentrated on the phosphor element 40Y and the position in the Z axis direction at which the light beams emitted from the second excitation light source unit 10b are concentrated on the phosphor element 40Y. It becomes possible to control the emitting direction of a light beam emitted from the projection lens 2600 while maintaining the distance. A control direction is the Z axis direction.

To explain the above emitting direction of the light beam, FIG. 29 illustrates a light ray trajectory diagram for explaining the behavior of light beams. The coordinates illustrated in FIG. 29 correspond to FIG. 27. For convenience, light beams are depicted as light rays. Only a part on the −X axis direction side of the phosphor element 40Y of FIG. 27 is depicted.

Light rays 2700a emitted from a position on an optical axis C5 of the phosphor element 40Y are collimated by the projection lens 2600. In FIG. 29, the light rays 2700a (light beam) are represented by solid lines.

The collimated light rays 2700a (light beam) travel parallel to the optical axis C5 in the −X axis direction.

Light rays 2700b emitted from a position on the −Z axis direction side of the optical axis C5 of the phosphor element 40Y are collimated by the projection lens 2600. In FIG. 29, the light rays 2700b (light beam) are represented by dashed lines.

The collimated light rays 2700b (light beam) are emitted from the projection lens 2600 with inclination to the optical axis C5 in the +Z axis direction. That is, the collimated light rays 2700b (light beam) are projected on the +Z axis direction side relative to the collimated light rays 2700a (light beam).

Thus, by shifting the position at which light is concentrated on the phosphor element 40Y in the −Z axis direction, it becomes possible to control the direction of the projected light beam in the +Z axis direction. Similarly, by shifting the position at which light is concentrated on the phosphor element 40Y in the +Z axis direction, it becomes possible to control the direction of the projected light beam in the −Z axis direction.

Thus, the direction in which light is projected can be selected by selecting a light source to be lit. Thus, selection of a high beam and a low beam used in an automobile can be easily achieved. It is also applicable to an adaptive front lighting system (AFS) that changes a light distribution pattern, e.g., shifts a light distribution of projection light in the left-right direction of the automobile.

The light combining element 2300 has the incident surface 2300a on which the first excitation light is incident and the emission surface 2300b from which the first excitation light is emitted. The incident surface 2300a is inclined to the emission surface 2300b.

The above embodiments may use terms, such as “parallel” or “perpendicular”, indicating positional relationships between parts or the shapes of parts. These terms are intended to include ranges taking account of manufacturing tolerances, assembly variations, or the like. Thus, recitations in the claims indicating positional relationships between parts or the shapes of parts are intended to include ranges taking account of manufacturing tolerances, assembly variations, or the like.

Further, although the embodiments of the present invention are described as above, the present invention is not limited to these embodiments.

### DESCRIPTION OF REFERENCE CHARACTERS

1 projection display device, 2, 1001, 1002, 1003 light source device, 1004, 1005 headlight, 3 controller, 10a first excitation light source unit, 10b second excitation light source unit, 110A first excitation light source group, 110B second excitation light source group, 115A first collimator lens group, 115B second collimator lens group, 11a, 12a, 13a, 14a, 15a, 21a, 22a, 23a, 24a, 25a, 31a, 32a, 33a, 34a, 35a, 41a, 42a, 43a, 44a, 45a, 51a, 52a, 53a, 54a, 55a first excitation light source, 11b, 12b, 13b, 14b, 15b, 21b, 22b, 23b, 24b, 25b, 31b, 32b, 33b, 34b, 35b, 41b, 42b, 43b, 44b, 45b, 51b, 52b, 53b, 54b, 55b second excitation light source, 16a, 17a, 18a, 19a, 20a, 26a, 27a, 28a, 29a, 30a, 36a, 37a, 38a, 39a, 40a, 46a, 47a, 48a, 49a, 50a, 56a, 57a, 58a, 59a, 60a first collimator lens, 16b, 17b, 18b, 19b, 20b, 26b, 27b, 28b, 29b, 30b, 36b, 37b, 38b, 39b, 40b, 46b, 47b, 48b, 49b, 50b, 56b, 57b, 58b, 59b, 60b second collimator lens, 20B blue light source unit, 30R red light source unit, 210B blue light source group, 215B collimator lens group, 310R red light source group, 315R collimator lens group, 101 biconvex lens, 102 biconcave lens, 113 light intensity equalizing element, 113i incident end surface, 113o emitting end surface, 113a, 113b light concentration position, 115 relay lens group, 116 concave-convex lens (meniscus lens), 117 convex lens, 118 biconvex lens, 120 deflecting mirror, 121 light valve, 122 condensing lens, 124 projection optical system, 124f front face, 133 light diffusion element, 200, 300 lens group, 201, 301 convex lens, 202, 302 concave lens, 400, 502 condensing lens group, 501 collimating lens group, 401, 501a, 502a convex lens, 402, 501b, 502b aspheric convex lens, 40G phosphor element, 41G, 42G rotary phosphor element, 41Ga, 42Ga phosphor region, 41Gb transmission region, 4000a. solid line, 4000s dashed line, 4000p dot-and-dash line, 70, 70a, 70b, 700a, 700b, 710, 2300 light combining element, 71, 712 deflecting mirror, 72, 73, 132, 136 color separation filter, 74 reflection region, 75 transmission region, 701a, 701b light ray, 711 biconvex lens, 713 biconcave lens, 714 condensing lens, 715 light concentration surface, 113a, 113b, 400a, 400b, 715a, 715b light concentration position, 720a first light ray group, 720b second light ray group, 80 condensing optical system, 2300a, 2300b surface, A, B, D, E, F, G, H, K, J angle, C, C3, C4, OA optical axis, C1, C2 axis, CA center axis, D1, D2 curve, d distance, L, H, L0, H0 dimension, M magnification ratio, MC modulation control signal, Ro projection light, VS image signal.

1. A light source device comprising:
a light combining element for transmitting first excitation light and reflecting second excitation light; and
a phosphor element for receiving the first excitation light and the second excitation light and emitting first fluorescence,
wherein an emission angle of the first excitation light emitted from the light combining element and a reflection angle of the second excitation light reflected by the light combining element are different from each other, so that a position at which the first excitation light passing through the light combining element reaches the phosphor element and a position at which the second excitation light reflected by the light combining element reaches the phosphor element are different from each other.

2. The light source device of claim 1, wherein the first excitation light passes through a reflection surface of the light combining element for reflecting the second excitation light.

3. The light source device of claim 2, wherein:
the first excitation light and the second excitation light are laser light, and
a polarization direction of the first excitation light is different by 90 degrees from a polarization direction of the second excitation light.

4. The light source device of claim 1, wherein:
the light combining element has a transmission region for transmitting the first excitation light and a reflection surface of a reflection region for reflecting the second excitation light, and
the reflection region is a region different from the transmission region.

5. The light source device of claim 4, wherein:
the transmission region has a transmission surface, and
the transmission surface is on a same surface as the reflection surface.

6. The light source device of claim 4, wherein the transmission region is formed by an opening provided in the light combining element.

7. The light source device of claim 1, wherein:
the light combining element has an incident surface on which the first excitation light is incident, and an emitting surface from which the first excitation light is emitted, and
the incident surface is inclined to the emitting surface.

8. The light source device of claim 1, wherein a reflection surface or a transmission surface of the light combining element includes a first normal to a surface including a central light ray of a light beam of the first excitation light and a central light ray of a light beam of the second excitation light, and is disposed in such a manner as to be rotated about the first normal.

9. The light source device of claim 1, further comprising a deflecting mirror for reflecting the first excitation light passing through the light combining element and the second excitation light reflected by the light combining element,
wherein a reflection surface of the deflecting mirror includes a second normal to a plane including a central light ray of a light beam of the first excitation light incident on the deflecting mirror and a central light ray of a light beam of the first excitation light reflected by the deflecting mirror, and is disposed in such a manner as to be rotated about the second normal.

10. The light source device of claim 1, further comprising:
a first condensing lens for converting the first excitation light or the second excitation light into first concentrated light;
a first rotary phosphor element disposed at a light concentration position of the first concentrated light, the first rotary phosphor element having a first phosphor region to which phosphor is applied and that receives the first concentrated light and emits second fluorescence, and a transmission region that transmits the first concentrated light; and
a second condensing lens for converting the first concentrated light passing through the first rotary phosphor element into second concentrated light,
wherein the first concentrated light reaches the first phosphor region or the transmission region due to rotation of the first rotary phosphor element, and
wherein the phosphor element is disposed at a light concentration position of the second concentrated light.

11. The light source device of claim 1, further comprising:
a first laser light source for emitting first laser light in a wavelength range different from a wavelength range of the first fluorescence;
a second laser light source for emitting second laser light in a wavelength range different from a wavelength range of the first fluorescence and a wavelength range of the first laser light; and
a color separation filter for reflecting or transmitting light depending on a wavelength of the light,
wherein the color separation filter reflects the first fluorescence if the color separation filter transmits the first laser light and the second laser light, and transmits the first fluorescence if the color separation filter reflects the first laser light and the second laser light, thereby arranging the first laser light, the second laser light, and the first fluorescence on a same optical path.
